(19) United States
(12) Patent Application Publication
(10) Pub. No.: US 2005/0285909 A1
(43) Pub. Date: Dec. 29, 2005

(54) Liquid droplet ejecting head and liquid droplet ejecting apparatus

(75) Inventors: Michiaki Murata, Kanagawa (JP); Hiroyuki Usami, Kanagawa (JP); Yoshinao Kondoh, Kanagawa (JP); Nayve Regan, Kanagawa (JP); Kazunori Onishi, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/140,026

(22) Filed: May 27, 2005

(30) Foreign Application Priority Data
Jun. 29, 2004 (JP) 2004-191974
Mar. 11, 2005 (JP) 2005-70038

(51) Int. Cl. B41J 2/045

(52) U.S. Cl. 347/70; 347/68

(57) ABSTRACT

A liquid droplet ejecting head is disclosed which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; and an isolation chamber that is provided in the liquid pooling chamber and isolates the piezoelectric element from the liquid. The liquid pooling chamber is provided at a side opposite to the pressure chamber, with the vibrating plate disposed between the liquid pooling chamber and the pressure chamber. A liquid droplet ejecting apparatus including this liquid droplet ejecting head is also disclosed.

### CROSS-REFERENCE TO RELATED APPLICATION

This application claims priority under 35 U.S.C. 119 from Japanese Patent Applications Nos. 2004-191974 and 2005-70038, the disclosures of which are incorporated herein.

### BACKGROUND OF THE INVENTION

1. Field of the Invention

The present invention relates to a liquid droplet ejecting head and a liquid droplet ejecting apparatus, and more particularly, to a liquid droplet ejecting head which has a nozzle which ejects liquid droplets, a pressure chamber which communicates with the nozzle and in which liquid droplets are filled, a vibrating plate structuring a portion of the pressure chamber, a liquid pooling chamber which pools a liquid to be supplied to the pressure chamber via a liquid droplet flow path, and a piezoelectric element which displaces the vibrating plate, and to a liquid droplet ejecting apparatus having this liquid droplet ejecting head.

2. Description of the Related Art

There have conventionally been known inkjet recording apparatus in which characters, images or the like are printed onto a recording medium such as a recording paper or the like which is conveyed in a subscanning direction, by ejecting ink droplets selectively from plural nozzles of a liquid droplet ejecting head (hereinafter sometimes referred to simply as “recording head”) which moves reciprocatingly in a main scanning direction.

Such an inkjet recording apparatus has piezoelectric system recording heads, thermal system recording heads, or the like. For example, in the case of a piezoelectric system recording head, as shown in FIGS. 52 and 53, a piezoelectric element (an actuator which converts electrical energy into mechanical energy) 306 is provided at a pressure chamber 304 to which ink is supplied from an ink tank via an ink pooling chamber 302. The piezoelectric element 306 flexurally deforms in a concave form so as to reduce the volume of the pressure chamber 304, thereby applying pressure to the ink within the pressure chamber 304 and ejecting the ink as an ink droplet 300A from a nozzle 308 which communicates with the pressure chamber 304.

In recent years, the ability to achieve high resolution printing while keeping the inkjet recording head low-cost and compact has come to be demanded of recording heads structured in this way. In order to address such demands, the nozzles must be disposed at a high density. However, the conventional recording head has limitations in respect of disposing the nozzles 308 at a high density since the ink pooling chamber 302 is disposed adjacent to the nozzles 308 (between the nozzles 308) as shown in the drawings.

Further, a recording head is provided with driving ICs that apply voltage to a certain piezoelectric element, and it has been the conventional practice to mount such ICs on a flexible print circuit board (FPC) as shown in FIG. 54. More specifically, a bump 312 formed on the FPC 310 is joined to the obverse of the metal electrode on the top surface of the piezoelectric element, and the piezoelectric element 306 and the driving IC (not shown) are electrically connected at this stage by virtue of the fact that the driving IC has been mounted on the FPC 310.

Further, there has conventionally been proposed a method in which an electrode terminal provided on the outer surface of a recording head is connected to an electrode terminal on a mounting board on which a driving IC is mounted (for example, refer to JP-A No. 2-301445). Furthermore, there has also conventionally been proposed a system in which a driving IC is joined and connected to an electrode terminal provided on the outer surface of a recording head and thereafter an FPC is joined to an electrode terminal of a lead-out wire provided on the recording head (for example, refer to JP-A No. 9-323414).

In either case, fine-pitch wiring (for example, 10 μm or less) cannot be formed, and therefore as the nozzle density is increased, the mounting board and the FPC becomes correspondingly larger, which gives rise to problems such as an impediment to achieving compactness and a cost increase. Another problem that is encountered with a high nozzle density is such that wires having a desirable resistance value cannot be routed. In other words, due to the limited wire density, there is a limitation in achieving a high nozzle density.

### SUMMARY OF THE INVENTION

Accordingly, in view of the problems such as mentioned above, the present invention provides a liquid droplet ejecting head which is designed such that a high nozzle density can be achieved while at the same time forming fine-pitch wiring, thus resulting in high resolution.

According to a first aspect of the present invention, a liquid droplet ejecting head is provided which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; and an isolation chamber that is provided in the liquid pooling chamber and isolates the piezoelectric element from the liquid; wherein the liquid pooling chamber is provided at a side opposite to the pressure chamber, with the vibrating plate disposed between the liquid pooling chamber and the pressure chamber.

According to a second aspect of the present invention, a liquid droplet ejecting head is provided which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; an isolation chamber that is provided in the liquid pooling chamber and isolates the piezoelectric element from the liquid; and a communication path that is communicated with the isolation chamber and makes a pressure within the pressure chamber substantially equal to an atmospheric pressure; wherein the liquid pooling chamber is provided at a side opposite to the pressure chamber, with the vibrating plate disposed between the liquid pooling chamber and the pressure chamber; and wherein the communication path comprises a first communication path that is provided in a partition wall of the liquid pooling chamber and communicated with the isolation chamber, and a second communication path that is provided in a top plate of the liquid pooling chamber and communicated with the first communication path and an exterior.

According to a third aspect of the present invention, a liquid droplet ejecting head is provided which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; an isolation chamber that is provided in the liquid pooling chamber and isolates the piezoelectric element from the liquid; and a communication path that is communicated with the isolation chamber and makes a pressure within the pressure chamber substantially equal to an atmospheric pressure; wherein the liquid pooling chamber is provided at a side opposite to the pressure chamber, with the vibrating plate disposed between the liquid pooling chamber and the pressure chamber; and wherein the communication path comprises a third communication path that penetrates through the vibrating plate and the piezoelectric element and is communicated with the isolation chamber, and a fourth communication path that is provided on a flow path substrate by which the pressure chamber is formed and which is communicated with the third communication path and an exterior.

According to a fourth aspect of the present invention, there is provided a liquid droplet ejecting apparatus including a liquid droplet ejecting head which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; and an isolation chamber that is provided in the liquid pooling chamber and isolates the piezoelectric element from the liquid; wherein the liquid pooling chamber is provided at a side opposite to the pressure chamber, with the vibrating plate disposed between the liquid pooling chamber and the pressure chamber.

According to a fifth aspect of the present invention, there is provided a liquid droplet ejecting apparatus including a liquid droplet ejecting head which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; an isolation chamber that is provided in the liquid pooling chamber and isolates the piezoelectric element from the liquid; and a communication path that is communicated with the isolation chamber and makes a pressure within the pressure chamber substantially equal to an atmospheric pressure; wherein the liquid pooling chamber is provided at a side opposite to the pressure chamber, with the vibrating plate disposed between the liquid pooling chamber and the pressure chamber; and wherein the communication path comprises a first communication path that is provided in a partition wall of the liquid pooling chamber and communicated with the isolation chamber, and a second communication path that is provided in a top plate of the liquid pooling chamber and communicated with the first communication path and an exterior.

According to a sixth aspect of the present invention, there is provided a liquid droplet ejecting apparatus including a liquid droplet ejecting head which includes: a nozzle that ejects a liquid droplet; a pressure chamber that is communicated with the nozzle and in which a liquid is filled; a vibrating plate that forms a portion of the pressure chamber; an ink pooling chamber that pools a liquid which is supplied to the pressure chamber via a liquid flow path; a piezoelectric element that displaces the vibrating plate; an isolation chamber that is provided in the liquid pooling chamber and isolates the piezoelectric element from the liquid; and a communication path that is communicated with the isolation chamber and makes a pressure within the pressure chamber substantially equal to an atmospheric pressure; wherein the liquid pooling chamber is provided at a side opposite to the pressure chamber, with the vibrating plate disposed between the liquid pooling chamber and the pressure chamber; and wherein the communication path comprises a third communication path that penetrates through the vibrating plate and the piezoelectric element and is communicated with the isolation chamber, and a fourth communication path that is provided on a flow path substrate by which the pressure chamber is formed and which is communicated with the third communication path and an exterior.

Other aspects, features, and advantages of the present invention will become apparent from the following description taken in conjunction with the accompanying drawings.

### BRIEF DESCRIPTION OF THE DRAWINGS

Preferred embodiments of the present invention will be described in detail based on the following figures, wherein:

FIG. 1 is a schematic perspective view showing an inkjet recording apparatus;

FIG. 2 is a schematic perspective view showing an inkjet recording unit mounted on a carriage;

FIG. 3 is a schematic plan view showing the structure of the inkjet recording head according to a first embodiment of the present invention;

FIG. 4 is a schematic sectional view taken along the line X-X of FIG. 3;

FIG. 5A is a plan view showing the relationship between the isolation chambers and the piezoelectric elements in the first embodiment of the present invention;

FIG. 5B is a schematic sectional view taken along the line B-B of FIG. 5A;

FIG. 6 is a schematic view showing a top plate before being cut into inkjet recording heads;

FIG. 7 is a schematic plan view showing bumps of a driving IC;

FIG. 8 is an explanatory view of all process steps for fabricating the inkjet recording head according to the first embodiment of the present invention;

FIGS. 9A-9K are explanatory views showing the process steps for manufacturing the piezoelectric element substrate according to the first embodiment of the present invention;

FIGS. 10A-10G are explanatory views showing the process steps for fabricating the top plate according to the first embodiment of the present invention;

FIGS. 11A-11D are explanatory views showing the process steps for joining the top plate to the piezoelectric element substrate according to the first embodiment of the present invention;

FIGS. 12A-12E are explanatory views showing the process steps for fabricating the flow path substrate according to the first embodiment of the present invention;

FIGS. 13A-13E are explanatory views showing the process steps for joining the flow path substrate to the piezoelectric element substrate according to the first embodiment of the present invention;

FIGS. 14J-14L are explanatory views showing a modified example of the process steps for fabricating the piezoelectric element substrate shown in FIGS. 9J-9K;

FIG. 15A is a plan view showing a modified example of the relationship between the isolation chambers and the piezoelectric elements shown in FIG. 5;

FIG. 15B is a schematic sectional view taken along the line B-B of FIG. 15A;

FIG. 16A is a plan view showing another modified example of the relationship between the isolation chambers and the piezoelectric elements shown in FIG. 5A;

FIG. 16B is a schematic sectional view taken along the line B-B of FIG. 16A;

FIGS. 17A-17B are explanatory views showing an inkjet recording head wherein the structure above the piezoelectric elements is different;

FIG. 18A is a plan view showing the isolation chambers, the resin protective films, the communication regions, and so forth in the second embodiment of the present invention;

FIG. 18B is a sectional view taken along the line C-C of FIG. 18A;

FIG. 18C is a sectional view taken along the line D-D of FIG. 18A;

FIG. 18D is a sectional view taken along the line E-E of FIG. 18A;

FIG. 18E is a sectional view taken along the line F-F of FIG. 18A;

FIG. 19 is a sectional view taken along the line A-A of FIG. 18A;

FIG. 20 is a sectional view taken along the line B-B of FIG. 18A;

FIGS. 21A-21K are explanatory views showing the process steps for fabricating the piezoelectric element substrate according to a second embodiment of the present invention;

FIGS. 22A-22G are explanatory views showing the process steps for fabricating the top plate according to the second embodiment of the present invention;

FIGS. 23A-23D are explanatory views showing the process steps for joining the top plate to the piezoelectric element substrate according to the second embodiment of the present invention;

FIGS. 24A-24E are explanatory views showing the process steps for joining the flow path substrate to the piezoelectric element substrate according to the second embodiment of the present invention;

FIG. 25A is a plan view showing the isolation chambers, the resin protective films, the communication regions, and so forth according to a modified example of the second embodiment;

FIG. 25B is a sectional view taken along the line C-C of FIG. 25A;

FIG. 25C is a sectional view taken along the line D-D of FIG. 25A;

FIG. 25D is a sectional view taken along the line E-E of FIG. 25A;

FIG. 25E is a sectional view taken along the line F-F of FIG. 25A;

FIG. 26 is a sectional view taken along the line A-A of FIG. 25A;

FIG. 27 is a sectional view taken along the line B-B of FIG. 25A;

FIG. 28A is a plan view showing the isolation chambers, the resin protective films, the communication regions, and so forth according to a further modified example of the second embodiment;

FIG. 28B is a sectional view taken along the line C-C of FIG. 28A;

FIG. 28C is a sectional view taken along the line D-D of FIG. 28A;

FIG. 28D is a sectional view taken along the line E-E of FIG. 28A;

FIG. 28E is a sectional view taken along the line F-F of FIG. 28A;

FIG. 29 is a sectional view taken along the line A-A of FIG. 28A;

FIG. 30 is a sectional view taken along the line B-B of FIG. 28A;

FIG. 31A is a plan view showing the isolation chambers, the resin protective films, the communication regions, and so forth according to a still further modified example of the second embodiment;

FIG. 31B is a sectional view taken along the line F-F of FIG. 31A;

FIG. 31C is a sectional view taken along the line D-D of FIG. 31A;

FIG. 31D is a sectional view taken along the line E-E of FIG. 31A;

FIG. 31E is a sectional view taken along the line F-F of FIG. 31A;

FIG. 32 is a sectional view taken along the line A-A of FIG. 31A;

FIG. 33 is a sectional view taken along the line B-B of FIG. 31A;

FIG. 34A is a plan view showing the isolation chambers, the resin protective films, the communication regions, and so forth according to a third embodiment of the present invention;

FIG. 34B is a sectional view taken along the line C-C of FIG. 34A;

FIG. 34C is a sectional view taken along the line D-D of FIG. 34A;

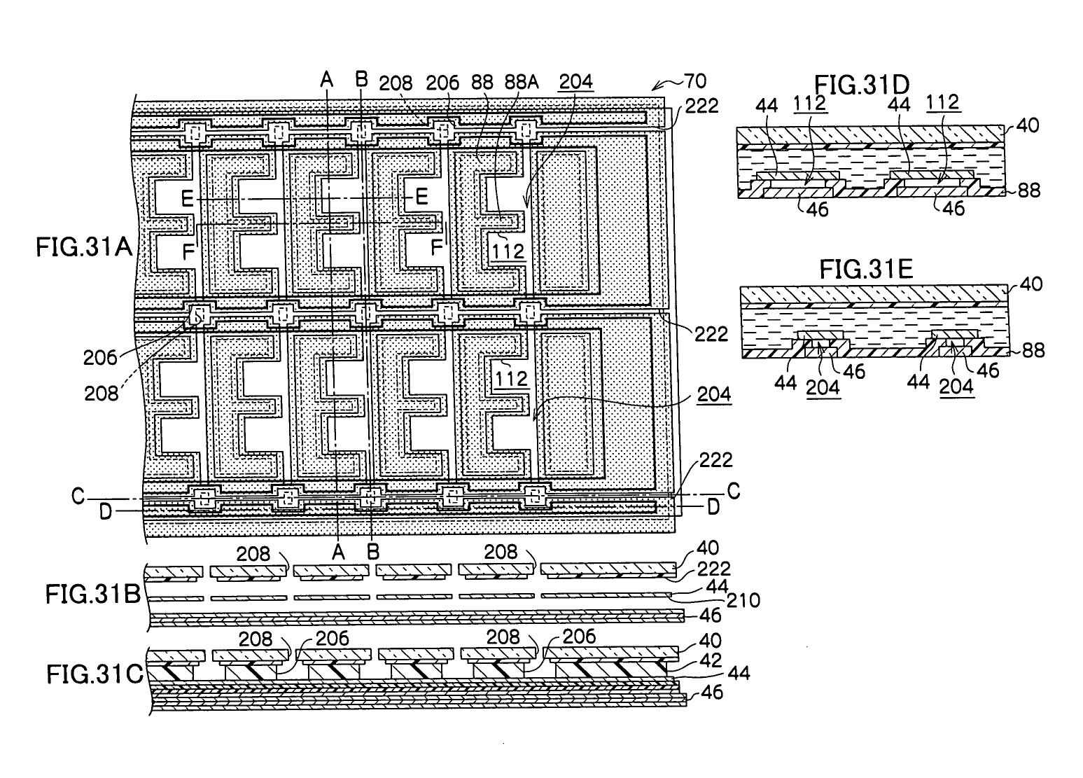

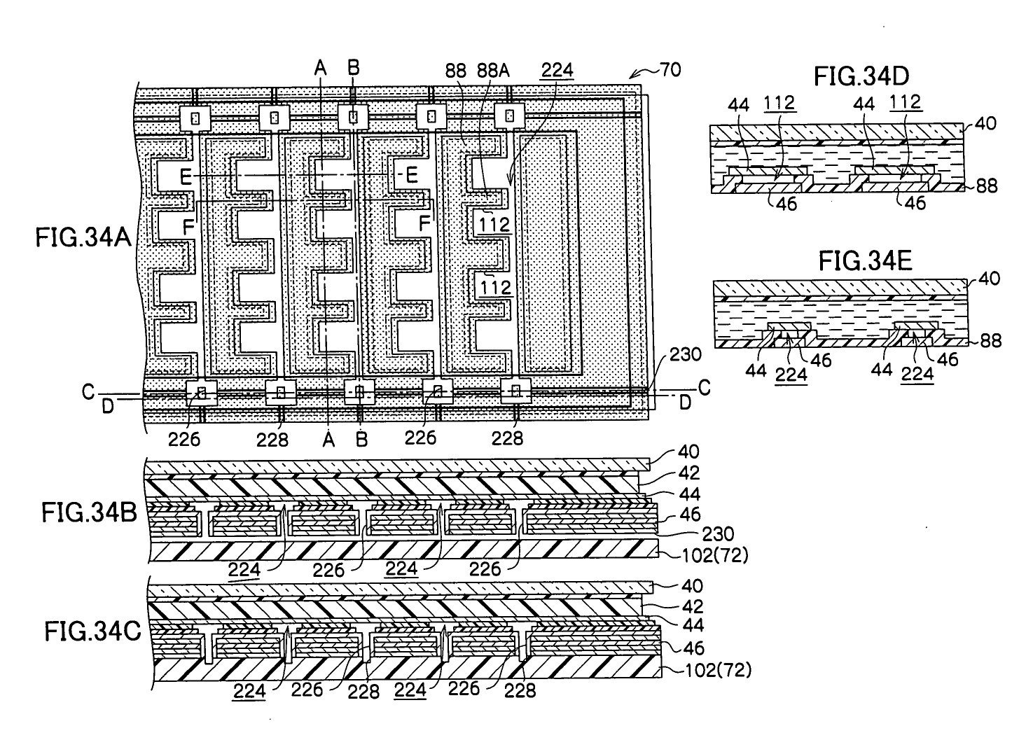

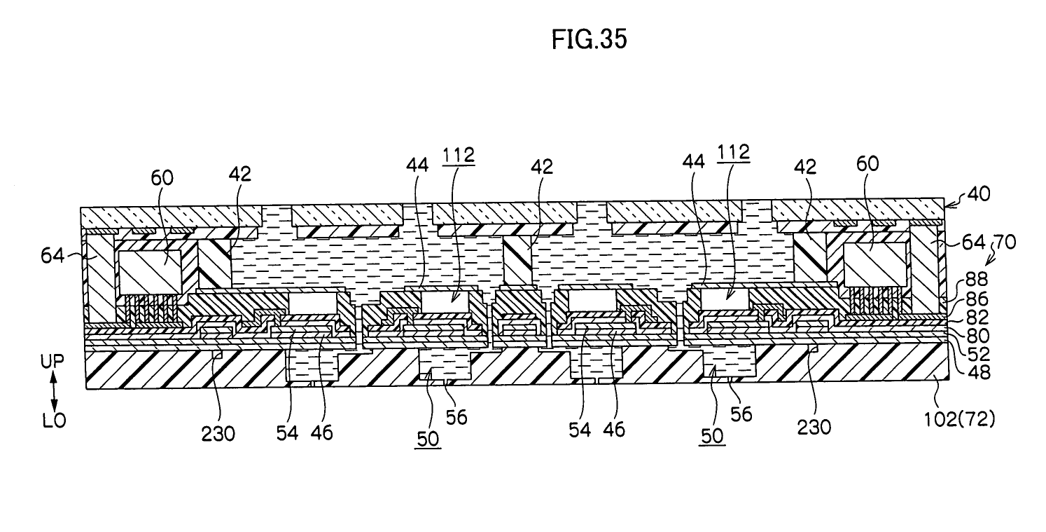

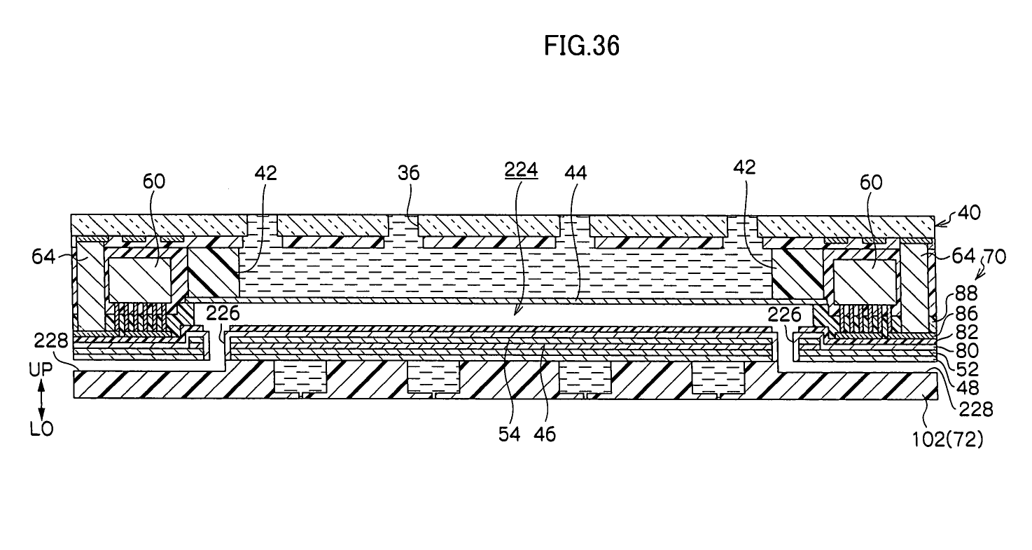

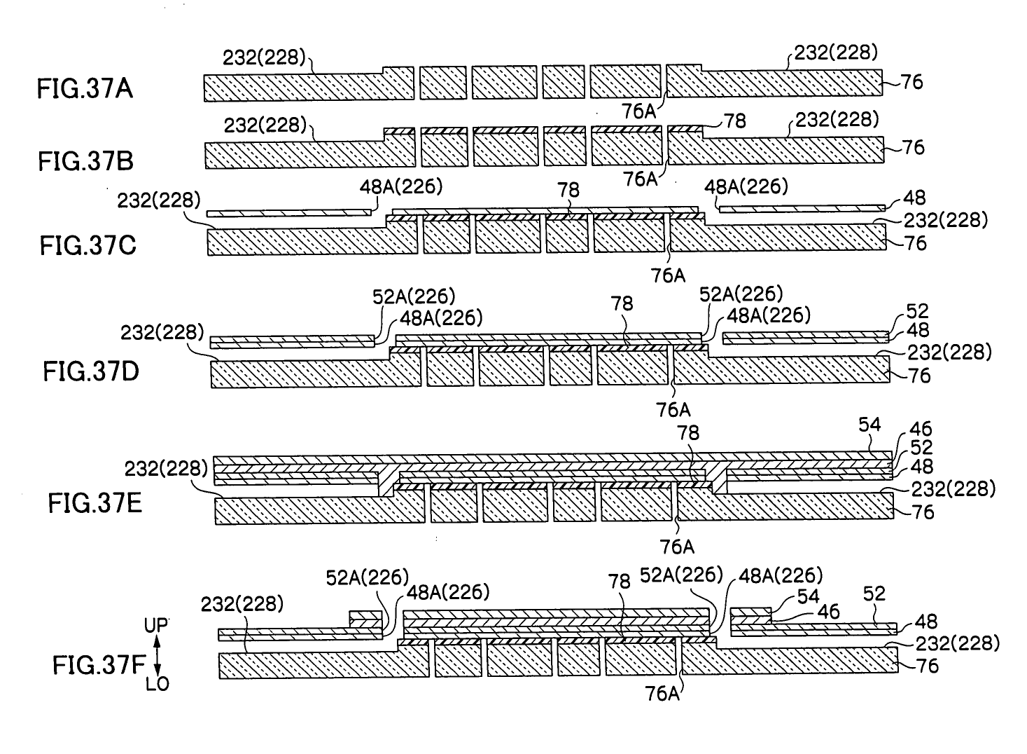

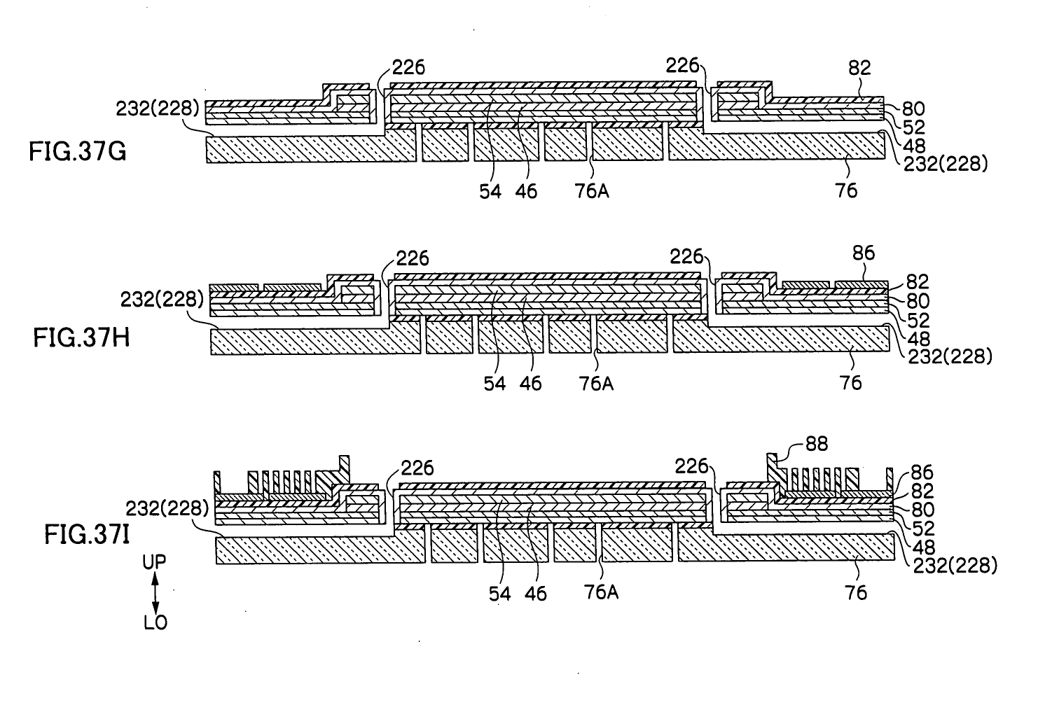

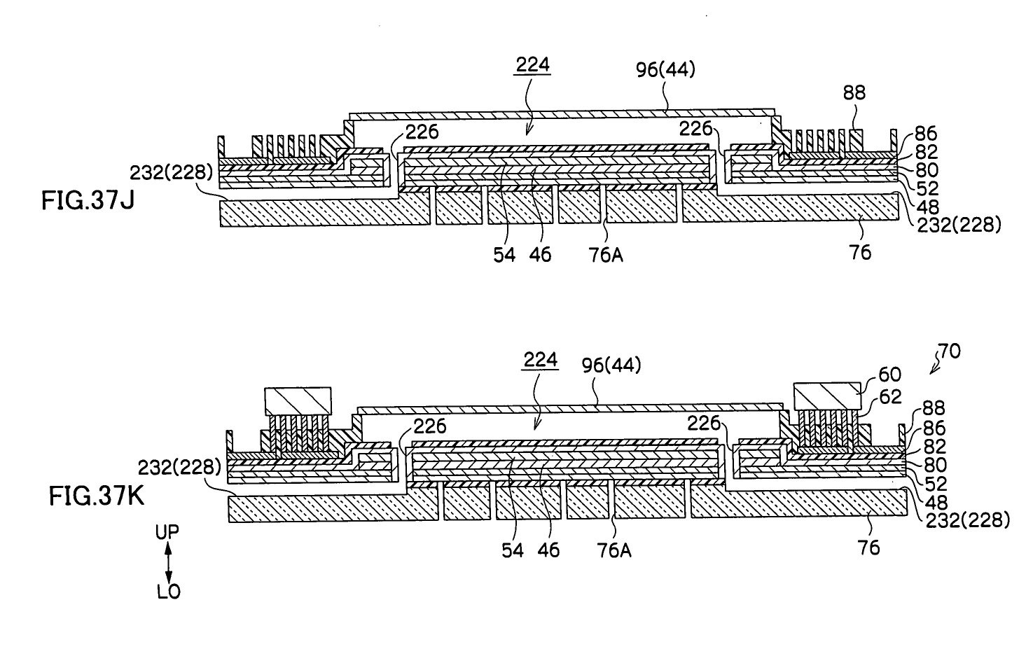

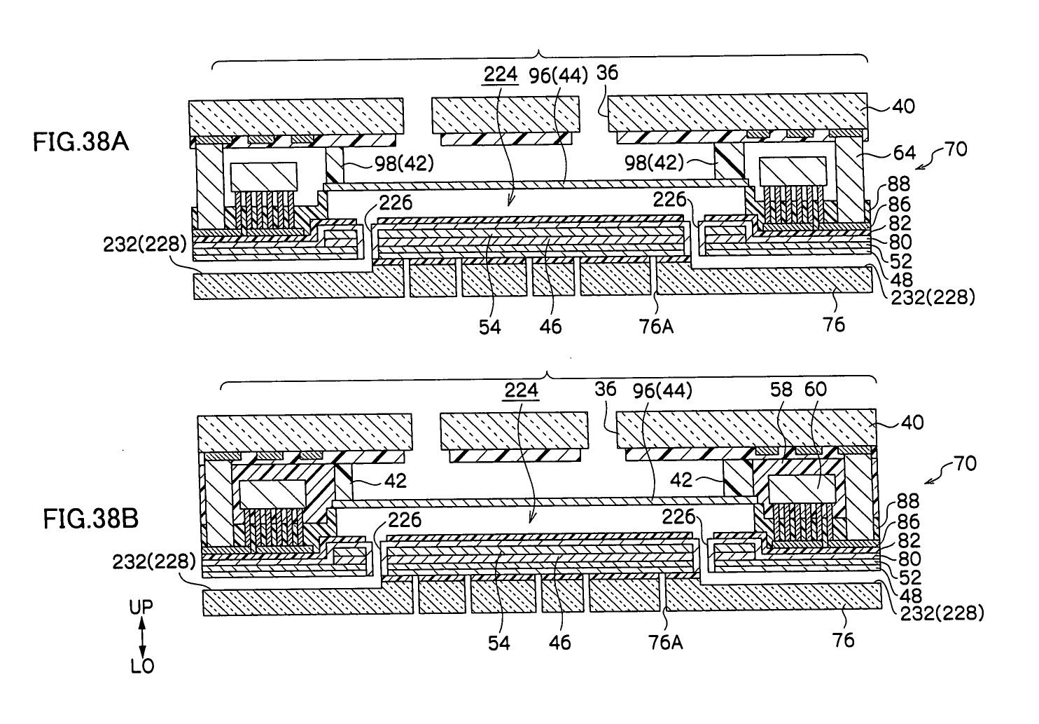

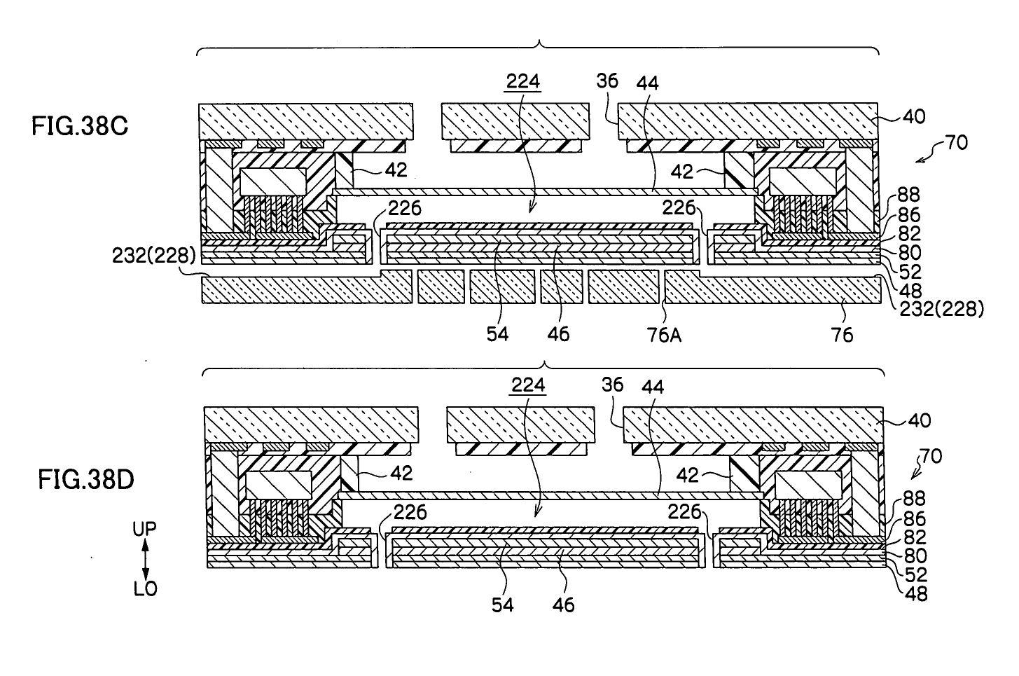

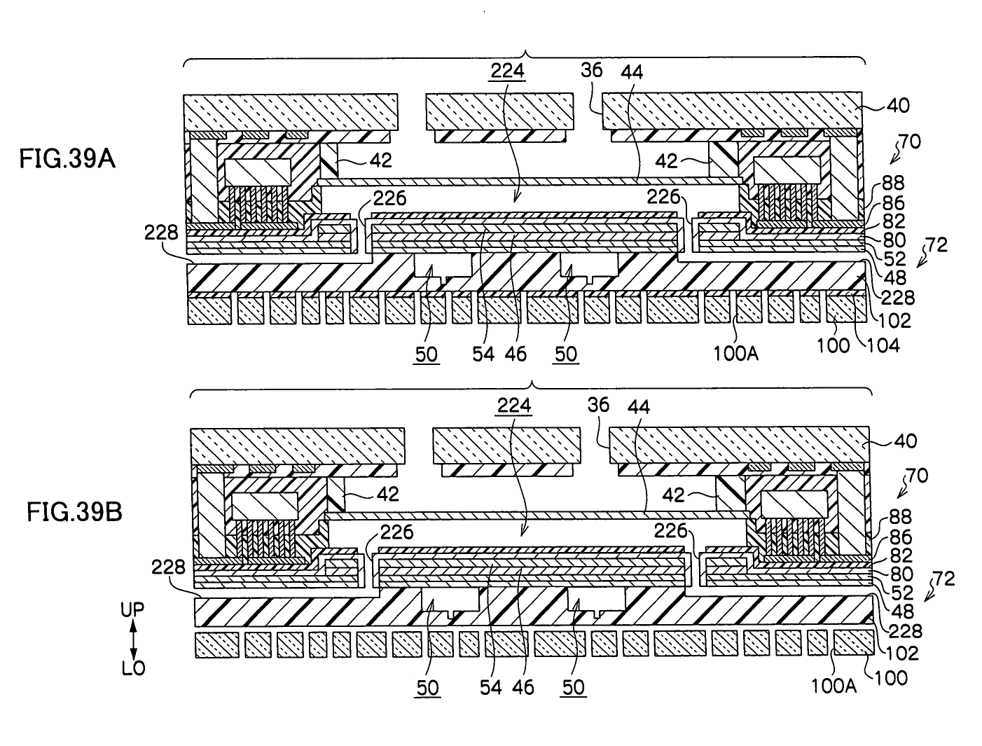

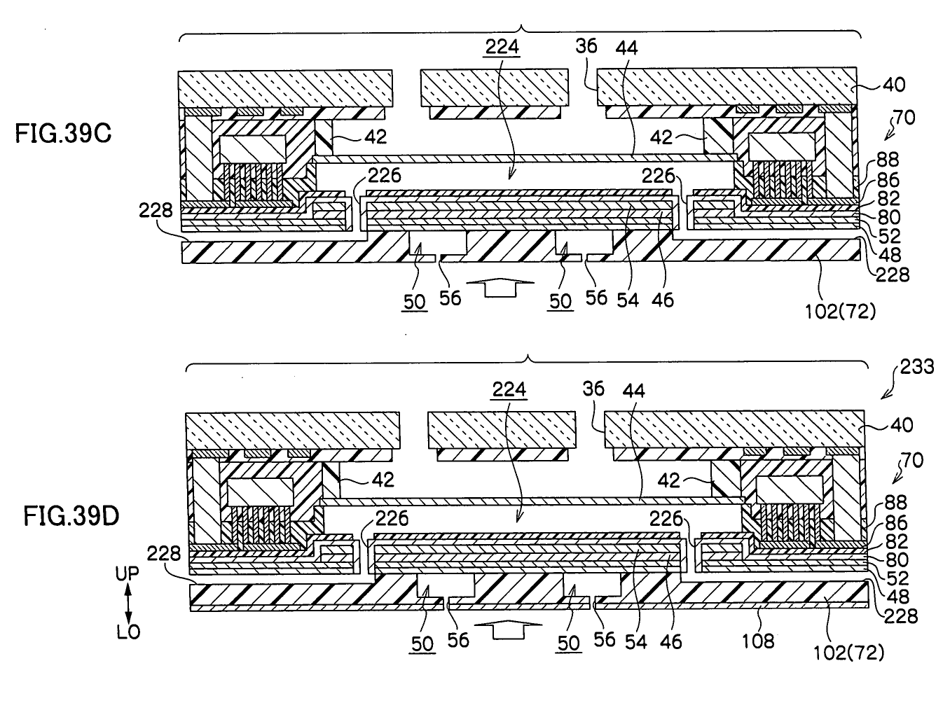

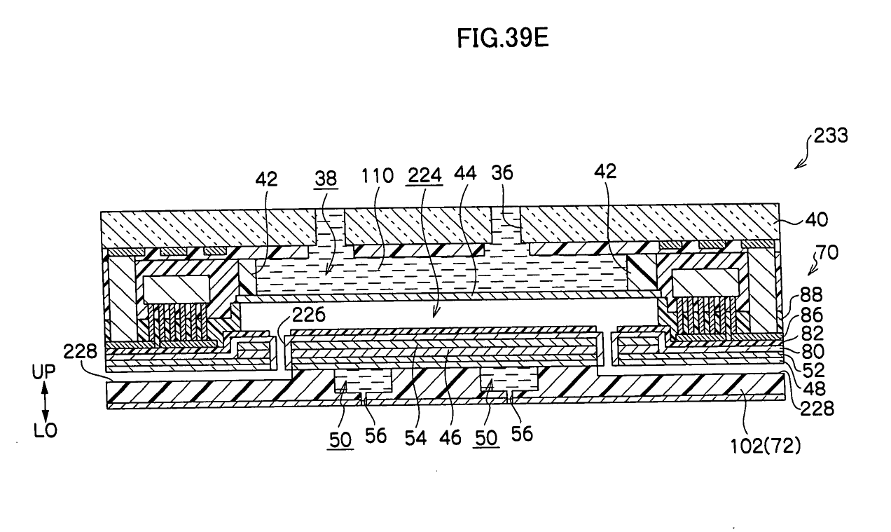

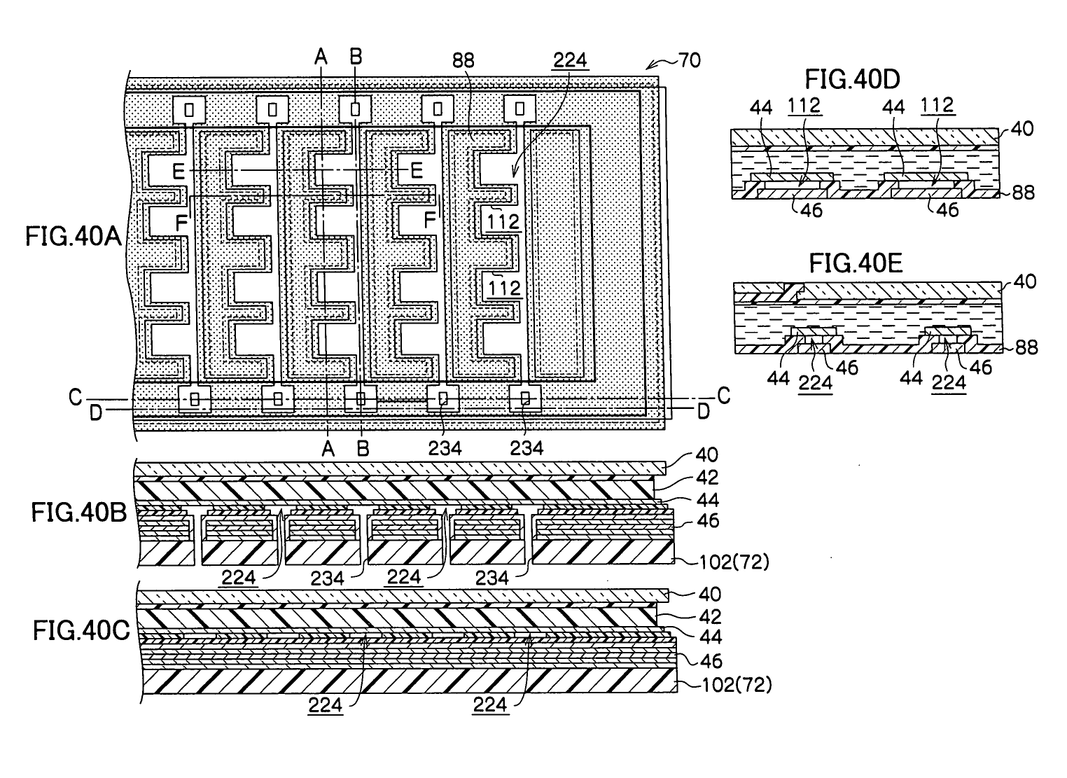

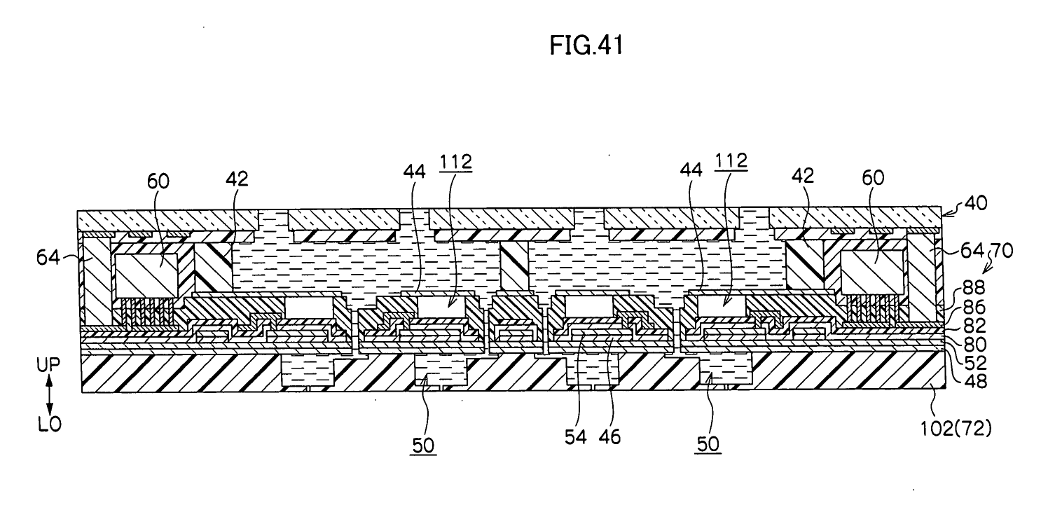

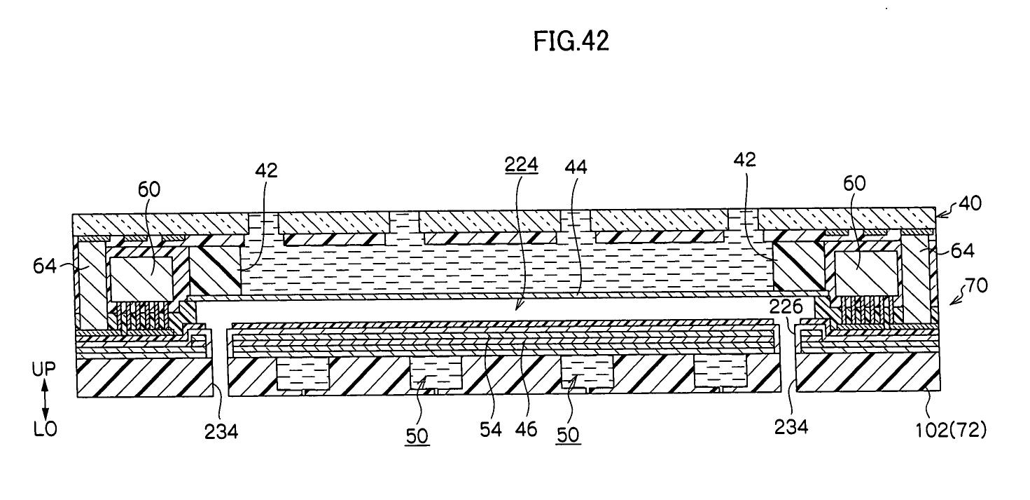

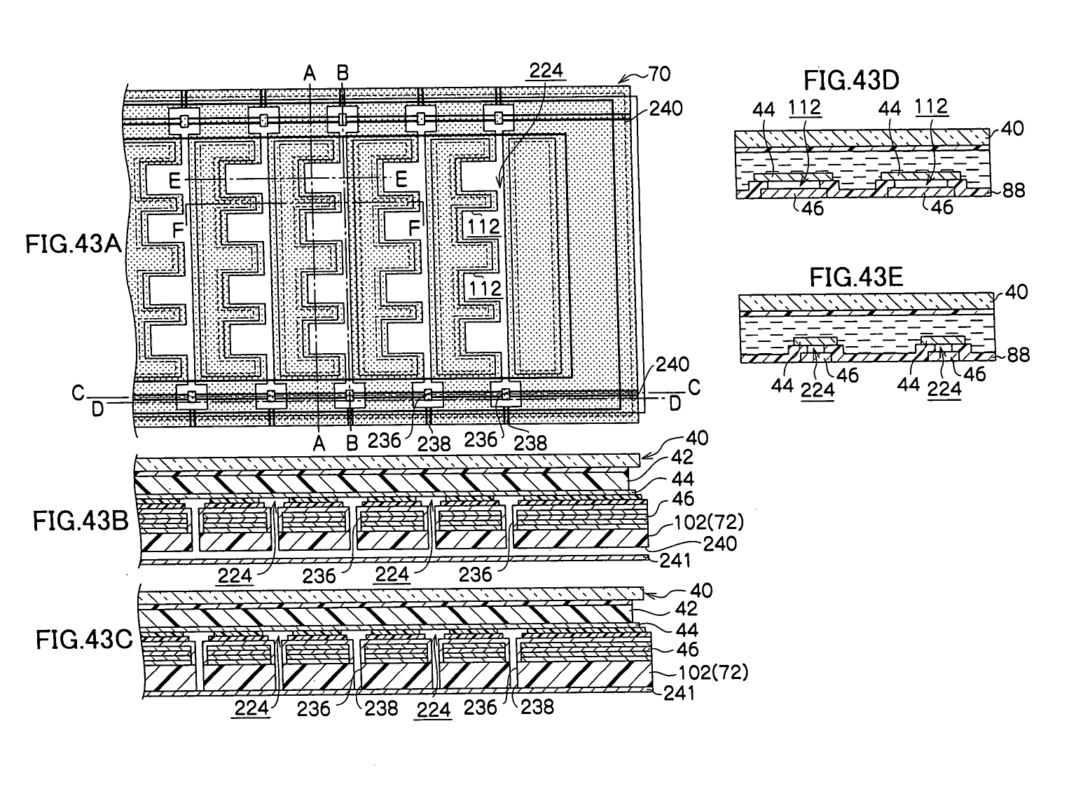

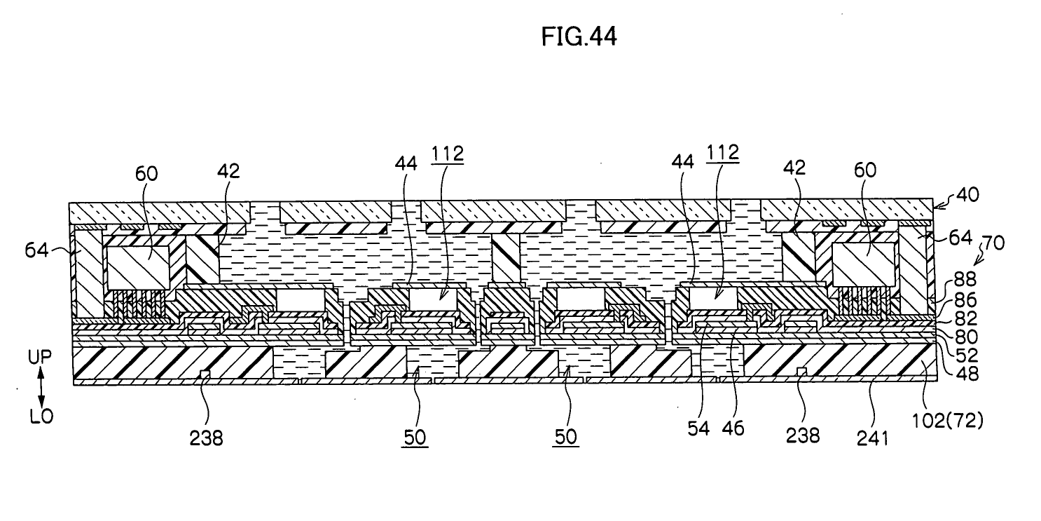

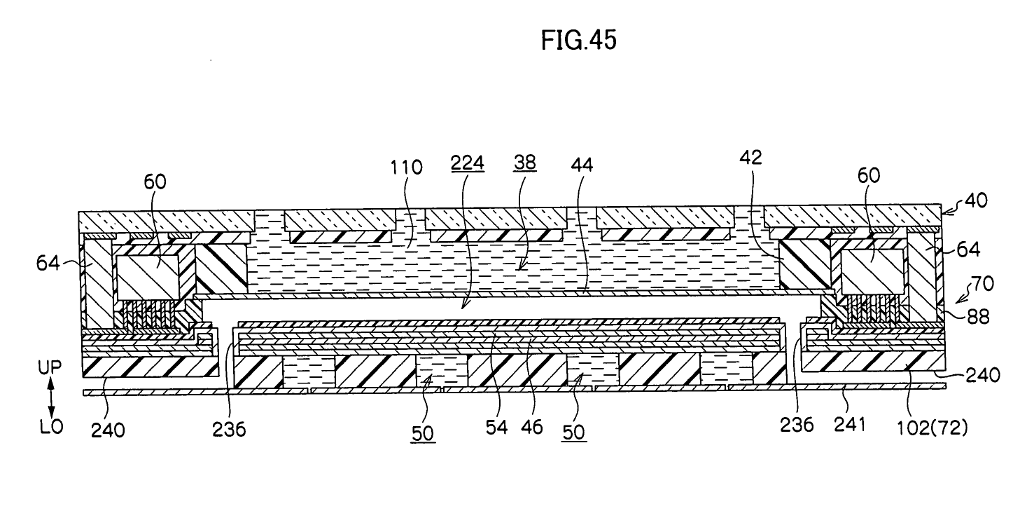

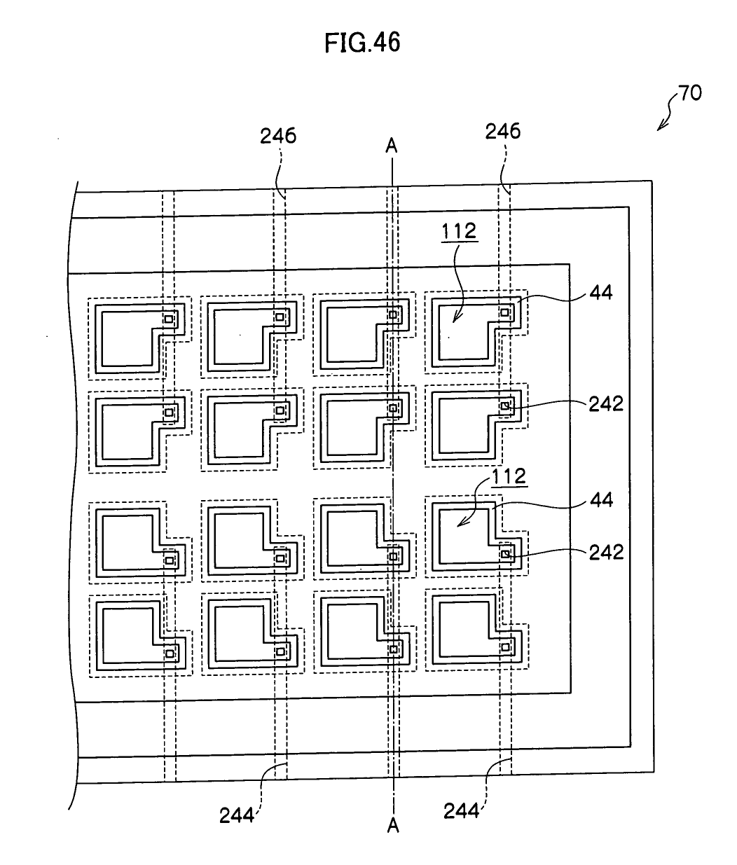

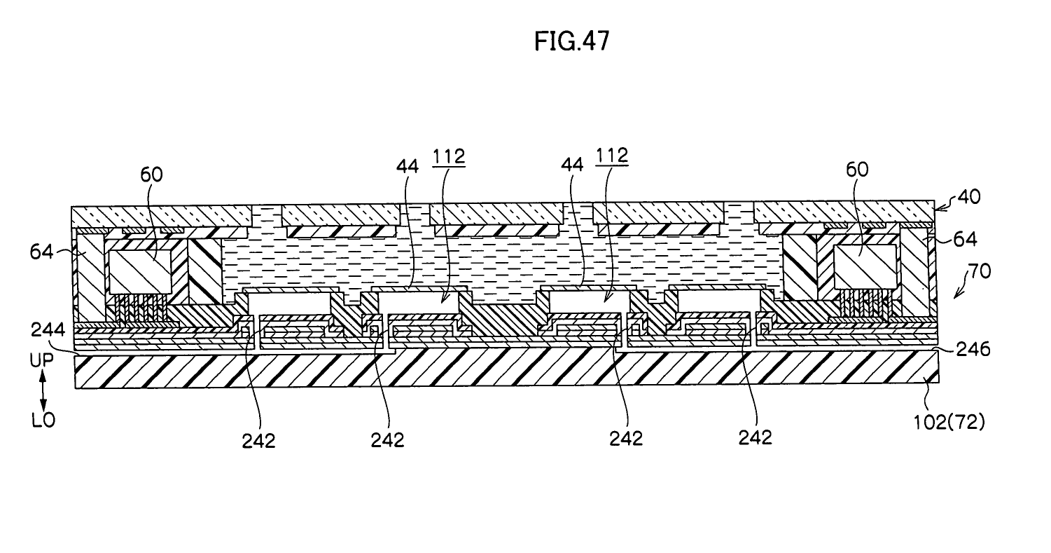

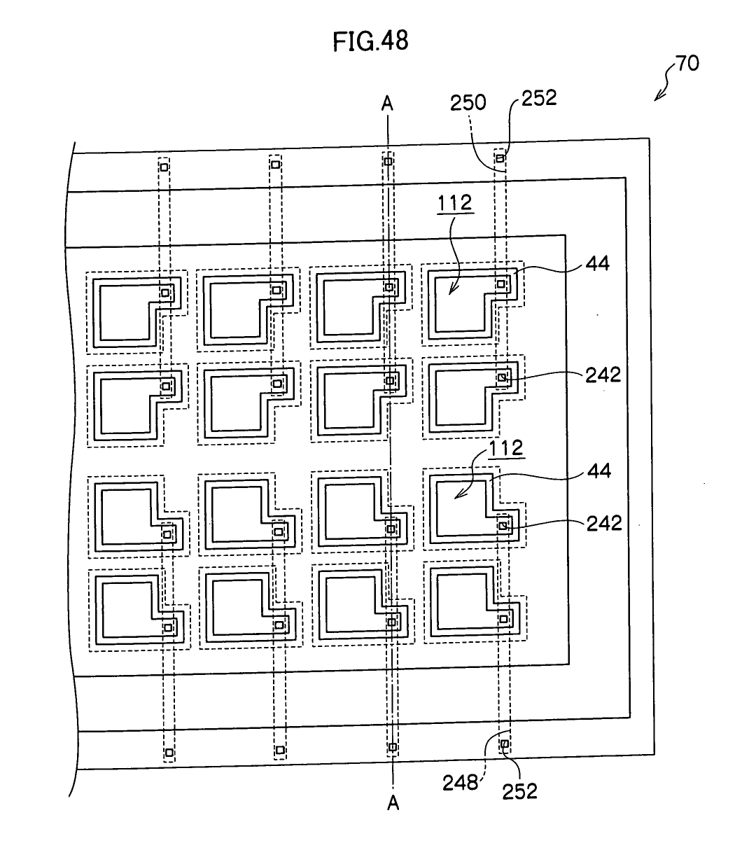

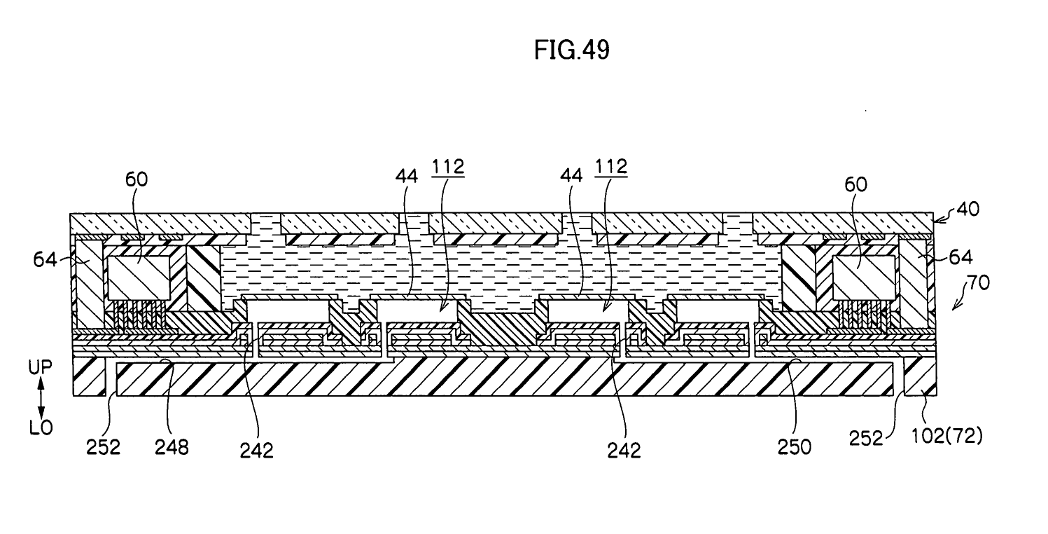

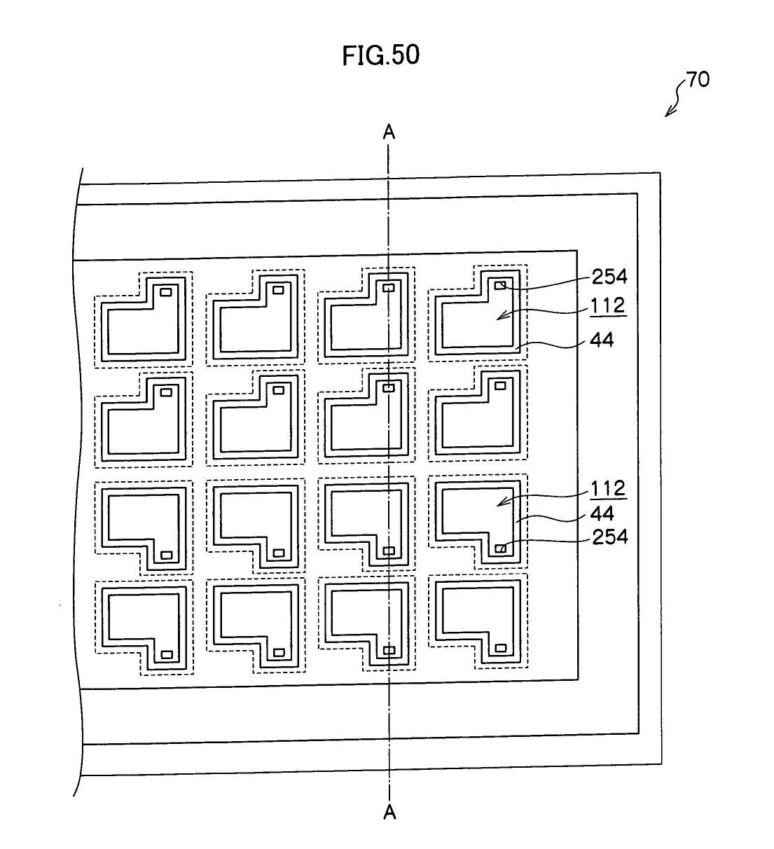

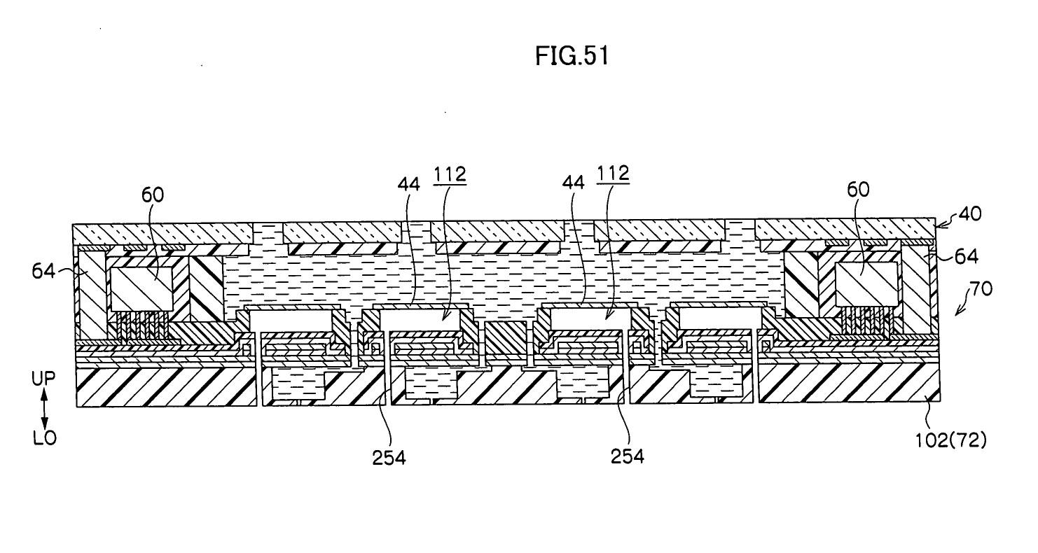

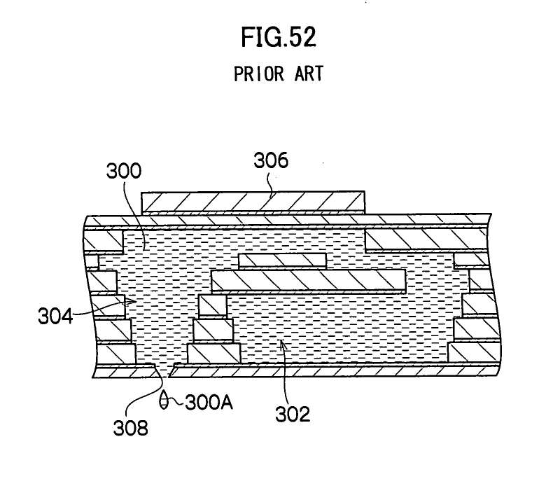

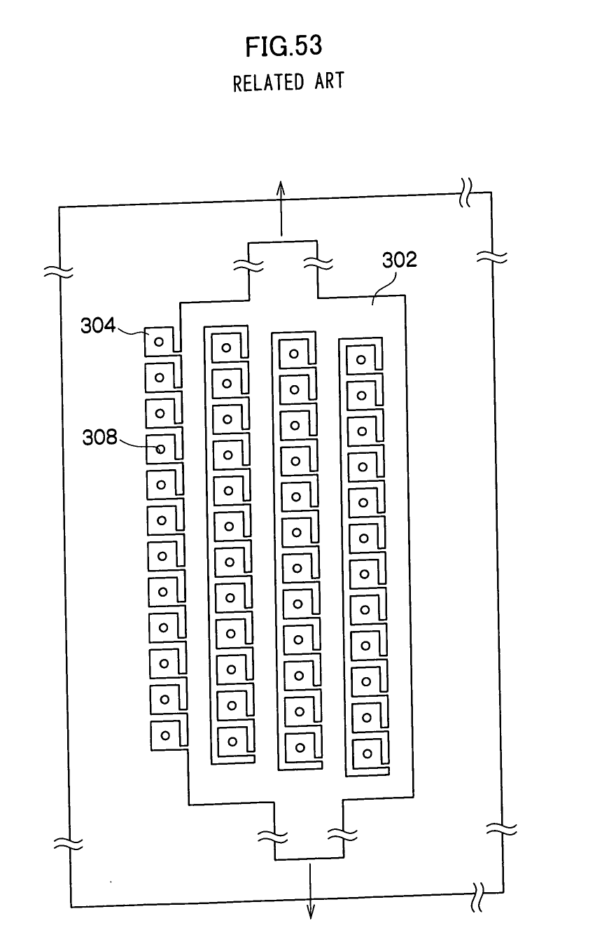

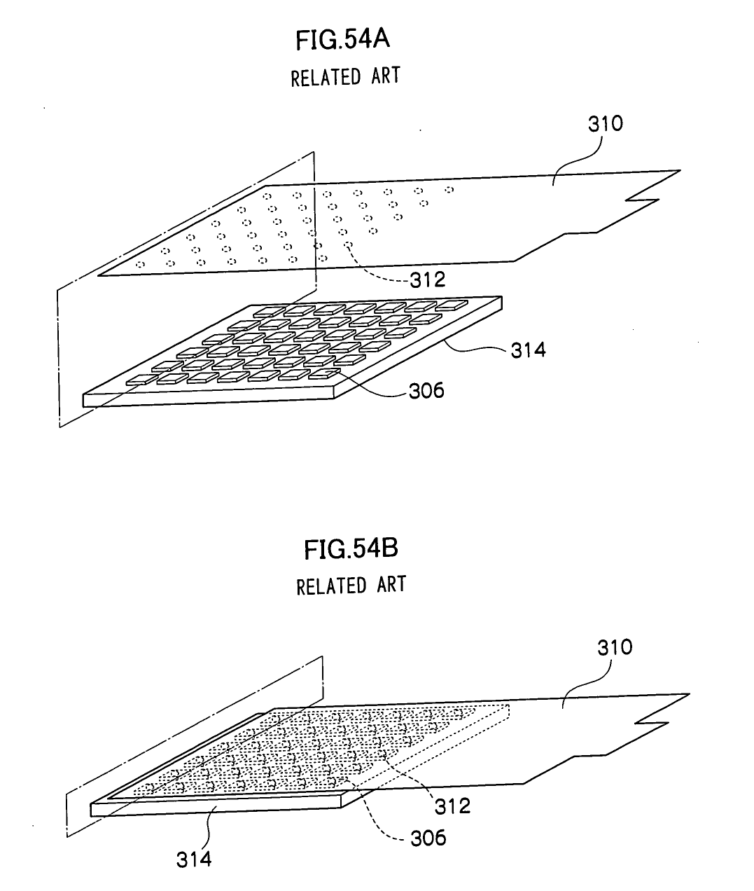

FIG. 31D is a sectional view taken along the line E-E of FIG. 34A;

FIG. 34E is a sectional view taken along the line F-F of FIG. 34A;

FIG. 35 is a sectional view taken along the line A-A of FIG. 34A;

FIG. 36 is a sectional view taken along the line B-B of FIG. 34A;

FIGS. 37A-37K are explanatory views showing the process steps for fabricating the piezoelectric element substrate according to the third embodiment of the present invention;

FIGS. 38A-38D are explanatory views showing the process steps for joining the top plate to the piezoelectric element substrate according to the third embodiment of the present invention;

FIGS. 39A-39E are explanatory views showing the process steps for joining the flow path substrate to the piezoelectric element substrate according to the third embodiment of the present invention;

FIG. 40A is a plan view showing the isolation chambers, the resin protective films, the communication regions, and so forth according to a modified example of the third embodiment of the present invention;

FIG. 40B is a sectional view taken along the line C-C of FIG. 40A;

FIG. 40C is a sectional view taken along the line D-D of FIG. 40A;

FIG. 40D is a sectional view taken along the line E-E of FIG. 40A;

FIG. 40E is a sectional view taken along the line F-F of FIG. 40A;

FIG. 41 is a sectional view taken along the line A-A of FIG. 40A;

FIG. 42 is a sectional view taken along the line B-B of FIG. 40A;

FIG. 43A is a plan view showing the isolation chambers, the resin protective films, the communication regions, and so forth according to a further modified example of the third embodiment of the present invention;

FIG. 43B is a sectional view taken along the line C-C of FIG. 43A;

FIG. 43C is a sectional view taken along the line D-D of FIG. 43A;

FIG. 43D is a sectional view taken along the line E-E of FIG. 43A;

FIG. 43E is a sectional view taken along the line F-F of FIG. 43A;

FIG. 44 is a sectional view taken along the line A-A of FIG. 43A;

FIG. 45 is a sectional view taken along the line B-B of FIG. 43A;

FIG. 46 is a plan view showing the isolation chambers, the resin protective films, the communication regions, and so forth according to a still further modified example of the third embodiment of the present invention;

FIG. 47 is a sectional view taken along the line A-A of FIG. 46;

FIG. 48 is a plan view showing the isolation chambers and the communication paths in a modified example of FIG. 46;

FIG. 49 is a sectional view taken along the line A-A of FIG. 48;

FIG. 50 is a plan view showing the isolation chambers and the communication paths in a further modified example of FIG. 46;

FIG. 51 is a sectional view taken along the line A-A of FIG. 50;

FIG. 52 is a schematic sectional view showing the structure of a conventional inkjet recording head;

FIG. 53 is a schematic plan view of a conventional inkjet recording head;

FIGS. 54A and 54B are schematic perspective views showing the structure of a conventional inkjet recording head.

### DETAILED DESCRIPTION OF THE INVENTION

Embodiments of the present invention will be described hereinbelow in detail on the basis of the drawings. Explanation will be given in which a recording paper P is used as a recording medium. The conveying direction of the recording paper P in an inkjet recording apparatus 10 is the subscanning direction and is denoted by arrow S, and the direction orthogonal to this conveying direction is the main scanning direction and is denoted by arrow M. Further, in the drawings, when arrow UP and arrow LO are shown, they express the upward direction and the downward direction, respectively, and when up and down are to be expressed, they correspond to these arrows, respectively.

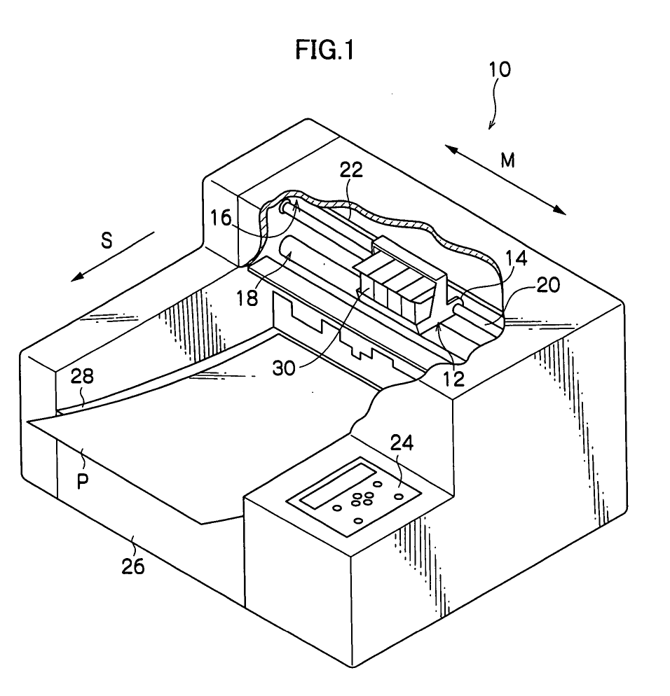

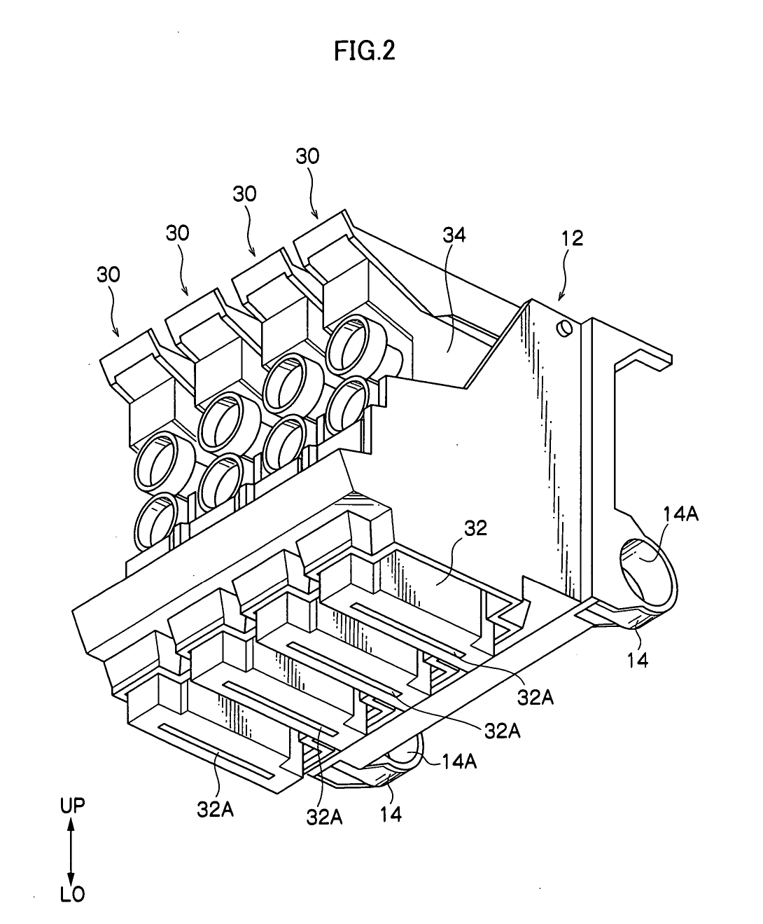

First, a summary of the inkjet recording apparatus 10 will be given. As shown in FIG. 1, the inkjet recording apparatus 10 has a carriage 12 in which are installed inkjet recording units 30 (inkjet recording heads 32) of black, yellow, magenta and cyan. A pair of brackets 14 project from the side of the carriage 12 which is the upstream side in the conveying direction of the recording paper P. Open holes 14A which are round (see FIG. 2) are formed in the brackets 14. A shaft 20, which spans in the main scanning direction, is inserted through the open holes 14A.

A driving pulley (not shown) and a driven pulley (not shown), which structure a main scanning mechanism 16, are disposed at the both ends in the main scanning direction. A portion of a timing belt 22, which is trained around the driving pulley and the driven pulley and which travels in the main scanning direction, is fixed to the carriage 12. Accordingly, the carriage 12 is supported so as to be able to move reciprocatingly in the main scanning direction.

A paper feed tray 26, in which the recording papers P before image printing are placed in a bundle, is provided at the inkjet recording apparatus 10. A catch tray 28 is provided above the paper feed tray 26. The recording papers P, on which images have been printed by the inkjet recording heads 32, are discharged out onto the catch tray 28. Also provided is a subscanning mechanism 18 formed by a conveying roller and a discharge roller which convey the recording papers P, which are fed-out one-by-one from the paper feed tray 26, at a predetermined pitch in the subscanning direction.

In addition, a control panel 24 for carrying out various types of settings at the time of printing, a maintenance station (not shown), and the like are provided at the inkjet recording apparatus 10. The maintenance station is structured so as to include a capping member, a suction pump, a dummy jet receptacle, a cleaning mechanism, and the like, and carries out maintenance operations such as suctioning and recovering, dummy jetting, cleaning, and the like.

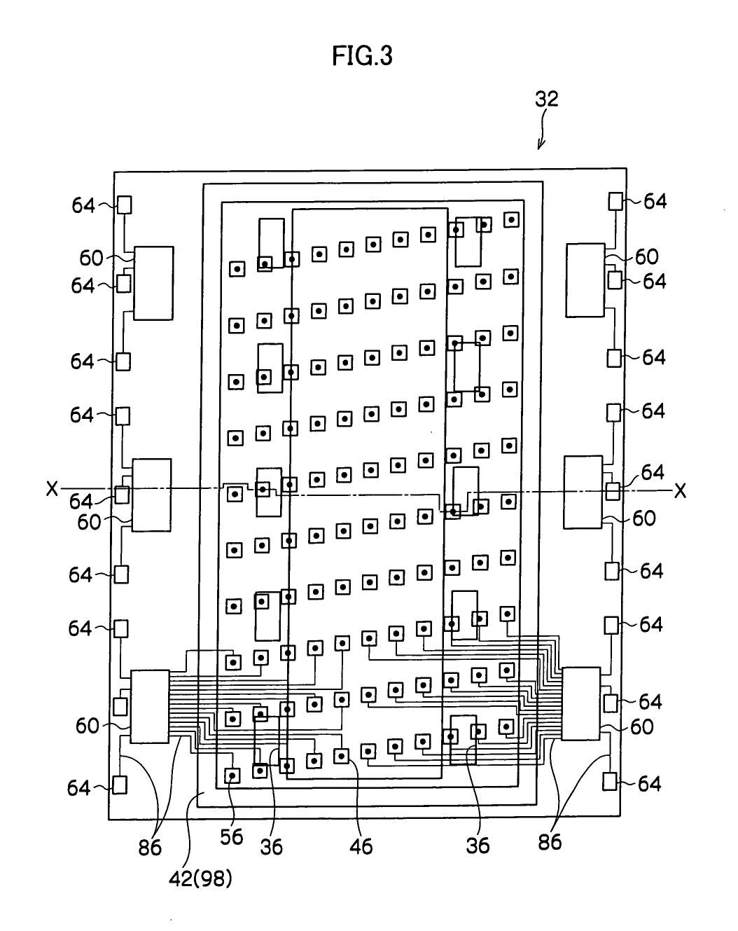

As shown in FIG. 2, at the inkjet recording unit 30 of each color, the inkjet recording head 32 and an ink tank 34, which supplies ink to the inkjet recording head 32, are structured integrally. The inkjet recording unit 30 is installed in the carriage 12 such that plural nozzles 56 (see FIG. 3), which are formed in an ink ejecting surface 32A at the center of the bottom surface of the inkjet recording head 32, face the recording paper P. Accordingly, due to the inkjet recording heads 32 selectively ejecting ink droplets from the nozzles 56 onto the recording paper P while the inkjet recording heads 32 are moved in the main scanning direction by the main scanning mechanism 16, a portion of an image based on image data is recorded at a predetermined band region.

When movement of one time in the main scanning direction is completed, the recording paper P is conveyed by a predetermined pitch in the subscanning direction by the subscanning mechanism 18. A portion of the image based on the image data is recorded on the next band region while the inkjet recording heads 32 (the inkjet recording units 30) are again moved in the main scanning direction (in the direction opposite to that previously). By repeating this operation plural times, the entire image which is based on the image data is recorded on the recording paper P in full color.

Next, the inkjet recording head 32 in the inkjet recording apparatus 10 having the above-described structure will be described in detail.

### First Embodiment

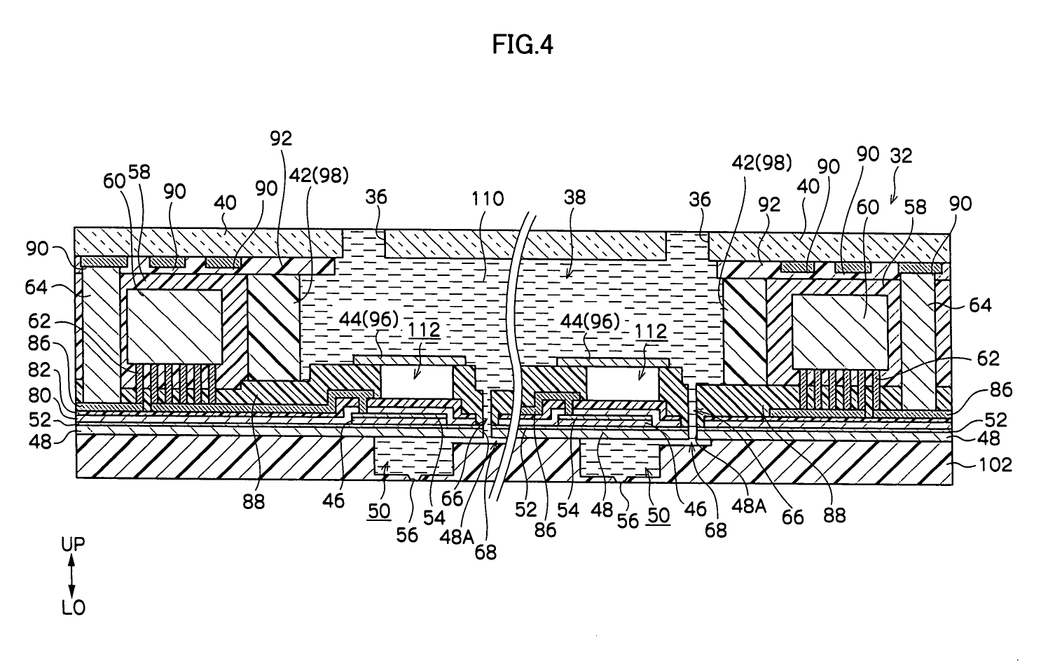

FIG. 3 is a schematic plan view showing the structure of the inkjet recording head 32, and FIG. 4 is a schematic sectional view taken along line X-X of FIG. 3. As shown in FIGS. 3 and 4, ink supplying ports 36, which communicate with the ink tank 34, are provided at the inkjet recording head 32. Ink 110, which is injected-in from these ink supplying ports 36, is pooled in an ink pooling chamber 38.

The volume of the ink pooling chamber 38 is regulated by a top plate 40 and a partitioning wall 42. A plurality of the ink supplying ports 36 are formed in lines at predetermined places on the top plate 40. Further, an air damper 44 (a photosensitive dry film 96 which will be described later), which is made of resin and mitigates pressure waves, is provided in the ink pooling chamber 38, further toward the inner side than the top plate 40.

Any material, such as glass, ceramic, silicon, resin, or the like for example, may be used as the material of the top plate 40, provided that it is an insulator which has a strength such that it can become the supporting body of the inkjet recording head 32. Further, metal wires 90, which are for energizing driving ICs 60 which will be described later, are provided at the top plate 40. The metal wires 90 are covered and protected by a resin film 92, such that erosion of the metal wires 90 due to the ink 110 is prevented.

The partitioning wall 42 is molded of resin (a photosensitive dry film 98 which will be described later), and partitions the ink pooling chamber 38 into a rectangular shape. Further, the ink pooling chamber 38 is separated, above and below, from pressure chambers 50 via piezoelectric elements 46 and vibrating plates 48 which are flexurally deformed in the top-bottom direction by the piezoelectric elements 46. Namely, the piezoelectric elements 46 and the vibrating plates 48 are structured so as to be disposed between the ink pooling chamber 38 and the pressure chambers 50, and the ink pooling chamber 38 and the pressure chambers 50 are structured so as to not exist on the same horizontal plane.

Accordingly, the pressure chambers 50 can be disposed in a state of being near to one another, and the nozzles 56 can be disposed in the form of a matrix and at a high density. With such a structure, an image can be formed in a wide band region due to the carriage 12 moving one time in the main scanning direction. Therefore, the scanning time can be made to be short. Namely, it is possible to realize high-speed printing in which an image is formed over the entire surface of the recording paper P in a short time and by a small number of times of movement of the carriage 12.

The piezoelectric elements 46 are disposed in the form of a matrix (see FIGS. 5A and 5B), and are adhered onto the top surface of the vibrating plates 48 for each pressure chamber 50. The vibrating plates 48 are formed of a metal such as SUS or the like, and are elastic at least in the top-bottom direction. When the piezoelectric element 46 is energized (i.e., when voltage is applied to the piezoelectric element 46), the vibrating plate 48 is flexurally deformed (is displaced) in the top-bottom direction. Note that the vibrating plate 48 may be an insulating material such as glass or the like. Lower electrodes 52, which are of one polarity, are disposed at the bottom surfaces of the piezoelectric elements 46. Upper electrodes 54, which are of the other polarity, are disposed on the top surfaces of the piezoelectric elements 46. The driving ICs 60 are electrically connected to the upper electrodes 54 by metal wires 86.

The piezoelectric elements 46 are covered and protected by a low water permeability insulating film (SiOx film) 80. The low water permeability insulating film 80 (SiOx film), which covers and protects the piezoelectric elements 46, is formed under the condition that the moisture permeability thereof is low. Therefore, the low water permeability insulating film 80 can prevent poor reliability due to moisture infiltrating the piezoelectric elements 46 (a deterioration in the piezoelectric characteristic caused by the oxygen within the PZT film being reduced). Note that the vibrating plate 48, which is formed of metal (SUS or the like) and contacts the lower electrode 52, also functions as a low-resistance GND wire.

Moreover, the top surface of the low water permeability insulating film (SiOx film) 80 is covered and protected by a resin film 82. In this way, the resistance to erosion by the ink 110 is ensured. The metal wires 86 as well are covered and protected by a resin protective film 88, such that erosion of the metal wires 86 due to the ink 110 is prevented.

The regions above the piezoelectric elements 46 are covered and protected by the resin film 82, and are not covered by the resin protective film 88. Because the resin film 82 is a flexible resin layer, due to such a structure, an impediment to displacement of the piezoelectric elements 46 (the vibrating plate 48) is prevented (the piezoelectric elements 46 (the vibrating plate 48) can flexurally deform appropriately in the top-bottom direction). Namely, at the resin layer above the piezoelectric elements 46, the thinner the layer is, the better the effect of suppressing the impediment to displacement becomes. Therefore, the resin protective film 88 is not provided above the piezoelectric elements 46. Further, on the top surface of the resin protective film 88 and in a manner so as to face the piezoelectric element 46 is provided an air damper 44 (a photosensitive dry film 96 which will be described later), which is made of resin and mitigates pressure waves.

The driving ICs 60 are disposed at the outer sides of the ink pooling chamber 38 which is defined by the partitioning wall 42, and between the top plate 40 and the vibrating plate 48. The driving ICs 60 are structured so as to not be exposed (projected out) from the vibrating plate 48 or the top plate 40. Accordingly, the inkjet recording head 32 can be made more compact.

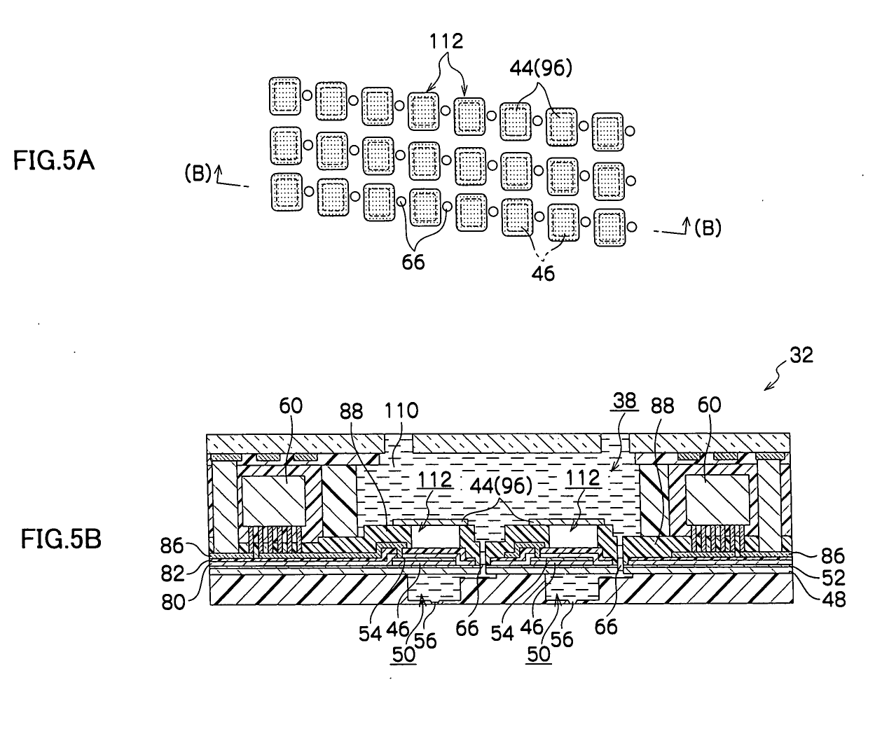

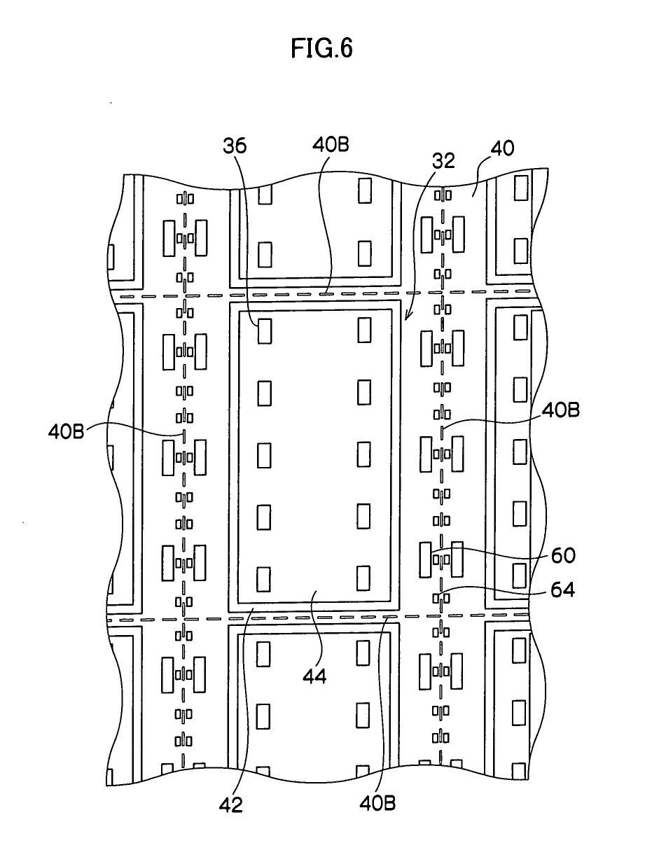

The peripheries of the driving ICs 60 are sealed by a resin material 58. As shown in FIG. 6, plural injection openings 40B for the resin material 58 which seals the driving ICs 60 are formed in the top plate 40 in the manufacturing step, in a grid-like form so as to partition the respective inkjet recording heads 32. After the uniting (joining) of a piezoelectric element substrate 70 and a flow path substrate 72 which will be described later, the top plate 40 is cut along the injection openings 40B which are sealed (closed) by the resin material 58. In this way, a plurality of the inkjet recording heads 32, which have the nozzles 56 (see FIG. 3) in a matrix form, are manufactured at one time.

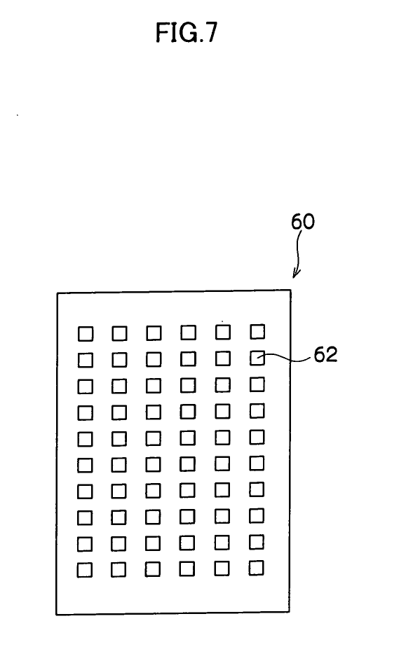

As shown in FIGS. 4 and 7, plural bumps 62 project out by predetermined heights and in the form of a matrix at the bottom surface of the driving IC 60, so as to be flip-chip assembled at the metal wires 86 of the piezoelectric element substrate 70 at which the piezoelectric elements 46 are formed on the vibrating plate 48. Accordingly, high-density connection to the piezoelectric elements 46 can be realized easily, and a reduction in the height of the driving IC 60 is possible (the driving IC 60 can be made thinner). For this reason as well, the inkjet recording head 32 can be made more compact.

As shown in FIG. 3, bumps 64 are provided at the outer sides of the driving ICs 60. The bumps 64 connect metal wires 90 provided at the top plate 40, and the metal wires 86 provided at the piezoelectric element substrate 70. The bumps 64 are of course provided so as to be higher than the heights of the driving ICs 60 assembled on the piezoelectric element substrate 70.

Accordingly, the metal wires 90 of the top plate 40 are energized from the main body of the inkjet recording apparatus 10, and the metal wires 86 are energized from the metal wires 90 of the top plate 40 via the bumps 64. Thus, the driving ICs 60 are energized. Voltage is applied to the piezoelectric elements 46 at a predetermined timing by the driving ICs 60, such that the vibrating plate 48 is flexurally deformed in the top-bottom direction. The ink 110 filled in the pressure chambers 50 is thereby pressurized, such that ink droplets are ejected from the nozzles 56.

One nozzle 56 which ejects the ink droplets is provided for each pressure chamber 50, at a predetermined position thereof. The pressure chamber 50 and the ink pooling chamber 38 are connected by an ink flow path 66 and an ink flow path 68 communicating with one another. The ink flow path 66 bypasses the piezoelectric element 46 and passes through a through-hole 48A formed in the vibrating plate 48. The ink flow path 68 extends horizontally in FIG. 4 from the pressure chamber 50. The ink flow path 68 is provided in advance so as to be a little longer than the portion actually connected to the ink flow path 66, such that the ink flow path 68 can be aligned with the ink flow path 66 (such that they can reliably be made to communicate with one another) at the time of manufacturing the inkjet recording head 32.

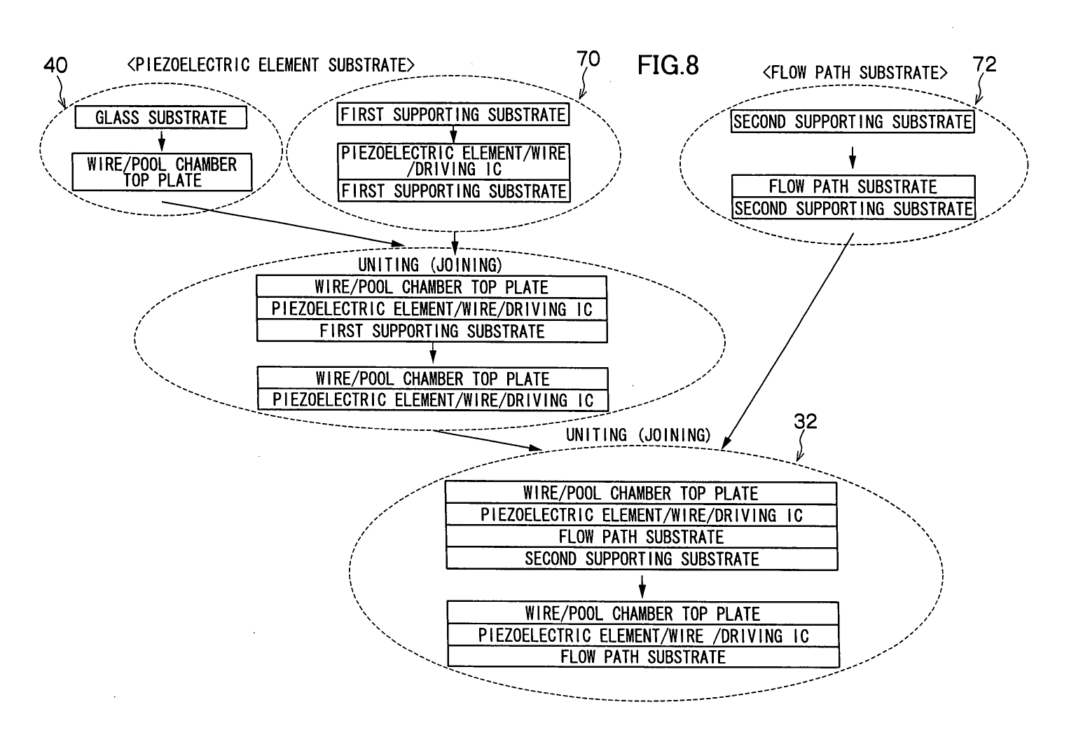

Next, the manufacturing processes of the inkjet recording head 32, which is structured as described above, will be described in detail with reference to FIGS. 8 through 13. As shown in FIG. 8, the inkjet recording head 32 is manufactured by forming the piezoelectric element substrate 70 and the flow path substrate 72 separately, and then uniting (joining) the two together. Thus, the process of manufacturing the piezoelectric element substrate 70 will be described first. However, the top plate 40 is united (joined) to the piezoelectric element substrate 70 before the flow path substrate 72.

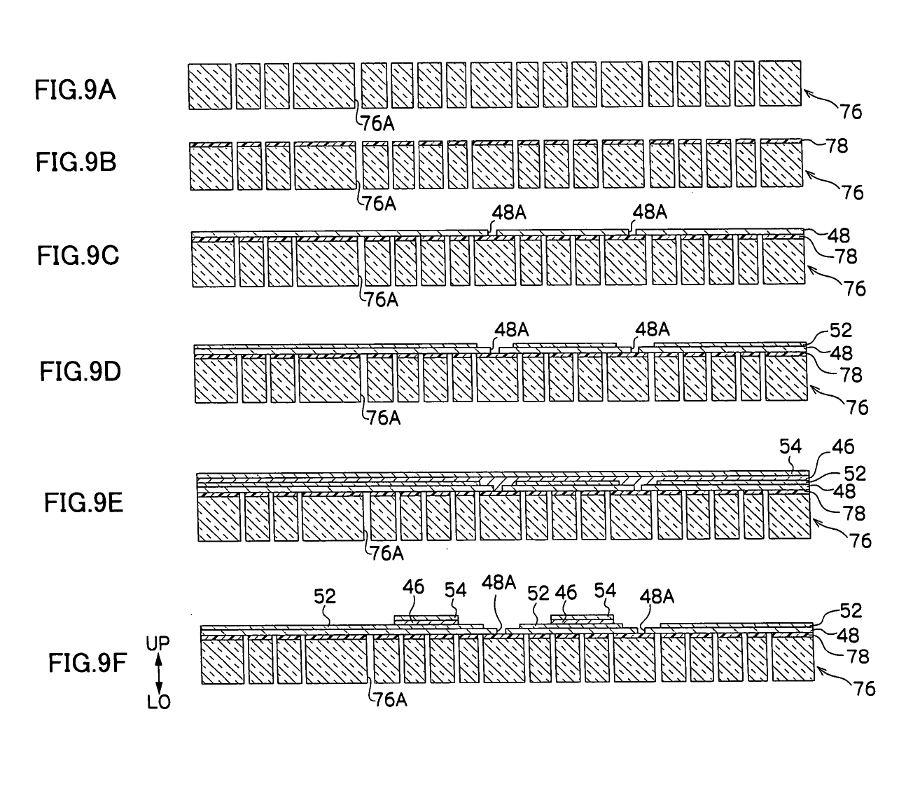

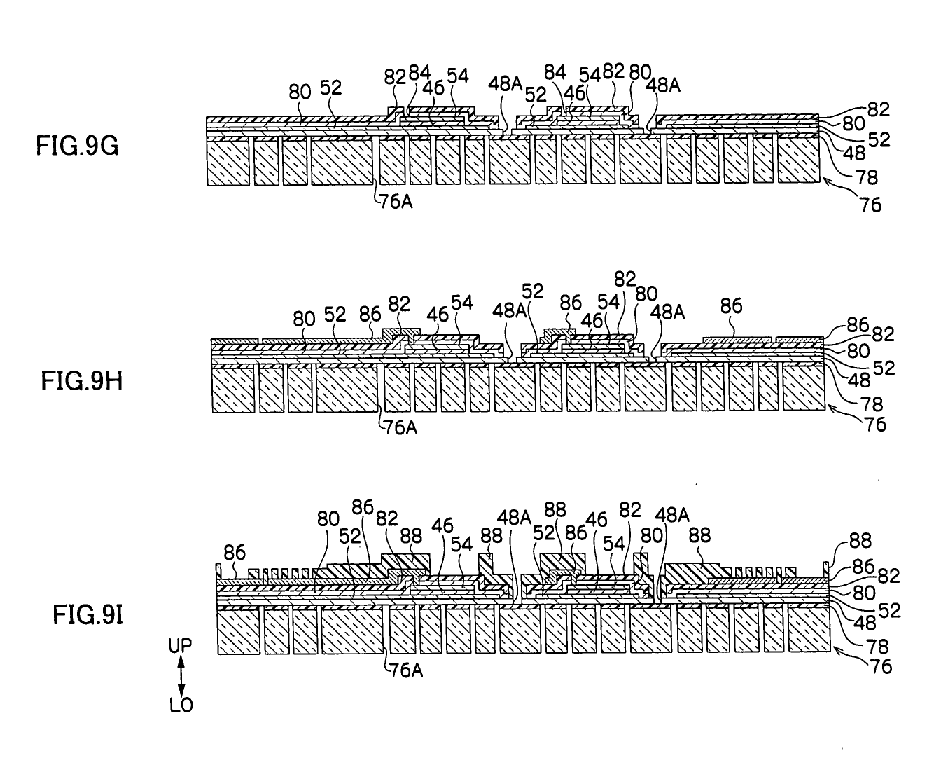

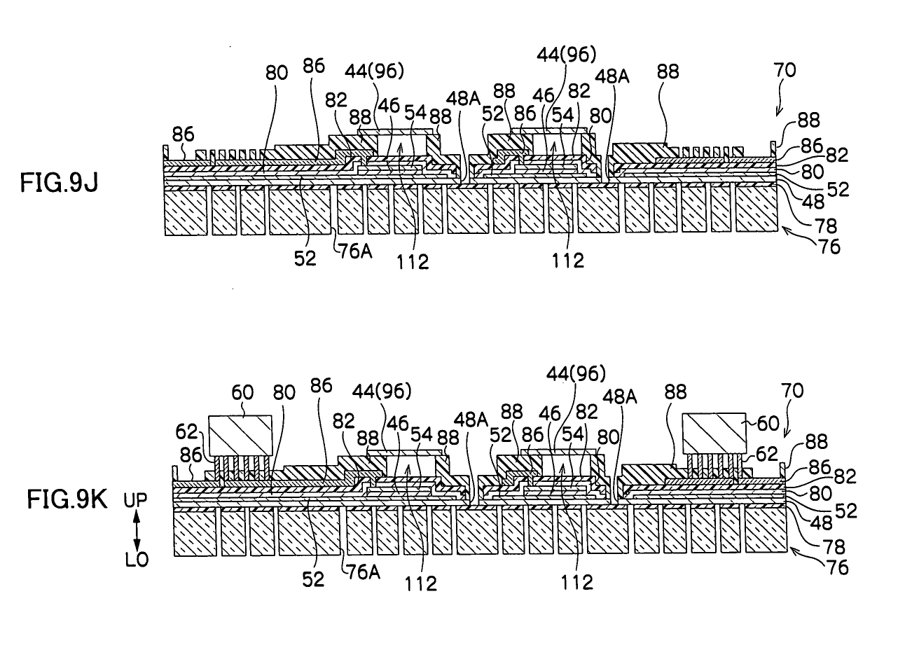

As shown in FIG. 9A, a first supporting substrate 76 is first prepared, which is formed of glass and in which plural through-holes 76A are formed. The first supporting substrate 76 may be any material provided that it does not flex, and is not limited to being formed of glass, but glass is preferable as it is hard and inexpensive. Blast machining or femtosecond laser machining of a glass substrate, exposure and development of a photosensitive glass substrate (e.g., PEG3C manufactured by Hoya Corporation), and the like are known as methods for fabricating the first supporting substrate 76.

Then, as shown in FIG. 9B, an adhesive 78 is applied to the top surface (the obverse) of the first supporting substrate 76, and, as shown in FIG. 9C, the vibrating plate 48 which is formed of metal (SUS or the like) is adhered on the top surface. At this time, it is ensured that the through-holes 48A of the vibrating plate 48 and the through-holes 76A of the first supporting substrate 76 are not superposed (do not overlap). Note that an insulating substrate of glass or the like may be used as the material of the vibrating plate 48.

Here, the through-holes 48A of the vibrating plate 48 are for forming the ink flow paths 66. Further, the reasons why the through-holes 76A are provided in the first supporting substrate 76 are in order to allow a chemical liquid (solvent) to flow-in to the boundary surface between the first supporting substrate 76 and the vibrating plate 48 in a later step, and in order to dissolve the adhesive 78 and remove the first supporting substrate 76 from the vibrating plate 48. Further, the reason why the through-holes 76A of the first supporting substrate 76 and the through-holes 48A of the vibrating plate 48 are made to not overlap is in order for the respective materials which are used in manufacturing to not leak out from the bottom surface (the reverse surface) of the first supporting substrate 76.

Next, as shown in FIG. 9D, the lower electrode 52, which is layered on the top surface of the vibrating plate 48, is patterned. Specifically, metal film sputtering (film thickness: 500 Å to 3000 Å), resist formation by photolithography, patterning (etching), and resist removal by oxygen plasma are carried out. This lower electrode 52 is to be at a ground potential. Next, as shown in FIG. 9E, a PZT film, which is the material of the piezoelectric elements 46, and the upper electrodes 54 are layered in that order by sputtering on the top surface of the lower electrode 52. As shown in FIG. 9F, the piezoelectric elements 46 (the PZT film) and the upper electrodes 54 are patterned.

Specifically, PZT film sputtering (film thickness: 3 μm to 15 μm), metal film sputtering (film thickness: 500 Å to 3000 Å), resist formation by photolithography, patterning (etching), and resist removal by oxygen plasma are carried out. Examples of the material for the lower and upper electrodes include Au, Ir, Ru, Pt, and the like, which are heat-resistant and have good affinity with the PZT material which forms the piezoelectric elements.

Thereafter, as shown in FIG. 9G, the low water permeability insulating film (SiOx film) 80 is layered on the exposed portions of the top surface of the lower electrode 52 and the top surfaces of the upper electrodes 54. Then, the resin film 82 which is ink-resistant and flexible, e.g., a resin film of a polyimide, a polyamide, an epoxy, a polyurethane, a silicon, or the like, is layered on the top surface of the low water permeability insulating film (SiOx film) 80. By patterning these films, openings 84 (contact holes) for connecting the piezoelectric elements 46 and the metal wires 86 are formed.

Specifically, the following processes are carried out: the low water permeability insulating film (SiOx film) 80 which has a high dangling bond density is formed by chemical vapor deposition (CVD); a photosensitive polyimide (e.g., photosensitive polyimide Durimide 7520 manufactured by FUJIFILM Electronics Materials Co., Ltd.) is coated, exposed, and developed so as to be patterned; and the SiOx film is etched by using the photosensitive polyimide as a mask, by reactive ion etching (RIE) using CF₄ gas. Note that an SiOx film is used as the low water permeability insulating film here, but an SiNx film, an SiOxNy film, or the like may be used.

Next, as shown in FIG. 9H, a metal film is layered on the top surfaces of the resin film 82 and the upper electrodes 54 within the openings 84, and the metal wires 86 are patterned. Specifically, the following processes are carried out: an Al film (thickness: 1 μm) is formed by sputtering; a resist is formed by photolithography; the Al film is etched by RIE using a chlorine gas; and the resist film is removed by oxygen plasma. The upper electrodes 54 and the metal wires 86 (the Al film) are joined. Note that, although not illustrated, the openings 84 are provided above the lower electrode 52 as well, and the lower electrode 52 is also connected to the metal wires 86 as with the upper electrodes 54.

Then, as shown in FIG. 9I, the resin protective film 88 (e.g., photosensitive polyimide Durimide 7320 manufactured by FUJIFILM Electronics Materials Co., Ltd.) is layered on the top surfaces of the metal wires 86 and the resin film 82, and is patterned. This resin protective film 88 is formed of the same type of resin material as the resin film 82. At this time, the resin protective film 88 is not layered on the regions above the piezoelectric elements 46 where the metal wires 86 are not patterned (only the resin film 82 is layered thereat).

The reason why the resin protective film 88 is not layered above the piezoelectric elements 46 (on the top surface of the resin film 82) is in order to prevent the displacement (flexural deformation in the top-bottom direction) of the vibrating plate 48 (the piezoelectric elements 46) from being impeded. Further, when the metal wires 86, which are led out from the upper electrodes 54 of the piezoelectric elements 46 (connected to the upper electrodes 54), are covered by the resin protective film 88, because the resin protective film 88 is formed of the same type of resin material as the resin film 82 on which the metal wires 86 are layered, the joining forces of the resin films which cover the metal wires 86 are strong, and corrosion of the metal wires 86 due to the ink 110 infiltrating from the boundary surface can be prevented.

Because the resin protective film 88 is formed of the same type of resin material as the partitioning wall 42 (the photosensitive dry film 98), the joining force of the resin protective film 88 with respect to the partitioning wall 42 (the photosensitive dry film 98) also is strong. Accordingly, the infiltration of ink 110 from the boundary surfaces is prevented more positively. Further, using the same type of resin material in this way is advantageous in that, because the coefficients of thermal expansion of the protective film 88 and the partitioning wall 42 are substantially equal, there is little generation of thermal stress.

As shown in FIG. 9J, a photosensitive dry film 96 (for example, Raytec FR-5025: 25 μm thick produced by Hitachi Chemical Co., Ltd.) is disposed on the top surfaces of the resin protective films 88 in facing relationship to the respective piezoelectric elements 46 which are disposed in a matrix form, and the photosensitive dry film 96 is patterned by exposure and development. This photosensitive dry film 96 constitutes air dampers 44 which serve to mitigate pressure waves.

Next, as shown in FIG. 9K, the driving ICs 60 are flip-chip assembled on the metal wires 86 via the bumps 62. At this time, the driving ICs 60 are worked to a predetermined thickness (70 μm to 300 μm) in a grinding process carried out in advance at the end of the semiconductor wafer processes. If the driving ICs 60 are too thick, patterning of the partitioning wall 42 and formation of the bumps 64 may become difficult.

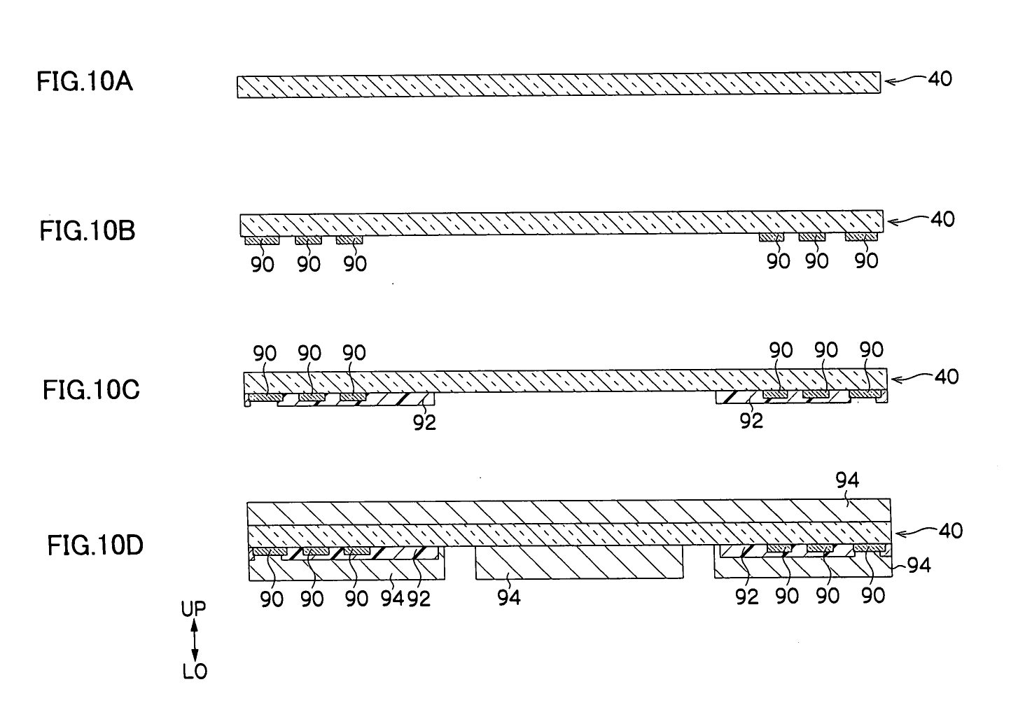

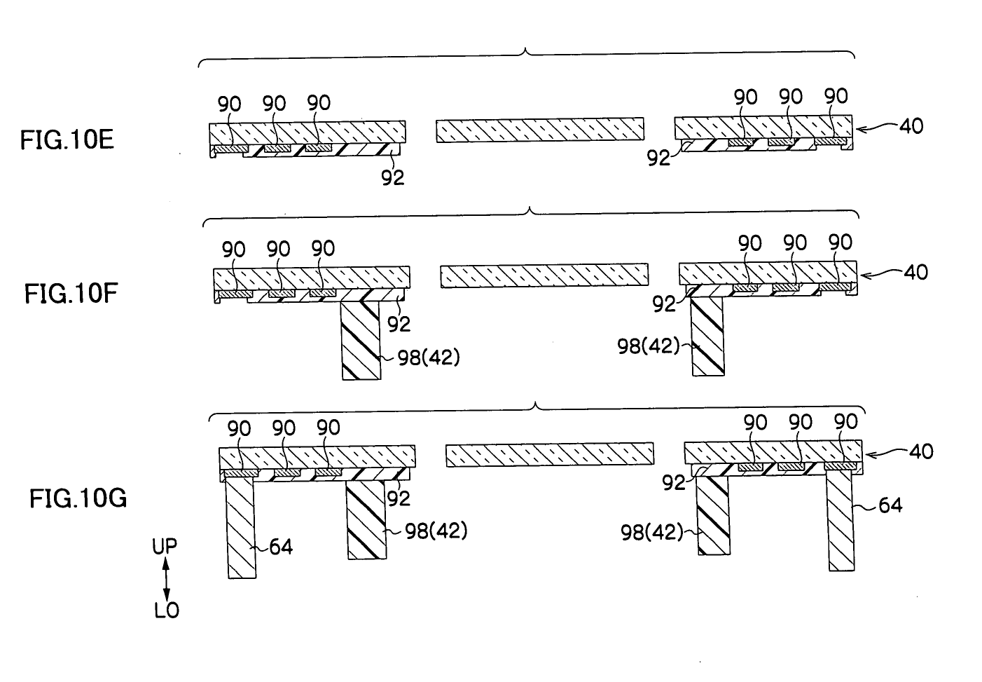

Electroplating, electroless plating, a ball bump process, screen printing, or the like can be used as the method for forming the bumps 62 for flip-chip assembling the driving ICs 60 on the metal wires 86. In this way, the piezoelectric element substrate 70 is fabricated, and the top plate 40, which is made of glass for example, is united (joined) thereto. Note that, for convenience of explanation, in FIGS. 10A through 10G to be described hereinafter, description is given with the wire formation surface being the bottom surface, but the wire formation surface is the top surface in the actual processes.

In manufacturing the glass top plate 40, as shown in FIG. 10A, the top plate 40 itself has a thickness (0.3 mm to 1.5 mm) which can ensure strength of an extent needed for the top plate 40 to be a supporting body. Therefore, there is no need to provide a separate supporting body. First, as shown in FIG. 10B, the metal wires 90 are layered on the bottom surface of the top plate 40, and patterning is carried out. Specifically, the following processes are carried out: an Al film (thickness: 1 μm) is formed by a sputtering method; a resist is formed by photolithography; the Al film is etched by RIE (reactive ion etching process) using a chlorine gas; and the resist film is removed by oxygen plasma.

Then, as shown in FIG. 10C, the resin film 92 (e.g., photosensitive polyimide Durimide 7320 manufactured by FUJIFILM Electronics Materials Co., Ltd.) is layered on the surface at which the metal wires 90 are formed, and patterning is carried out. Note that, at this time, the resin film 92 is not layered on some of the metal wires 90 in order to join the bumps 64.

Next, as shown in FIG. 10D, a resist is patterned by photolithography on the surface of the top plate 40 where the metal wires 90 are formed. The surface where the metal wires 90 are not formed is entirely covered by a resist 94 for protection. Here, the resist 94 for protection is coated in order to prevent the top plate 40 from being etched from the reverse surface of the surface where the metal wires 90 are formed, in the subsequent wet (SiO₂) etching step. Note that, in a case in which a photosensitive glass is used as the top plate 40, this step of applying the resist 94 for protection can be omitted.

Next, as shown in FIG. 10E, wet (SiO₂) etching by an HF solution is carried out on the top plate 40, and thereafter, the resist 94 for protection is removed by oxygen plasma.

Subsequently, as shown in FIG. 10F, the photosensitive dry film 98 (thickness: 100 μm) is layered on the resin film 92, and is patterned by exposure and development. This photosensitive dry film 98 becomes the partitioning wall 42 which defines the ink pooling chamber 38. Note that the partitioning wall 42 is not limited to the photosensitive dry film 98, and may be a resin coated film (e.g., SU-8 resist manufactured by Kayaku Microchem Corporation). At this time, it suffices for coating to be carried out by a spray coating device, and for exposure and development to be carried out.

Finally, as shown in FIG. 10G, the bumps 64 are formed by plating or the like on the metal wires 90 on which the resin film 92 is not layered. In order to electrically connect these bumps 64 to the metal wires 86 of the driving ICs 60, as illustrated, the heights of the bumps 64 are made higher than that of the photosensitive dry film 98 (the partitioning wall 42).

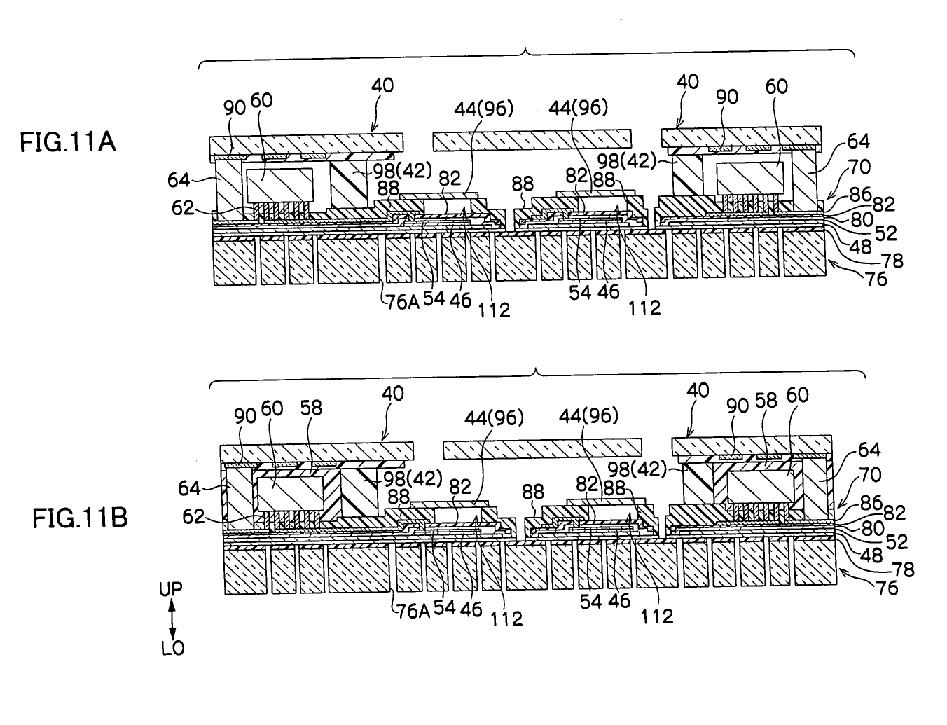

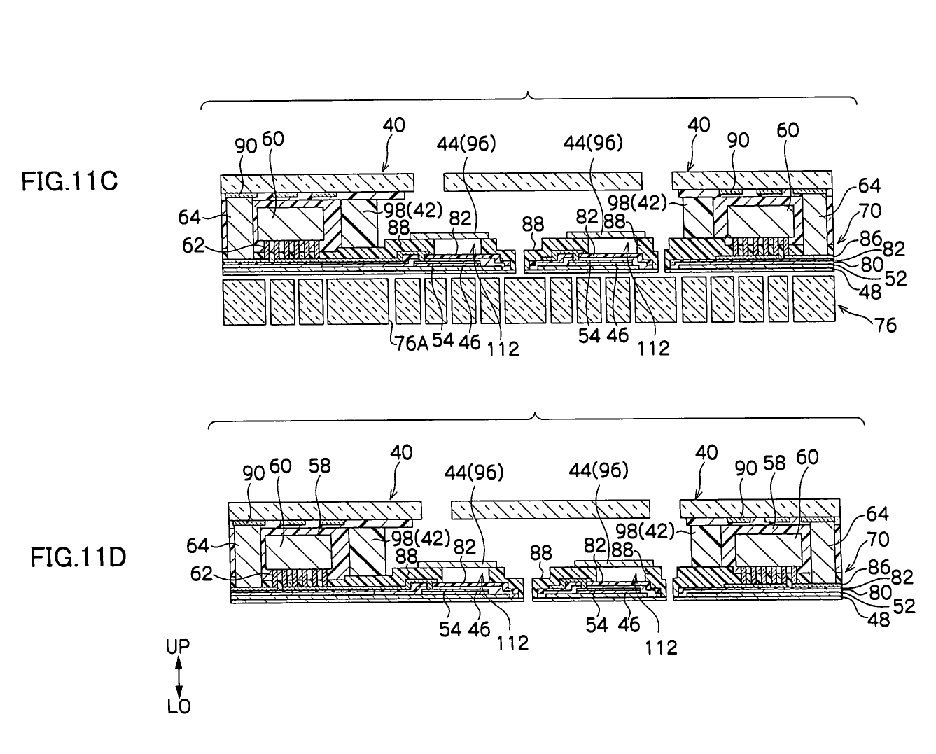

After the top plate 40 is manufactured in this way, as shown in FIG. 11A, the top plate 40 is placed on the piezoelectric element substrate 70, and both are united (joined) together by thermocompression bonding. Namely, the photosensitive dry film 98 (the partitioning wall 42) is joined to the resin protective film 88 which is a photosensitive resin layer, and the bumps 64 are joined to the metal wires 86.

At this time, the heights of the bumps 64 are higher than the height of the photosensitive dry film 98 (the partitioning wall 42). Therefore, by joining the photosensitive dry film 98 (the partitioning wall 42) to the resin protective film 88, the bumps 64 are automatically joined to the metal wires 86. Namely, because it is easy to adjust the heights of the solder bumps 64 (the solder bumps 64 are easily crushed), the connecting of the bumps 64 and the sealing of the ink pooling chamber 38 by the photosensitive dry film 98 (the partitioning wall 42) can be carried out easily.

When the joining of the partitioning wall 42 and the resin protective film 88, and the joining of the bumps 64 and the metal wires 86, are completed, as shown in FIG. 11B, the resin material 58 for sealing (e.g., an epoxy resin) is injected-in at the driving ICs 60. Namely, the resin material 58 is made to flow-in from the injection openings 41 (see FIG. 5A) which are formed in the top plate 40. When the resin material 58 is injected-in and the driving ICs 60 are sealed in this way, the driving ICs 60 can be protected from the external environment such as moisture or the like, and the bonding strength of the piezoelectric element substrate 70 and the top plate 40 can be improved. Further, it is possible to avoid damage in the later steps, e.g., damage to the driving ICs 60 due to water or ground pieces at the time when the finished piezoelectric element substrate 70 is divided into the inkjet recording heads 32 by dicing.

Next, as shown in FIG. 11C, by injecting-in an adhesive removal solution from the through-holes 76A of the first supporting substrate 76 and selectively dissolving the adhesive 78, the first supporting substrate 76 is removed from the piezoelectric element substrate 70. In this way, as shown in FIG. 11D, the piezoelectric element substrate 70, with which the top plate 40 is united (joined), is completed. Then, from this state, the top plate 40 becomes the supporting body of the piezoelectric element substrate 70.

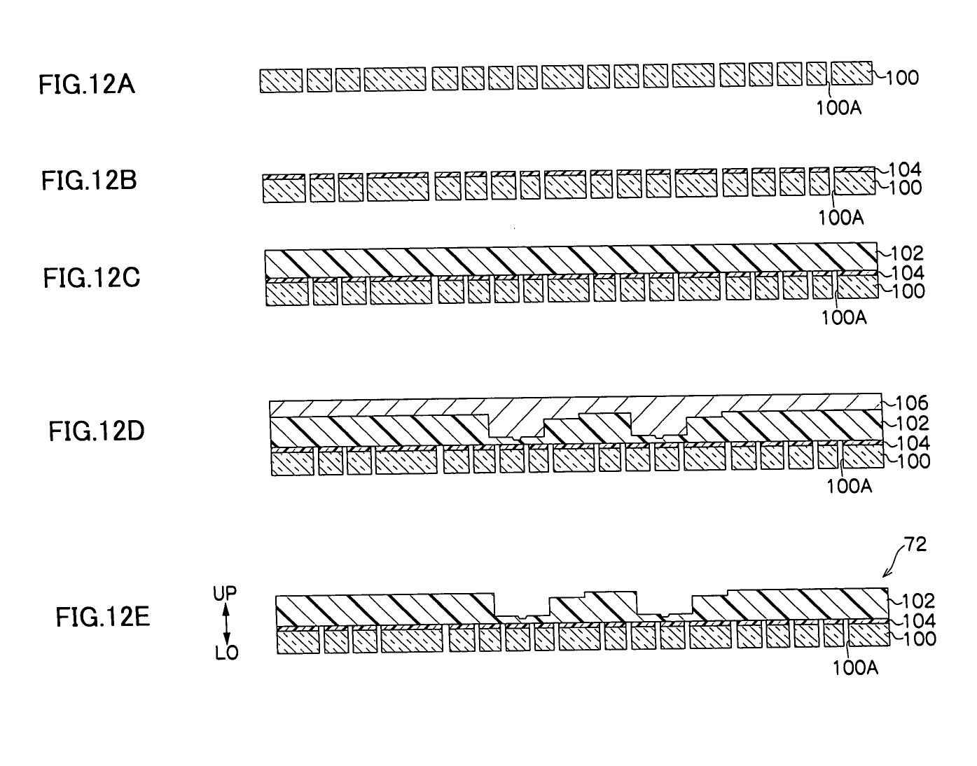

On the other hand, as shown in FIG. 12A, for the flow path substrate 72, first, a second supporting substrate 100 which is formed of glass and in which plural through-holes 100A are formed, is prepared. As with the first supporting substrate 76, the second supporting substrate 100 may be any material provided that it does not flex, and is not limited to being formed of glass, but glass is preferable as it is hard and inexpensive. Femtosecond laser machining of a glass substrate, exposure and development of a photosensitive glass substrate (e.g., PEG3C manufactured by Hoya Corporation), and the like are known as methods for fabricating the second supporting substrate 100.

Then, as shown in FIG. 12B, an adhesive 104 is applied onto the top surface (the obverse) of the second supporting substrate 100. As shown in FIG. 12C, a resin substrate 102 (e.g., an amideimide substrate of a thickness of 0.1 mm to 0.5 mm) is adhered to the top surface (the obverse) thereof. Then, as shown in FIG. 12D, the top surface of the resin substrate 102 is pushed against a mold 106, and heating and pressurizing processings are carried out. Thereafter, as shown in FIG. 12E, by separating the mold 106 from the resin substrate 102, the flow path substrate 72, in which the pressure chambers 50 and the nozzles 56 and the like are formed, is completed.

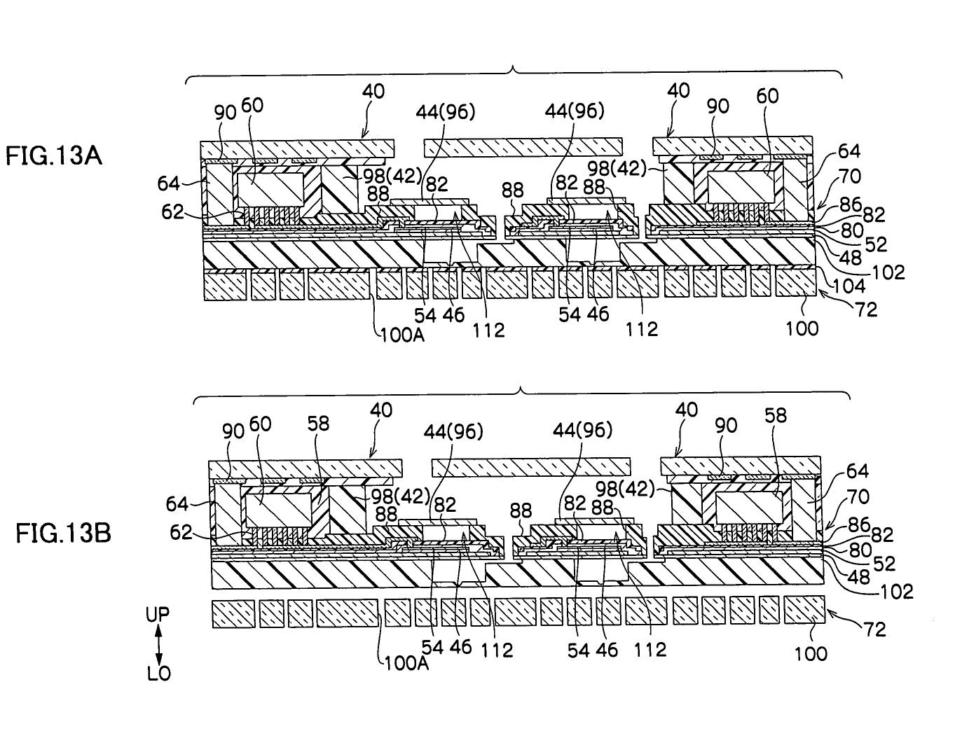

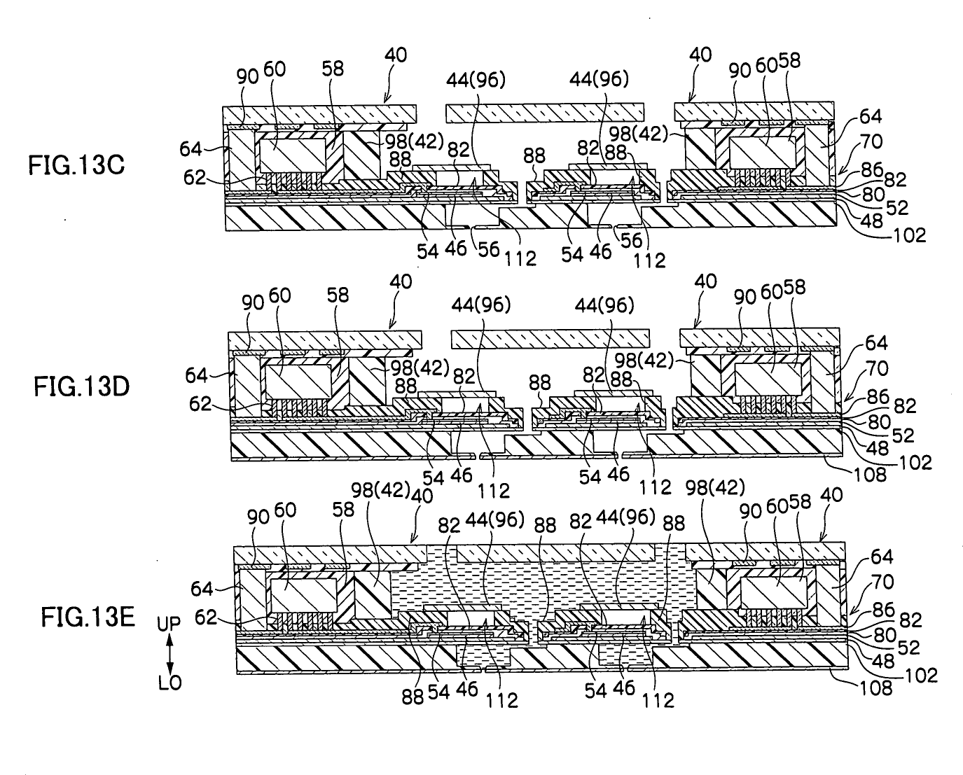

When the flow path substrate 72 is completed in this way, as shown in FIG. 13A, the piezoelectric element substrate 70 and the flow path substrate 72 are united (joined) by thermocompression bonding. Next, as shown in FIG. 13B, by injecting-in an adhesive removal solution from the through-holes 100A of the second supporting substrate 100 and selectively dissolving the adhesive 104, the second supporting substrate 100 is removed from the flow path substrate 72.

Thereafter, as shown in FIG. 13C, the surface from which the second supporting substrate 100 has been removed is subjected to polishing processing using an abrasive whose main component is alumina, or to RIE processing using oxygen plasma. In this way, the surface layer is removed, and the nozzles 56 are opened. Then, as shown in FIG. 13D, by applying a fluorine material 108 (e.g., Cytop manufactured by Asahi Glass Co., Ltd.), which serves as a water repellant, onto the bottom surface where the nozzles 56 are open, the inkjet recording head 32 is completed. As shown in FIG. 13E, the ink 110 can be filled into the ink pooling chamber 38 and the pressure chambers 50.

Since a manufacturing method is adopted in which the piezoelectric element substrate 70 and the flow path substrate 72 which constitute the inkjet recording head 32 are invariably fabricated on the hard supporting substrates 76 and 100 respectively and the supporting substrates 76 and 100 are removed when they become unnecessary during the fabrication steps of the substrates 70 and 72, the inkjet recording head 32 is structured so as to be very easy to manufacture. Meanwhile, since the inkjet recording head 32 as manufactured (completed) is supported by the top plate 40 (the top plate 40 serves as a support body therefor), the rigidity thereof is secured.

Next, operation of the inkjet recording apparatus 10, which is provided with the inkjet recording head 32 which is manufactured as described above, will be described. First, when an electric signal instructing printing is sent to the inkjet recording apparatus 10 shown in FIGS. 1 and 2, one of the recording papers P is picked-up from the paper feed tray 26, and is conveyed to a predetermined position by the subscanning mechanism 18.

On the other hand, at the inkjet recording unit 30, the ink 110 has already been injected (filled) into the ink pooling chamber 38 of the inkjet recording head 32 from the ink tank 34 and via the ink supplying ports 36 shown in FIG. 4. The ink 110 which is filled into the ink pooling chamber 38 is supplied to (filled into) the pressure chambers 50 via the ink flow paths 66, 68. At this time, a meniscus, in which the surface of the ink 110 is slightly concave toward the pressure chamber 50 side, is formed at the distal end (the ejecting opening) of the nozzle 56.

Then, while the inkjet recording heads 32, which are installed in the carriage 12, move in the main scanning direction, due to ink droplets being selectively ejected from the plural nozzles 56, a portion of the image based on the image data is recorded in a predetermined band region of the recording paper P.

Namely, voltage is applied to predetermined piezoelectric elements 46 at predetermined timing by the driving ICs 60, the vibrating plate 48 is flexurally deformed in the top-bottom direction (is out-of-plane vibrated), pressure is applied to the ink 110 within the pressure chambers 50, and the ink 110 is ejected as ink droplets from predetermined nozzles 56.

When a portion of the image based on the image data is recorded on the recording paper P in this way, the recording paper P is conveyed at a predetermined pitch by the subscanning mechanism 18. In the same way as described above, due to ink droplets being selectively ejected from the plural nozzles 56 again while the inkjet recording heads 32 are being moved in the main scanning direction, a portion of the image based on the image data is recorded at the next band region of the recording paper P.

When these operations are repeatedly carried out and the image based on the image data is completely recorded on the recording paper P, the subscanning mechanism 18 conveys the recording paper P to the end and discharges the recording paper P onto the catch tray 28. In this way, printing processing (image recording) with respect to the recording paper P is completed.

Here, at the inkjet recording head 32, the ink pooling chamber 38 is provided at the side opposite the pressure chambers 50 (the top side), with the vibrating plate 48 (the piezoelectric elements 46) therebetween. In other words, the vibrating plate 48 (the piezoelectric elements 46) is disposed between the ink pooling chamber 38 and the pressure chambers 50, and the ink pooling chamber 38 and the pressure chambers 50 do not lie in the same horizontal plane.

By arrangement such that the ink pooling chamber 38 and the pressure chambers 50 do not lie in the same horizontal plane as mentioned above, the pressure chambers 50 can be disposed adjacent to one another, and thus the nozzles 56 which are provided for each pressure chamber 50 can be disposed at a high density.

Further, by using the photolithography technique for semiconductor processes when forming the metal wires 86 which are led out from the piezoelectric elements 46, fine metal wires having a pitch of 10 μm or less can be formed. Still further, by connecting the metal wires to the driving ICs 60 near the piezoelectric elements 46, the wire length can be made short (the wire resistance can be reduced). In fact, with such structures, a high density of the nozzles 56 can be achieved with a practical wire resistance value. In this way, a high resolution can be achieved.

Further, isolation chambers 112 are provided within the ink pooling chamber, such that the piezoelectric elements 46 are isolated from the ink 110 by the isolation chambers 112, and thus no force of constraint of the ink is loaded to the piezoelectric elements 46. For this reason, flexural deformation of the piezoelectric elements 46 will not be impeded by the force of constraint. Additionally, the piezoelectric elements 46 can be protected from ink erosion by isolating them from the ink 110 by the isolation chambers 112.

On the other hand, when the pressure chambers 50 are pressurized due to flexural deformation of the piezoelectric elements 46 and thus the ink 110 is ejected as ink droplets from the nozzles 56 communicating with the pressure chambers 50, pressure waves of the ink 110 which are transmitted into the ink pooling chamber 38 via the ink flow path 66 are mitigated by the air dampers 44 provided at the isolation chambers 112.

By providing, at the isolation chambers 112, the air dampers 44 which mitigate pressures waves of the ink 110 pooled in the ink pooling chamber 38 as mentioned above, the necessity to provide the air dampers 44 on the top plate 40 is eliminated. For this reason, there is no need to form the top plate 40 with openings in which the air dampers 44 are to be provided, and thus a wide wire forming area can be secured on the top plate 40 (since wide wire width can be ensured, low-resistance wires can be formed).

Further, since each piezoelectric element 46 is isolated by each isolation chamber 112 as shown in FIGS. 5A and 5B and thus the area of each isolation chamber 112 is smaller than in the case where a plurality of the piezoelectric elements 46 is isolated by one isolation chamber 112, the strength of each isolation chamber 112 can be increased correspondingly.

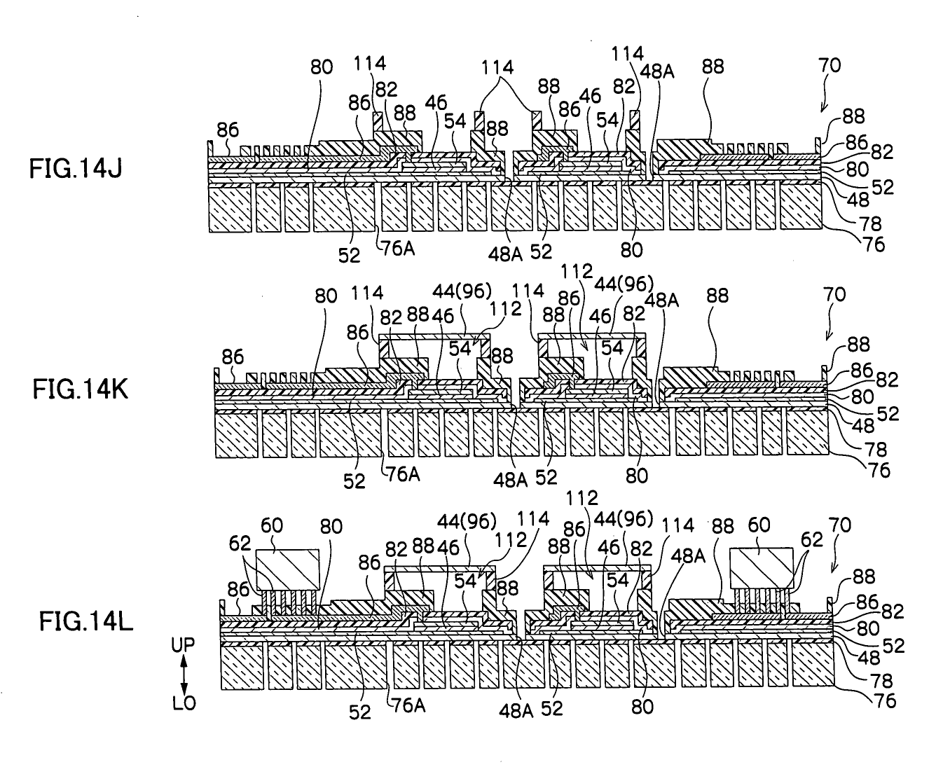

Thus, the air dampers 44 can be structured simply by using the resin protective films 88 coating and protecting the metal wires 86 as side walls of the isolation chambers 112 and mounting photosensitive dry films 96 on the top surfaces of the resin protective films 88. Therefore, there is no need to separately provide side walls or the like for reinforcing the isolation chambers 112. Note, however, that a side wall 114 may of course be provided for each isolation chamber 112, as shown in FIGS. 14K and 14L.

When each isolation chamber 112 is provided with the side wall 114 as mentioned above, subsequent to the process of FIG. 9I, the photosensitive dry film is layered on the top surface of the resin protective film 88 and patterned by exposure and development, thereby forming the side wall 114 for each isolation chamber 112, as shown in FIG. 14J.

Note that the side wall 114 is not limited to the photosensitive dry film but may be a resin coated film (e.g., SU-8 resist manufactured by Kayaku Microchem Corporation). In such a case, coating is carried out by using a spray coating device, and exposure and development are performed.

After the side wall 114 for each isolation chamber 112 has been formed, the photosensitive dry film 96 is patterned on the top surface of each side wall 114 as in the process of FIG. 9J, as shown in FIG. 14K, and the ICs 60 are flip-chip assembled on the metal wires 86 via the bumps 62 as in the process of FIG. 9K, as shown in FIG. 14L.

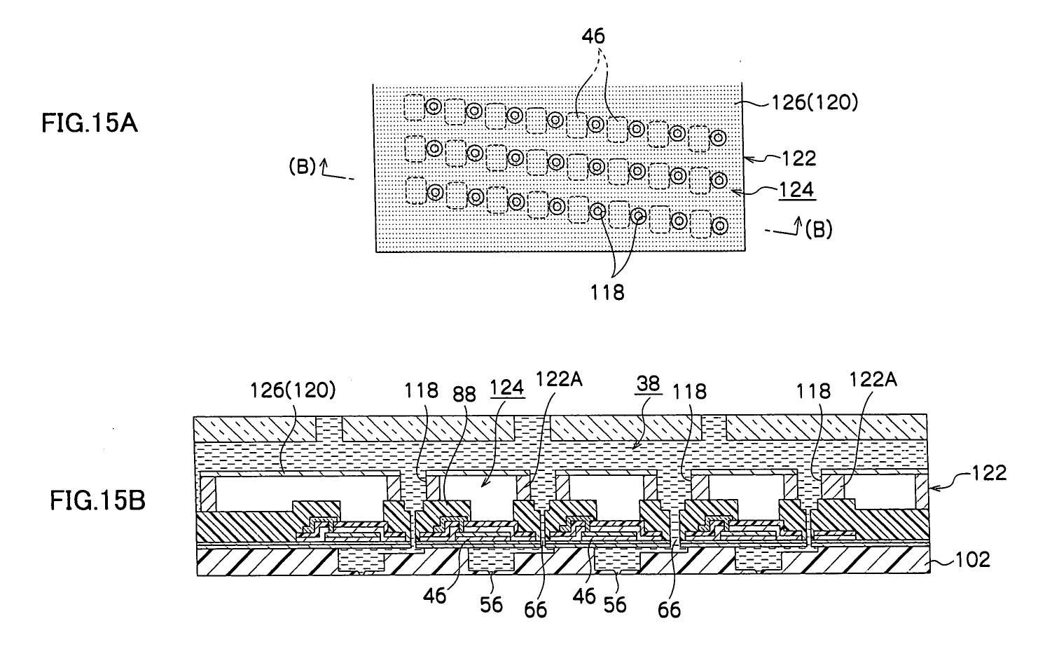

Further, as shown in FIGS. 15A and 15B, an arrangement may be adopted wherein: ink flow paths 118 are provided which can be communicated with the ink flow paths 66; a resin plate 122 is used on which a photosensitive dry film 120 is mounted at a position where it faces the piezoelectric elements 46; and the front end surfaces of the ink flow paths 118 and the front end surfaces of upright walls which are provided at the circumferential edges of the resin plate 122 are thermally joined to the resin protective film 88, thereby forming the isolation chambers 124 at the resin plate 122.

With the isolation chamber 124 defined by the resin plate 122 provided with the ink flow path 118 adapted for communication with the inflow path 66, the isolation chamber 124 can be made larger than in the case where isolation is achieved for each piezoelectric element by the associated isolation chamber 124. That is, the area of the air dampers can be increased, and thus the vibration characteristic (ink ejecting performance ) of the nozzles 56 corresponding to the piezoelectric elements can be improved.

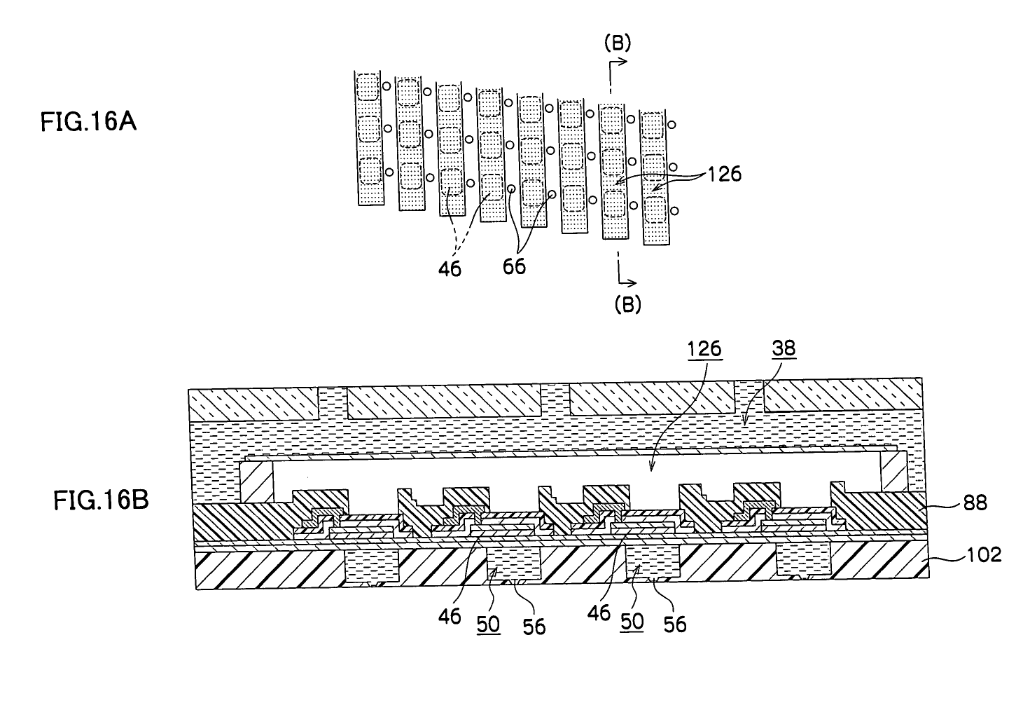

Further, since the ink flow paths 66 through which the pressure chambers 50 and the ink pooling chamber 38 are in communication with each other are provided between the columns of the piezoelectric elements 46 arranged in the form of a matrix as shown in FIGS. 16A and 16B, the piezoelectric elements 46 are isolated on a column-unit basis by the isolation chambers 124, and thus the area of the air dampers can be increased, thereby achieving an enhanced damper effect.

Further, although not shown, by isolating one or more arbitrary piezoelectric elements by an isolation chamber, it becomes possible to change the amount of flexural deformation of the piezoelectric element depending on the position of the piezoelectric element in the ink pooling chamber. For example, in the ink pooling chamber, by isolating the piezoelectric element disposed at an outer side by the isolation chamber and by providing the air damper at the isolation chamber, it is possible to improve the ink ejection performance of the nozzle corresponding to the piezoelectric element in the isolation chamber, and it is possible to realize a vibration characteristic (ink ejection performance) substantially equivalent to that of the piezoelectric element which is disposed at an inner side in the ink pooling chamber.

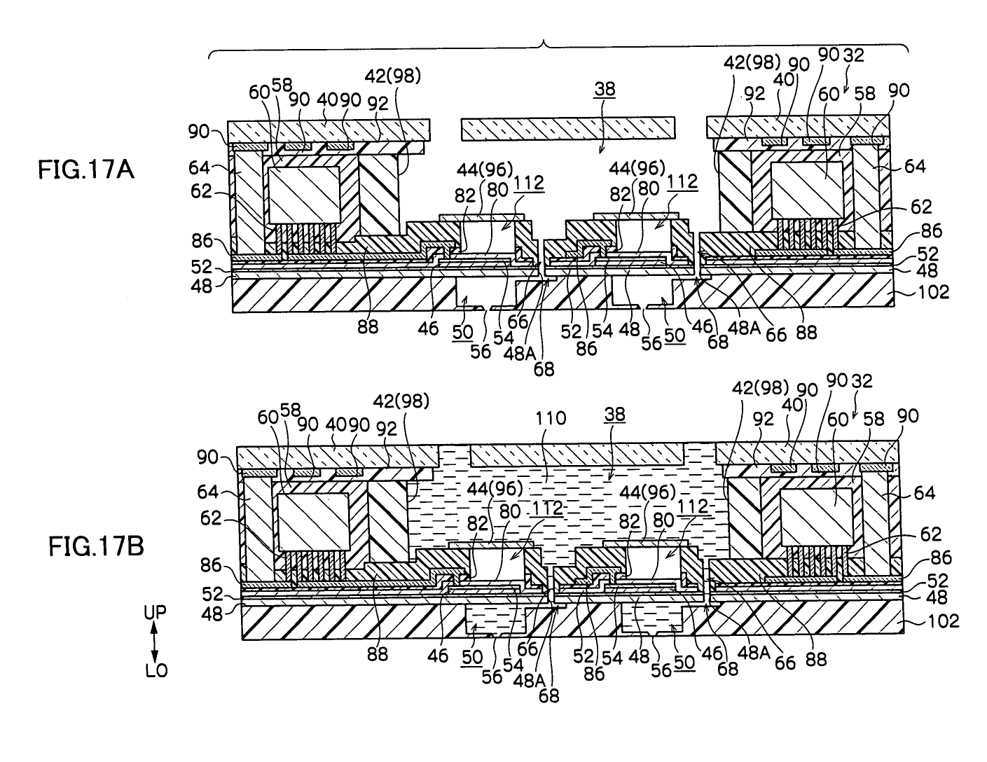

Further, in the present embodiment, the piezoelectric elements 46 can be isolated from the ink 110 by the isolation chambers 112, and thus the resin film 82 for protecting the low water permeability film 80 from erosion by the ink 110 is not needed within the isolation chamber 112, as shown in FIGS. 17A and 17B. In the regions above the piezoelectric elements 46, the effect of suppressing an impediment to displacement of the piezoelectric elements 46 is enhanced, and thus, an impediment to displacement of the piezoelectric elements 46 is prevented by virtue of the fact that the resin film 82 is not needed within the isolation chambers 112.

Further, the driving ICs 60 which apply voltage to the piezoelectric elements 46 are interposed between the vibrating plate 48 and the top plate 40 and structured so as not to be exposed (projected) out of the vibrating plate 48 or the top plate 40 (the driving ICs 60 are contained inside the inkjet recording bead 32). Consequently, as compared with the case where the driving ICs 60 are mounted outside the inkjet recording head 32, the metal wires 86 connecting the piezoelectric elements 46 and the driving ICs 60 are shortened, thus resulting in the metal wires 86 having a lower resistance.

In fact, a high density of the nozzles 56, or a high-density matrix-like arrangement of the nozzles 56 can be achieved with a practical wire resistance value, and thus a high resolution can be achieved. In addition, since the driving ICs 60 are flip-chip assembled on the piezoelectric element substrate 70 at which the piezoelectric elements 46 and the like are formed on the vibrating plate 48, high-density wire connection can be easily made, and also the height of the driving ICs 60 can be decreased (the driving ICs 60 can be made thin). Consequently, the inkjet recording head 32 can be made compact.

Specifically, in a conventional electrical connection using the FPC system, 600 npi (nozzle per inch) has been the limit for nozzle resolution, while in the system of the present invention, a 1200 npi array has become readily feasible. Further, as compared with a 600 npi nozzle array, for example, since there is no need to use an FPC, it has become possible to reduce the size of the present inkjet recording head by at least one half.

Further, by sealing the peripheral joint gaps of the driving ICs 60 with the resin material 58, the joint strength between the top plate 40 and the piezoelectric element substrate 70 is increased, and due to being sealed with the resin material 58, the driving ICs 60 can be protected from the external environment such as moisture or the like. Further, it is possible to avoid damage in the later steps, e.g., damage to the driving ICs 60 due to water or ground pieces at the time when the finished piezoelectric element substrate 70 is divided into the inkjet recording heads 32 by dicing.

Moreover, since the metal wires 86 on the piezoelectric element substrate 70 which connect the piezoelectric elements 46 and the driving ICs 60 are coated with the resin protective film 88, the metal wires 86 can be protected from erosion by the ink 110. In addition, since the resin protective film 88 and the resin film 82, which are coated over the metal wires 86 in such a manner as to hold the metal wires 86 therebetween, are made from the same kind of resin material, their coefficients of thermal expansion are substantially equal, so that the generation of thermal stress is minimized.

Meanwhile, when the top plate 40 is placed over the piezoelectric element substrate 70 and the two are united (joined) together by thermal compression as shown in FIG. 11A, for example, it sometimes happens that the air in the isolation chamber 112 expands such that a so-called leak path is formed between the resin protective film 88 constituting the isolation chamber 112 and the air damper 44.

With a view to preventing the formation of the above leak path, therefore, a process is applied in which communication is established between the isolation chamber 112 and the atmosphere and occurrence of a pressure difference between the inside and the outside of the isolation chamber 112 is suppressed. An embodiment of such a case will be described below.

### Second Embodiment

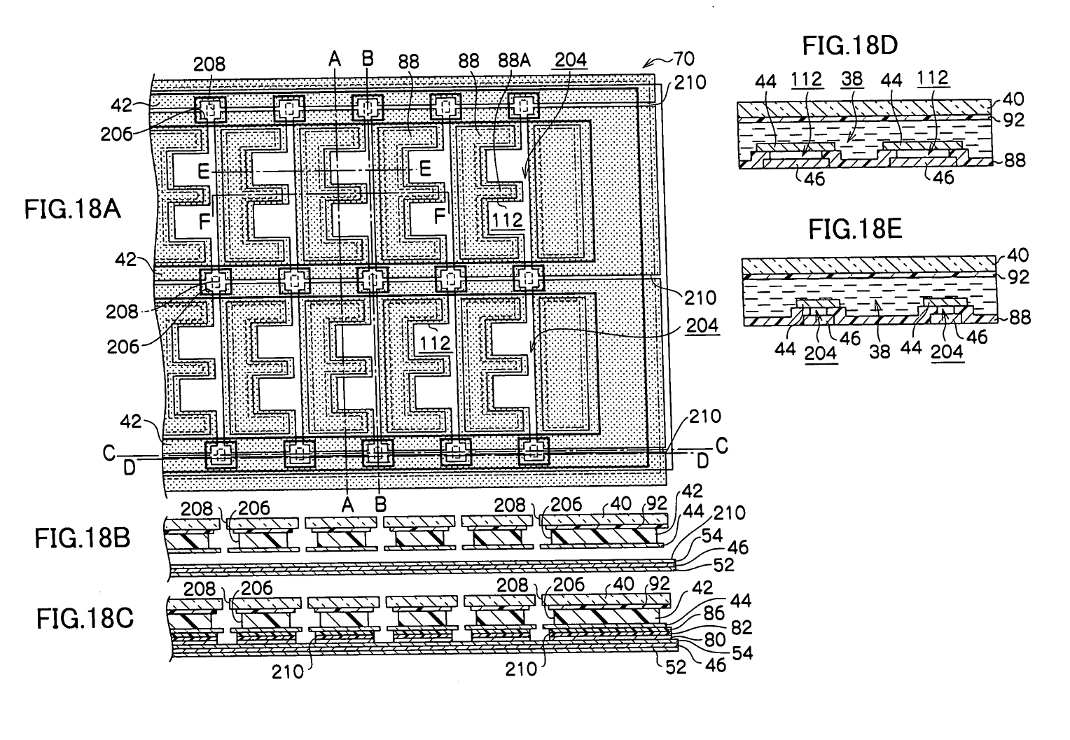

For example, as shown in FIGS. 18A-20 (in FIGS. 18A-18E, the driving ICs 60 and the bumps 64 are not shown), at least two adjacent piezoelectric elements 46 (although FIG. 18A shows a column-unit basis, a row-unit basis can also be adopted) forming one set are surrounded by the resin protective film 88 which is E-shaped. In this case, the piezoelectric elements 46 are isolated from each other by an intermediate wall portion 88A.

Further, a spacing is provided between the resin protective films 88 which are adjacent to each other in the row direction of the piezoelectric element substrate 70, and a communication region 204 with which one end portion of a respective one of the isolation chambers 112 is communicated is provided. In the interior of the partitioning wall 42 intersecting with an extension line of the communication region 204 is provided a communication path (first communication path) 206 which is communicated with the isolation chamber 112 via the communication region 204.

On the other hand, a communication path (second communication path) is provided on the resin film 92 and top plate 40 side at a position corresponding to the communication path 206, and the communication path 206 is communicated with the communication path 208. In this manner, the isolation chamber 112 is adapted to be communicated with the atmosphere so that the pressure in the isolation chamber 112 becomes substantially equal to the atmospheric pressure.

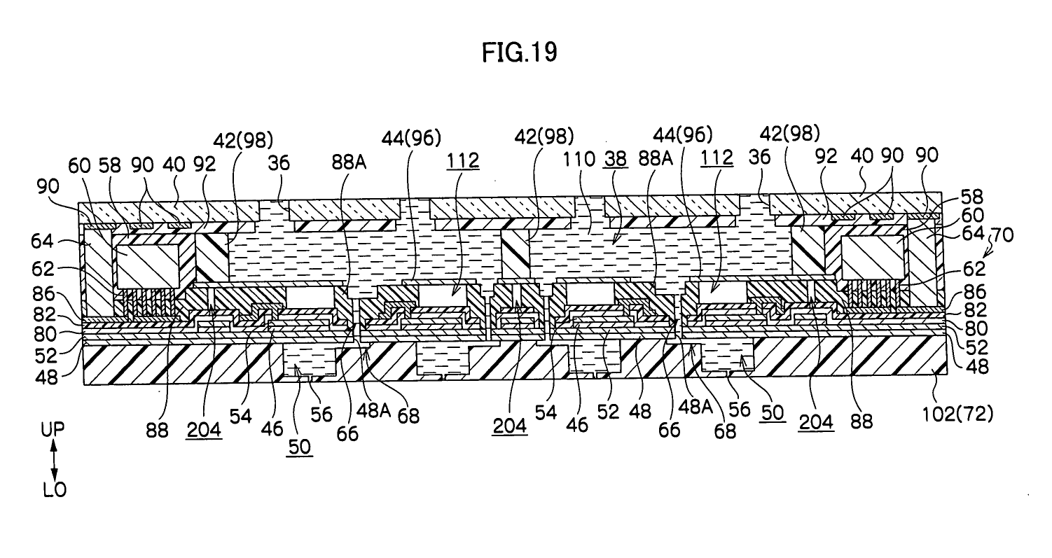

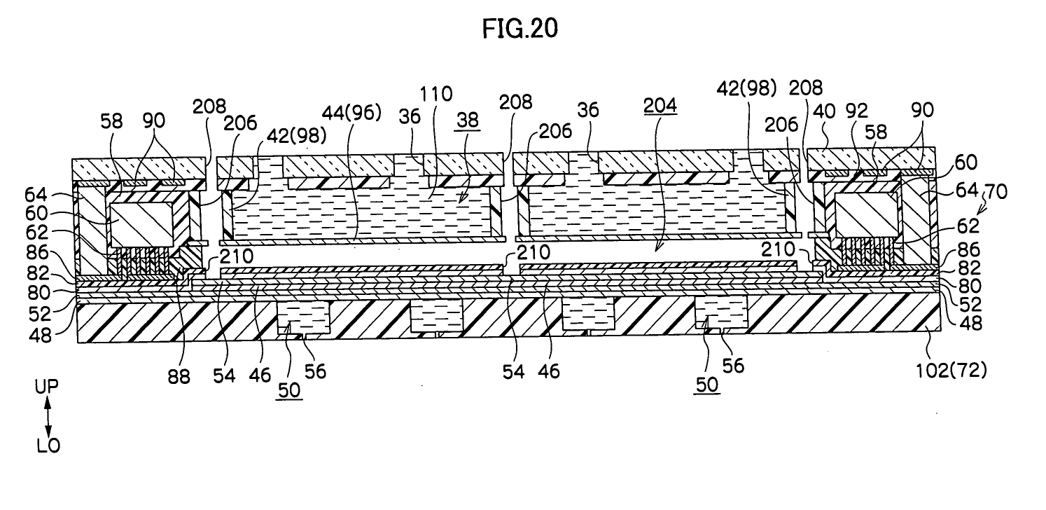

FIG. 18A is a plan view showing the isolation chambers 112, the resin protective films 88, the communication regions 204, the communication paths 206, groove portions 210 which will be described later, and so forth. FIG. 18B is a sectional view taken along the line C-C of FIG. 18A. FIG. 18C is a sectional view taken along the line D-D of FIG. 18A. FIG. 18D is a sectional view taken along the line E-E of FIG. 18A. FIG. 18E is a sectional view taken along the line F-F of FIG. 18A. FIG. 19 is a sectional view taken along the line A-A of FIG. 18A. FIG. 20 is a sectional view taken along the line B-B of FIG. 18A.

Here, since adjacent ones of the piezoelectric elements 46 are isolated by the intermediate wall 88A of the resin protective film 88, flexural deformation of one of the piezoelectric elements 46 has no effect on the other piezoelectric elements 46.

Further, the grooves 210 are provided on the bottom surfaces of the communication regions 204 located at lower portions of the partitioning walls 42 provided along the row direction of the piezoelectric element substrate 70 in FIG. 18A, in a manner so as to penetrate through the resin films and the low water permeability insulating films 80 and also in a manner so as to penetrate through the piezoelectric element substrate 70 along the row direction of the piezoelectric element substrate 70. Thus, the adjacent ones of the communication regions 204 in the row direction of the piezoelectric element substrate 70 are communicated with each other, and the isolation chambers 112 are communicated with the atmosphere via the communication regions 204. In this manner, occurrence of a pressure difference between the inside and the outside of the isolation chambers 112 is suppressed, and leak paths are prevented from being formed between the resin protective films 88 and the air dampers 44.

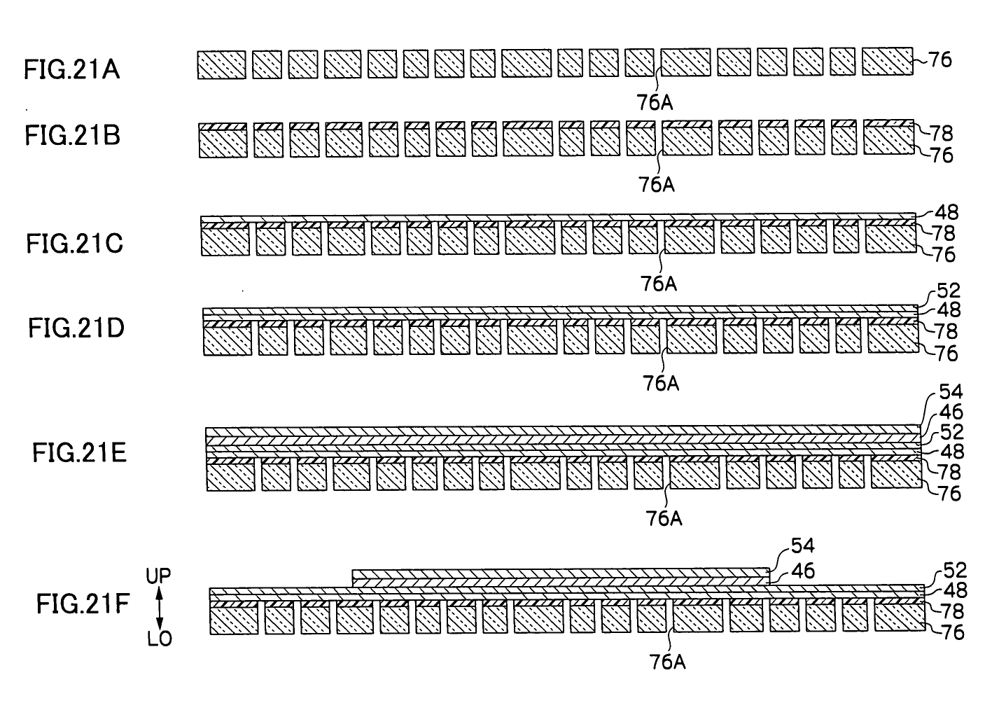

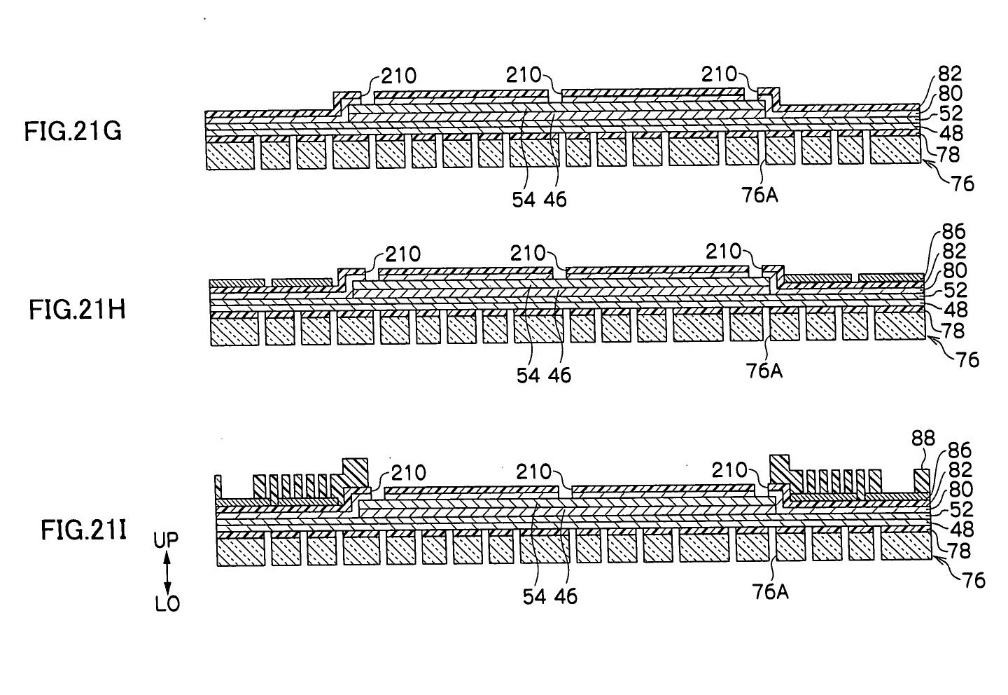

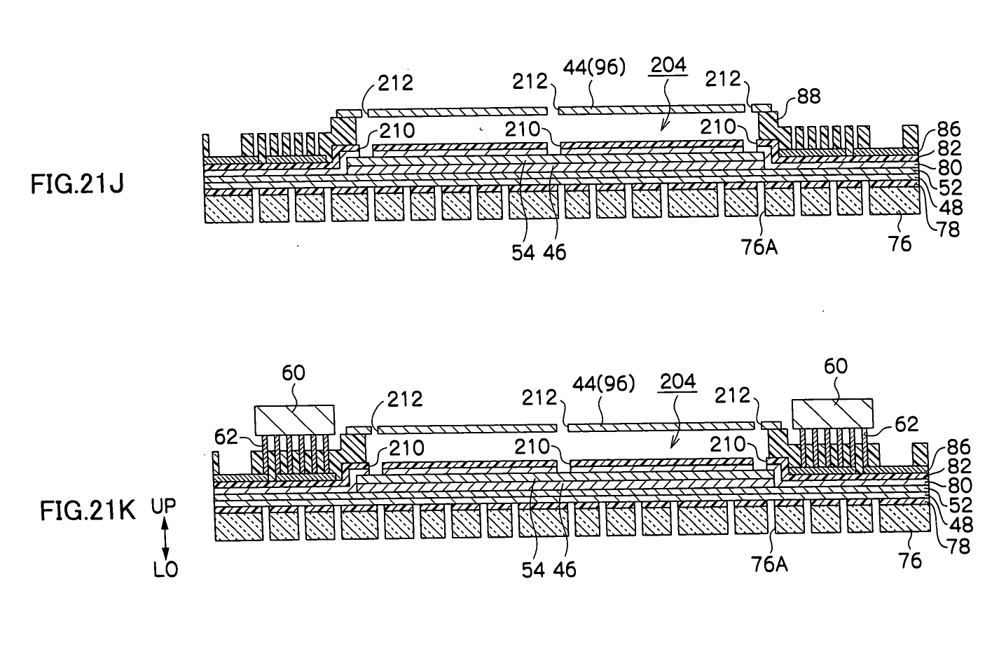

The manufacturing steps of the inkjet recording head 32 structured as described above will be described in detail with reference to FIGS. 21 through 24.

Description of contents substantially identical to the first embodiment will be omitted. Meanwhile, here, an illustration will be given with respect to the B-B section of FIG. 18A.

FIGS. 21A and 21B are identical to FIGS. 9A and 9B, respectively, wherein a first supporting substrate 76 made of glass and having plural through-holes 76A formed therein is prepared, and an adhesive 78 is applied to the top surface (the obverse) of the first supporting substrate 76.

Then, as shown in FIG. 21C, a vibrating plate 48 formed of metal (SUS or the like) is adhered on the top surface of the first supporting substrate. Here, while the through-holes 48 for forming the ink flow paths 66 are shown in FIG. 9C, such through-holes are not shown in FIG. 21C since an illustration is given with respect to the B-B section of FIG. 18A.

Next, as shown in FIG. 21D, a lower electrode 52 which is layered on the top surface of the vibrating plate 48 is patterned; subsequently, as shown in FIG. 21E, a PZT film which is the material of the piezoelectric element 46 and an upper electrode 54 are layered in that order by sputtering on the top surface of the lower electrode 52; and then, as shown in FIG. 21F, the piezoelectric element 46 (PZT film) and the upper electrode 54 are patterned.

Thereafter, as shown in FIG. 21G, a low water permeability film (an SiOx film) is layered on the exposed top surfaces of the lower and upper electrodes 52 and 54, and further, a resin film 82 having ink resistance and flexibility is layered onto the top surface of the low water permeability film 80 and then patterned. At this time, grooves 210 for communicating with the isolation chambers 112, and openings 84 (see FIG. 9G) for connecting the piezoelectric elements 46 and the metal wires 86 are formed. The openings 84 are not shown in FIG. 21G which is the B-B section of FIG. 18A.

Subsequently, as shown in FIG. 21H, a metal film is layered on the top surfaces of the upper electrode 54 and resin film 82 in the opening 84 (see FIG. 9G); the metal wire 86 is patterned; and the upper electrode 54 and the metal wire 86 (Al film) are joined.

Further, as shown in FIG. 211, a resin protective film 88 is layered onto the top surfaces of the metal wire 86 and the resin film 82 and patterned, and thereafter, as shown in FIG. 21J, a photosensitive dry film 96 is formed in a bridging manner with respect to the top surface of the resin protective film 88 and patterned by exposure and development.

This photosensitive dry film 96 becomes an air damper 44 which is adapted to mitigate pressure waves. Here, when a top plate 40 which will be described later is joined to a piezoelectric element substrate 70, the air damper 44 is provided with through-holes 212 at positions corresponding to center portions of the partitioning walls 42. Further, as shown in FIG. 21K, driving ICs 60 are flip-chip assembled on the metal wires 86 via bumps 62, and thus the piezoelectric element substrate 70 is fabricated.

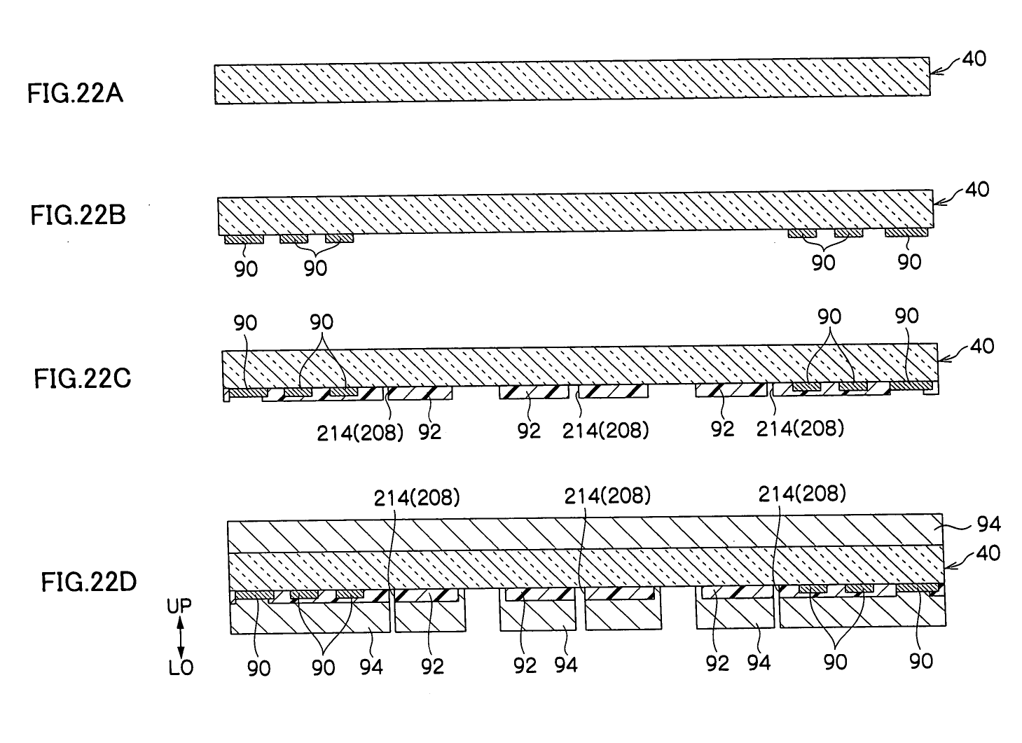

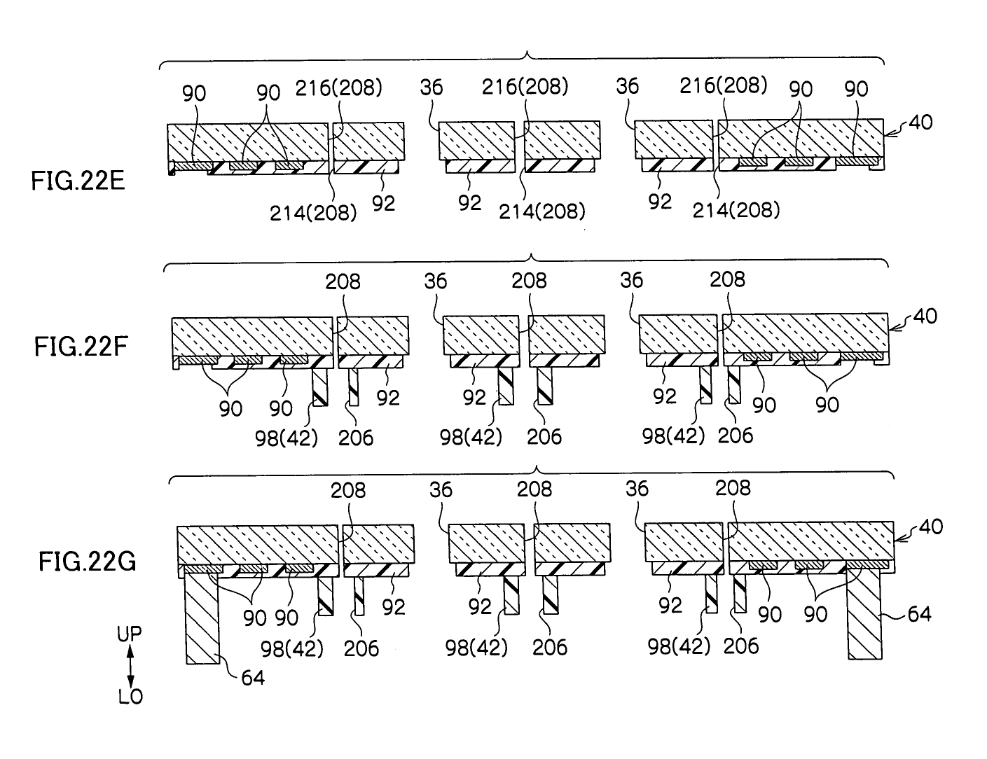

On the other hand, when fabricating the top plate 40, metal wires 90 are layered onto the bottom surface of the top plate and patterned, as shown in FIGS. 22A and 22B which are similar to FIGS. 10A and 10B respectively. Further, as shown in FIG. 22C, a resin film 92 is layered onto the surface on which the metal wires 90 are formed, and patterned. Here, apertures 214 which form communication paths 208 are provided by performing processing such that the resin film 92 is not layered at positions corresponding to the center portions of partitioning walls 42 which will be described later.

Next, as shown in FIG. 22D, a resist is patterned by photolithography on the surface of the top plate 40 on which the metal wires 90 are formed, while care is taken such that the resin film 92 is not layered at positions corresponding to the apertures 214. Further, the surface on which no metal wires 90 are formed is entirely covered by a resist 94 for protection.

Subsequently, as shown in FIG. 22E, wet (SiO₂) etching by an HF solution is carried out on the top plate 40, and thereafter, the resist 94 for protection is removed by oxygen plasma. In this manner, apertures 216 which form communication paths 208 in communication with the apertures 214 are formed in the top plate 40.

Further subsequently, as shown in FIG. 22F, a photosensitive dry film 98 (100 μm thick) is layered onto the resin film 92 and patterned by exposure and development. The photosensitive dry films 98 become the partitioning walls 42 which define the ink pooling chamber 38. Consequently, the communication paths 208 and the communication paths 206 communicate with one another.

Finally, as shown in FIG. 22G, the bumps 64 are formed by plating or the like on the metal wires 90 on which the resin film 92 is not layered.

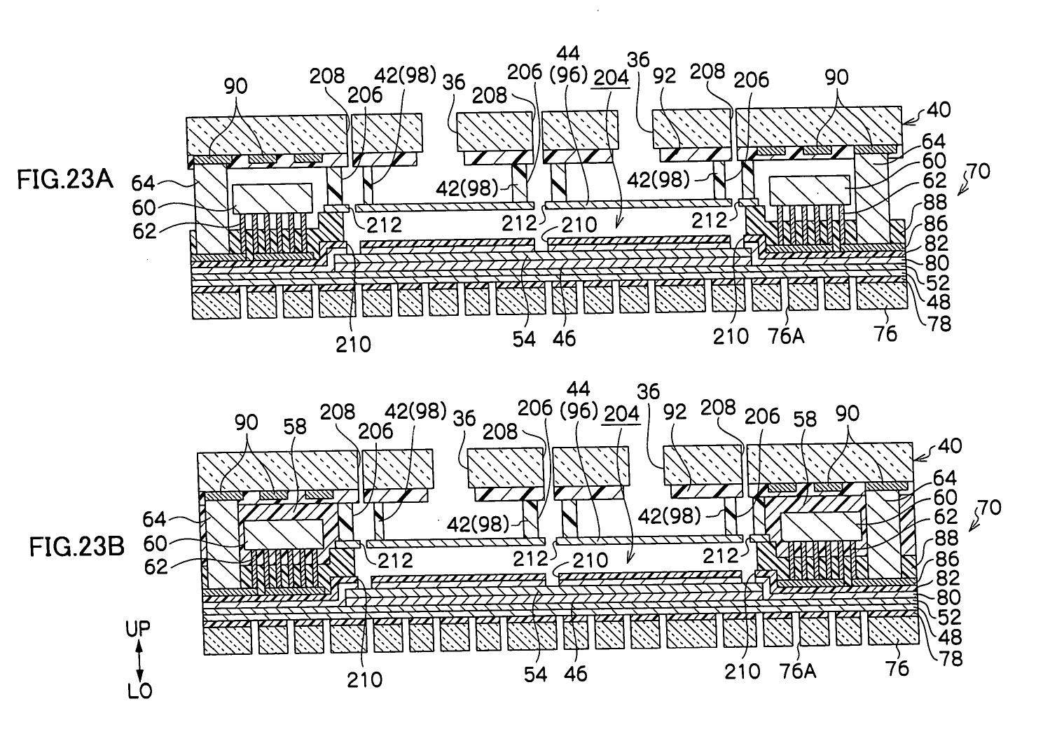

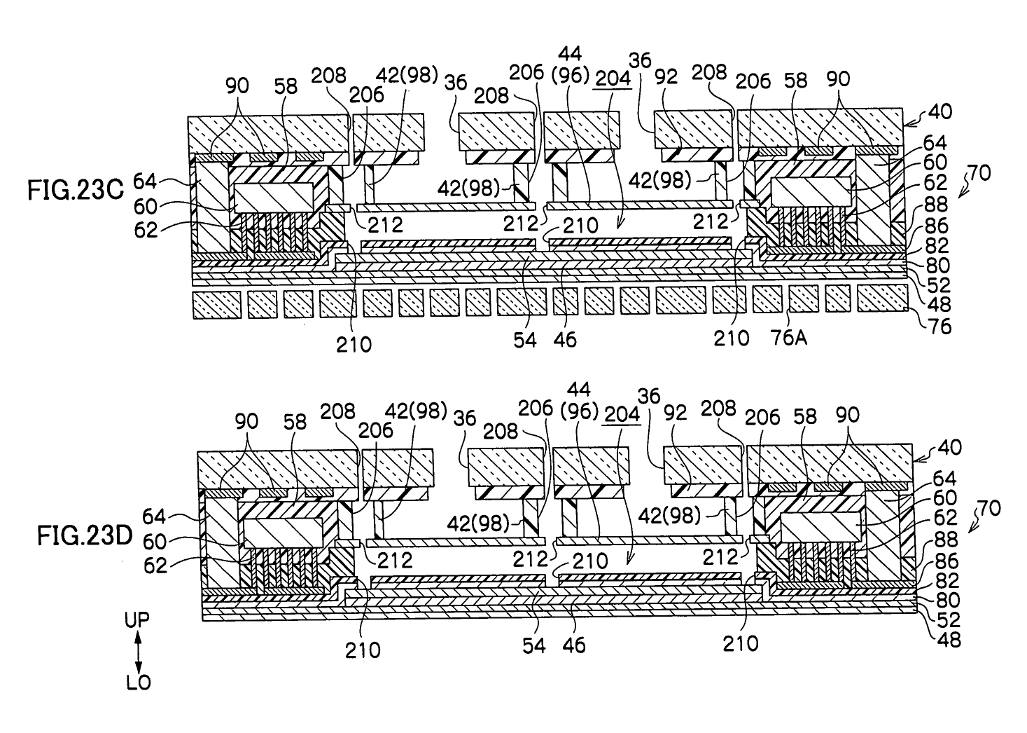

After the top plate 40 is manufactured in this way, as shown in FIG. 23A, the top plate 40 is placed on the piezoelectric element substrate 70, and both are united (joined) together by thermocompression bonding. Namely, the photosensitive dry film 98 (the partitioning wall 42) is joined to the air damper 44, and the bumps 64 are joined to the metal wires 86. In this manner, the communication paths 208 and 206 are in communication with the communication regions 204 via the through-holes 212, and the isolation chambers 112 are in communication with the atmosphere from the communication regions 204 and via the through-holes 212 and the communication paths 206 and 208.

When the joining of the partitioning walls 42 and the bumps 64 is completed, as shown in FIG. 23B, the resin material 58 for sealing (e.g., an epoxy resin) is injected-in at the driving ICs 60. Further, as shown in FIG. 23C, by injecting-in an adhesive removal solution from the through-holes 76A of the first supporting substrate 76 and selectively dissolving the adhesive 78 (see FIG. 10A), the first supporting substrate 76 is removed from the piezoelectric element substrate 70. In this way, as shown in FIG. 23D, the piezoelectric element substrate 70, with which the top plate 40 is united (joined), is completed.

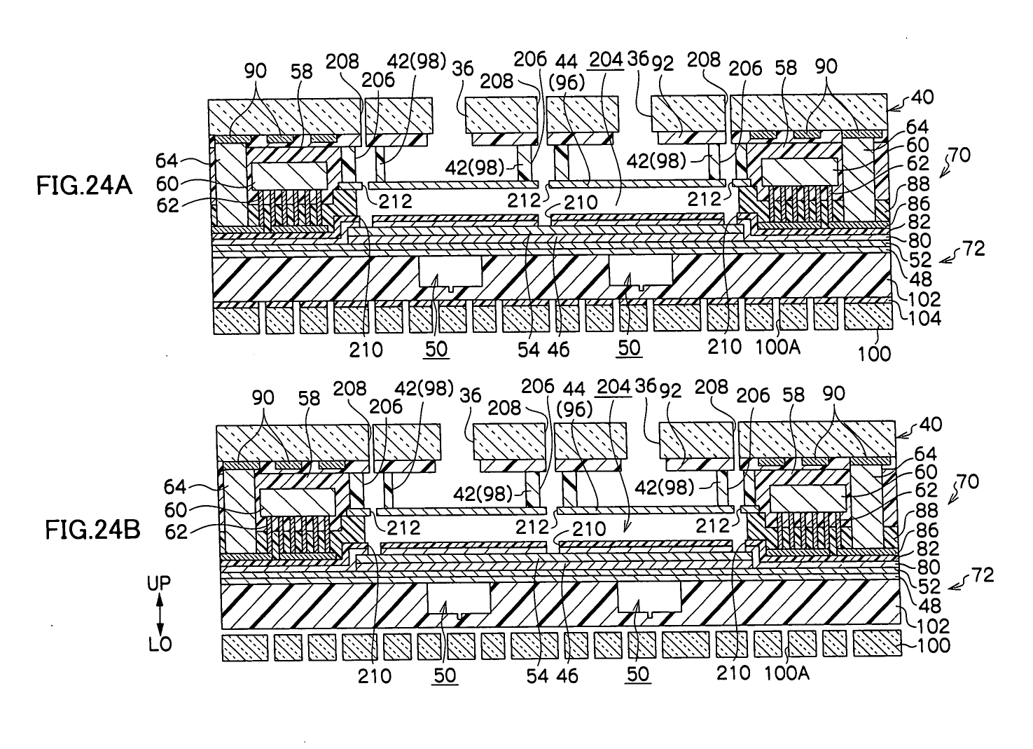

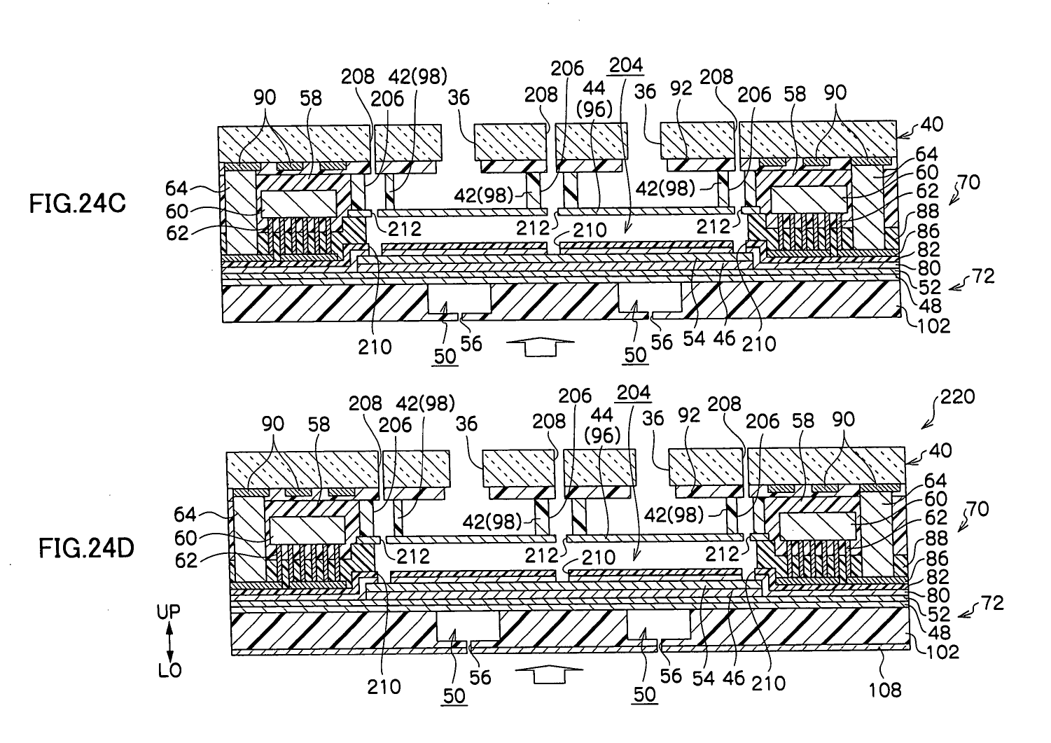

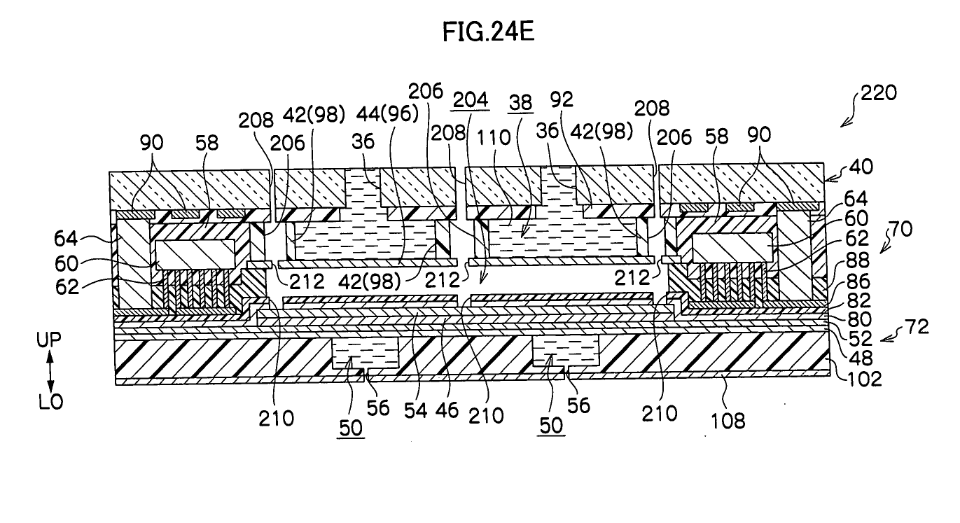

Next, as shown in FIG. 24A, the piezoelectric element substrate 70 and the flow path substrate 72 are united Coined) by thermal compression. Here, description of the steps of fabricating the flow path substrate 72 will be omitted since those steps are the same as those shown in FIGS. 2A-2E.

Subsequently, as shown in FIG. 24B, by injecting-in an adhesive removal solution from the through-holes 100A of the second supporting substrate 100 and selectively dissolving the adhesive 104, the second supporting substrate 100 is removed from the flow path substrate 72.

Thereafter, as shown in FIG. 24C, the nozzles 56 are opened in the surface from which the second supporting substrate 100 is removed. Then, as shown in FIG. 24D, by applying a fluorine material 108, which serves as a water repellant, onto the bottom surface where the nozzles 56 are open, the inkjet recording head 32 is completed. As shown in FIG. 24E, the ink 110 can be filled into the ink pooling chamber 38 and the pressure chambers 50.

In the above embodiment, a structure is adopted in which the isolation chambers 112 are communicated with the atmosphere by providing, in the partitioning walls 42, the communication paths 206 which are in communication with the isolation chambers. 112 and by providing, in the resin film 92 and the top plate 40, the communication paths 208 which are in communication with the communication paths 206, and a structure is further adopted in which the isolation chambers 112 are communicated with the atmosphere by providing, in the bottom surfaces of the communication regions 204, the grooves 210, which penetrate through the piezoelectric element substrate 70, along the row direction of the piezoelectric element substrate 70. However, it is sufficient to adopt only one of these structures since it is simply required that the isolation chambers 112 be able to be communicated with the atmosphere.

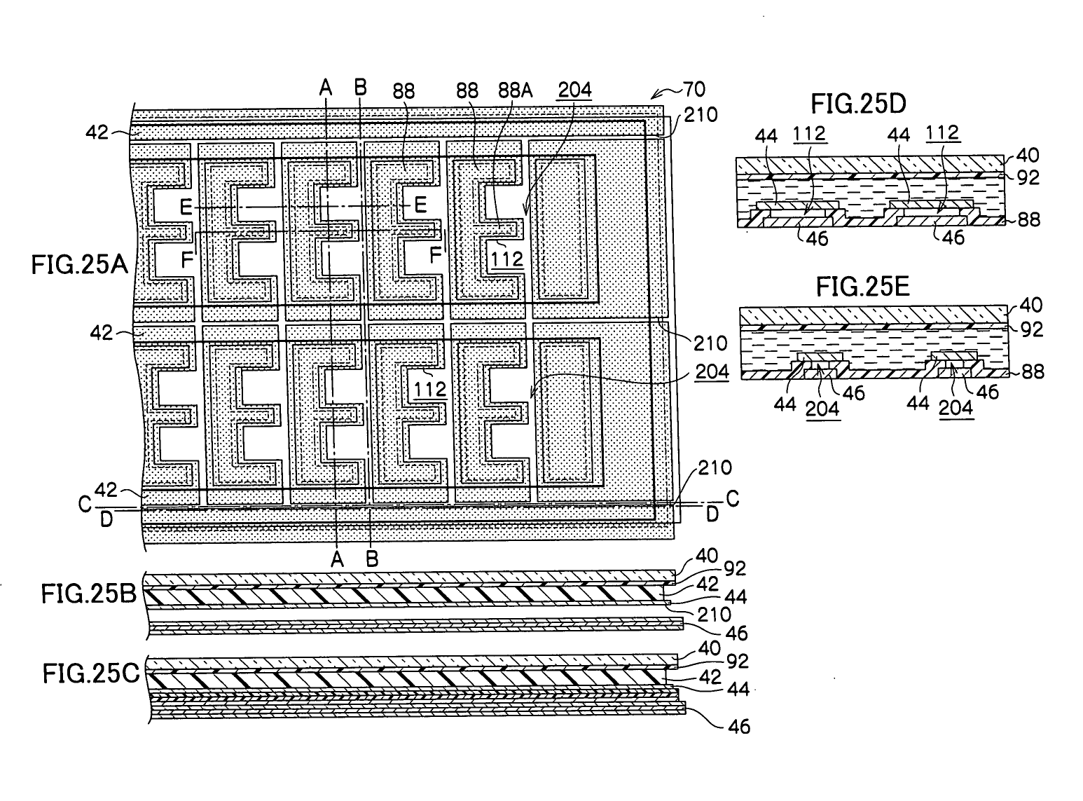

Specifically, as shown in FIGS. 25 through 27 (in FIG. 25, the driving ICs 60 and the bumps 64 are not shown), a structure may be adopted in which the isolation chambers 112 are communicated with the atmosphere only by the grooves 210 which are provided in the bottom surfaces of the communication regions 204 located below the partitioning walls 42, along the row direction of the piezoelectric element substrate 70 and in a manner so as to penetrate through the piezoelectric element substrate 70.

In this case, unlike in the case of FIGS. 18-20, there is no need to provide the communication path 206 in the partitioning wall 42 or to provide the communication path 208 on the resin film 92 and top plate 40. Thus, it is not necessary to make hollow the inner portion of the partitioning wall 42, and accordingly the strength of the partitioning wall 42 is increased.

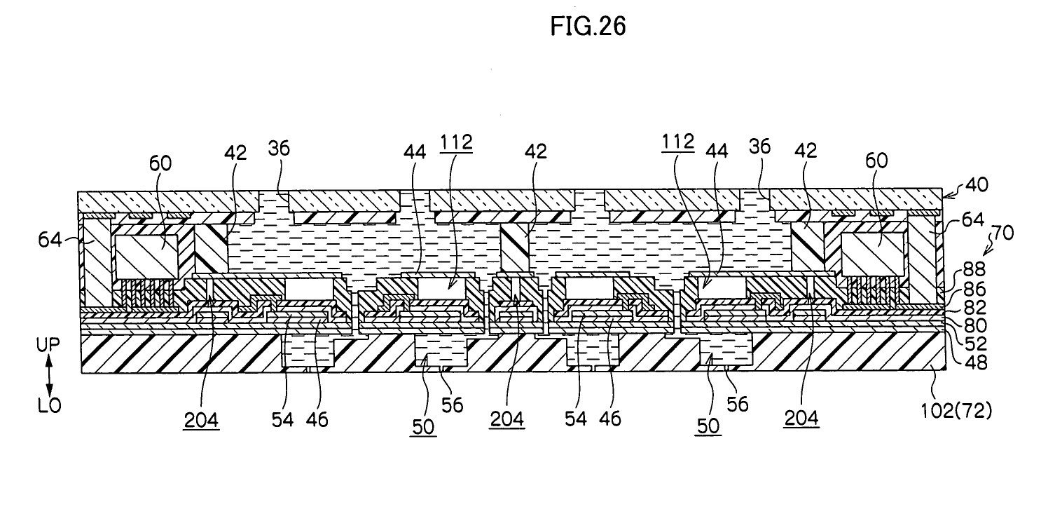

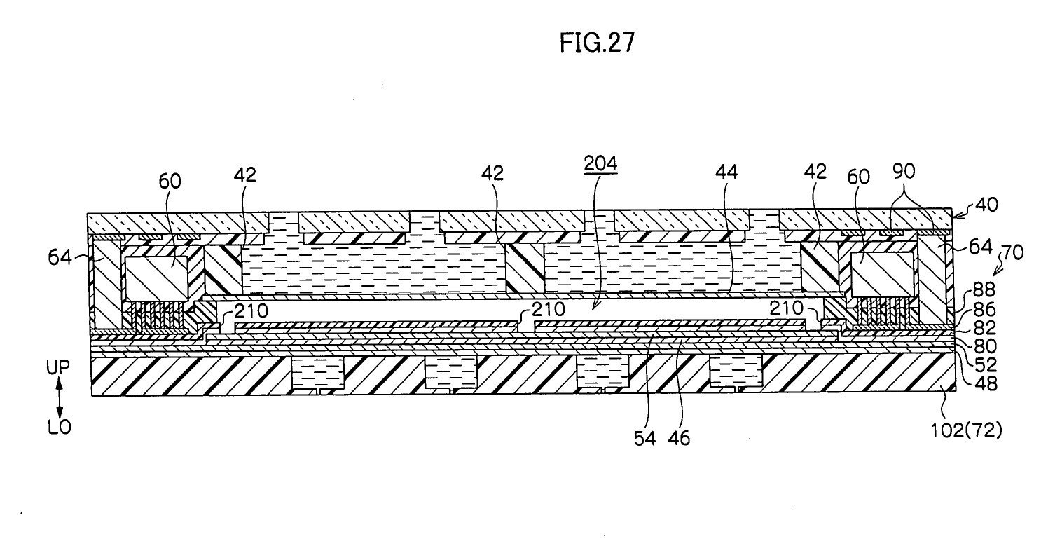

FIG. 25A is a plan view showing the isolation chambers 112, the resin protective films 88, the communication regions 204, the grooves 210, and so forth. FIG. 25B is a sectional view taken along the line C-C of FIG. 25A. FIG. 25C is a sectional view taken along the line D-D of FIG. 25A. FIG. 25D is a sectional view taken along the line E-E of FIG. 25A. FIG. 25E is a sectional view taken along the line F-F of FIG. 25A. FIG. 26 is a sectional view taken along the line A-A of FIG. 25A. FIG. 27 is a sectional view taken along the line B-B of FIG. 25A.

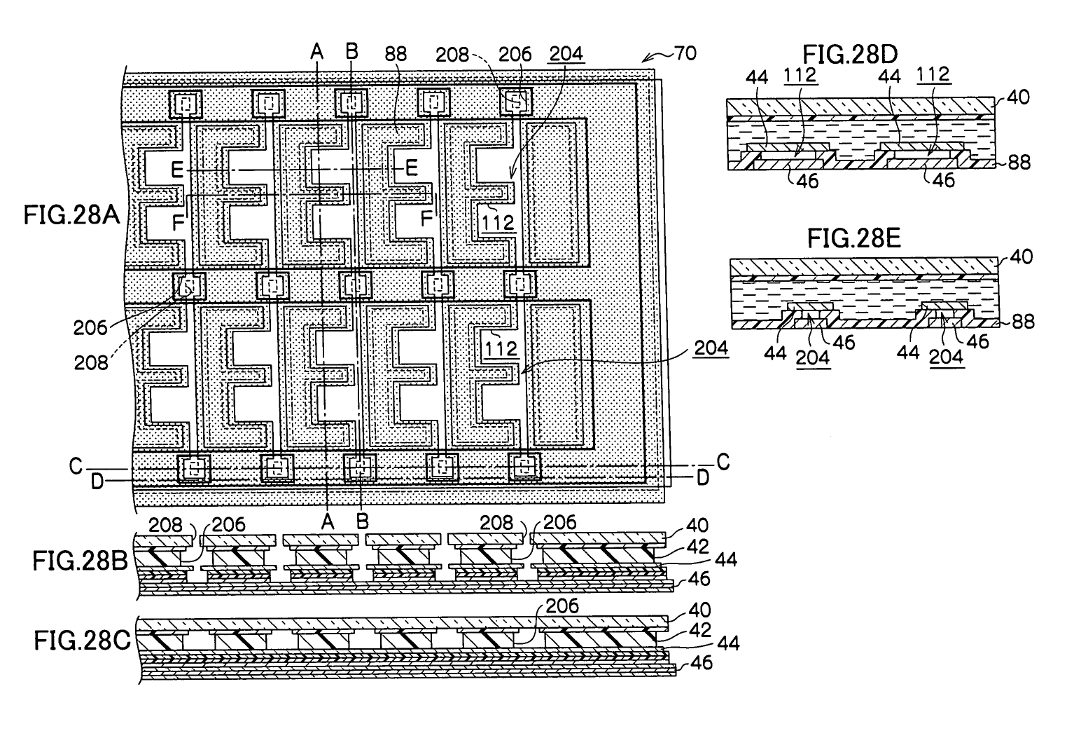

Further, as shown in FIGS. 28-30, it is also possible that the isolation chambers 112 may be communicated with the atmosphere by providing the communication paths 206, which are communicated with the communication paths 208, in the partitioning walls 42 and by providing the communication paths 208, which are communicated with the communication paths 206, in the resin film 92 and the top plate 40, and thus that the isolation chambers 112 may be communicated with the atmosphere only via the communication paths 206 and 208.

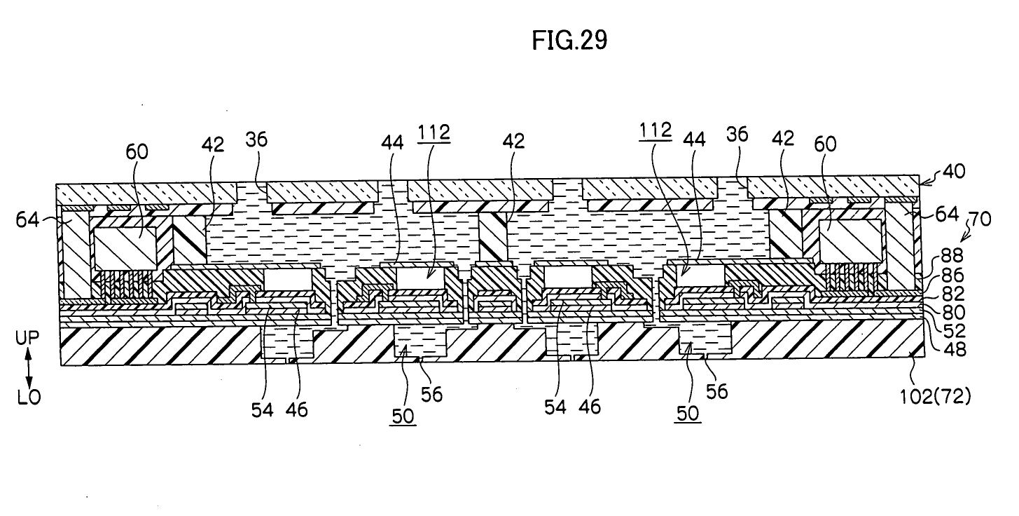

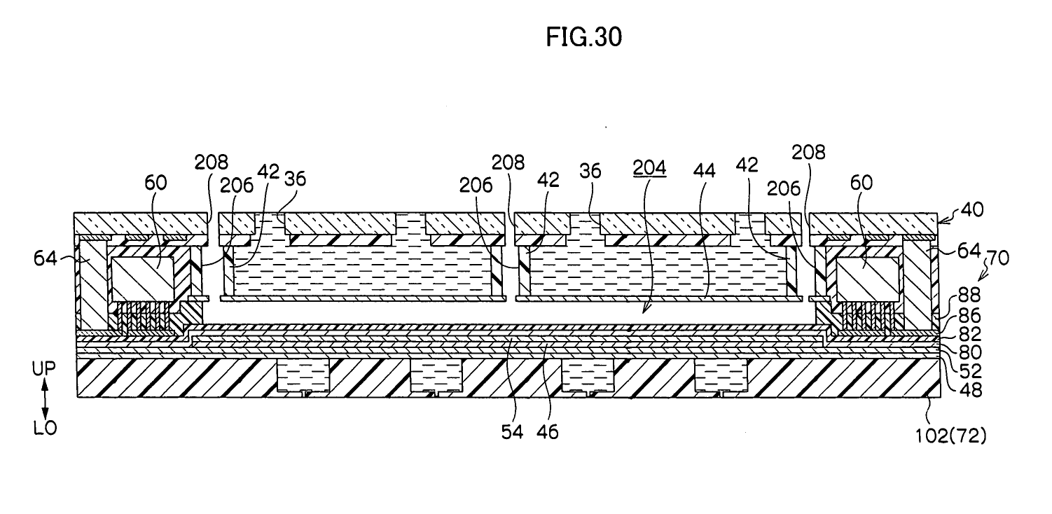

FIG. 28A is a plan view showing the isolation chambers 112, the resin protective films 88, the communication regions 204, the communication paths 206, and so forth. FIG. 28B is a sectional view taken along the line C-C of FIG. 28A. FIG. 28C is a sectional view taken along the line D-D of FIG. 28A. FIG. 28D is a sectional view taken along the line E-E of FIG. 28A. FIG. 28E is a sectional view taken along the line F-F of FIG. 28A. FIG. 29 is a sectional view taken along the line A-A of FIG. 28A. FIG. 30 is a sectional view taken along the line B-B of FIG. 28A.

Although, in the above embodiment, an example is given in which either the communication of the isolation chambers 112 with the atmosphere via the communication paths 206 and 208 or the communication of the isolation chambers 112 with the atmosphere via the grooves 210 is applied, it is also possible that both of those may be applied and in addition communication paths 222 which penetrate through the piezoelectric element substrate 70 may be provided along the row-direction of the piezoelectric element substrate 70, as shown in FIGS. 31-33 (the driving ICs 60 and the bumps 64 are not shown in FIG. 31).

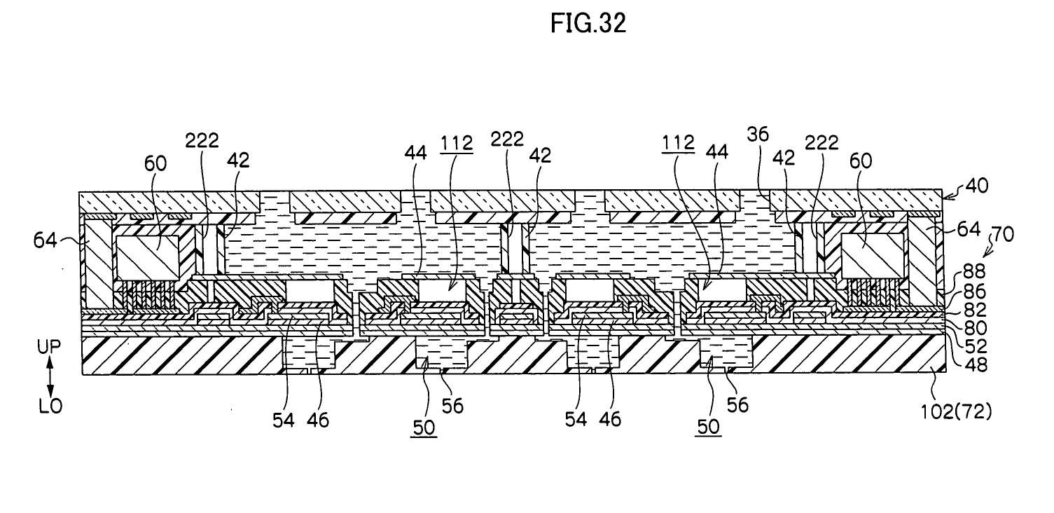

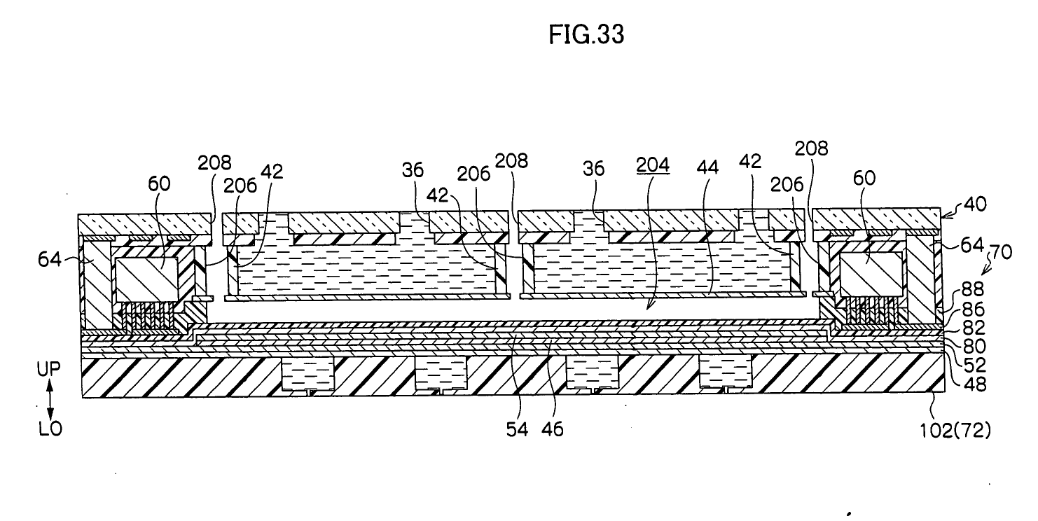

FIG. 31A is a plan view showing the isolation chambers 112, the resin protective films 88, the communication regions 204, the communication paths 206, and so forth. FIG. 31B is a sectional view taken along the line C-C of FIG. 31A. FIG. 31C is a sectional view taken along the line D-D of FIG. 31A. FIG. 31D is a sectional view taken along the line E-E of FIG. 31A. FIG. 31E is a sectional view taken along the line F-F of FIG. 31A. FIG. 32 is a sectional view taken along the line A-A of FIG. 31A. FIG. 33 is a sectional view taken along the line B-B of FIG. 31A.

Although in this embodiment, the communication paths which are communicated with the atmosphere are provided on the piezoelectric element substrate 70 side, it is also possible that the communication paths may be provided on the flow path substrate 72 side. Hereinbelow, description will be made of a case where the communication paths are provided on the flow path substrate 72 side.

### Third Embodiment

For example, in FIGS. 34-36 (the driving ICs 60 and the bumps 64 are not shown in FIG. 34), an arrangement is shown in which at least four adjacent piezoelectric elements 46 form one set, and the four piezoelectric elements are surrounded by a resin protective film 88 having a shape consisting of a continuous array of E shapes, and the piezoelectric elements 46 are isolated by the intermediate wall portion 88A.

Further, a spacing is provided between the ones of the resin protective films 88 which are adjacent to each other in the row-direction of the piezoelectric element substrate 70, and communication regions 224 are provided each of which is communicated with one end portion of each isolation chamber 112. In addition, communication paths 226 are formed which extend downward from the bottom surfaces of the communication regions 224 located below the partition wall 42 toward a resin substrate 102 forming the flow path substrate 72. Thereafter, communication paths (fourth communication paths) 228 and 230 are provided which permit the upper surface of the resin substrate 102 to be communicated with the exterior along orthogonal directions (the row and column directions of the piezoelectric element substrate 70). This makes the pressure within each isolation chamber 112 substantially equal to an atmospheric pressure.

FIG. 34A is a plan view showing the isolation chambers 112, the resin protective films 88, the communication regions 224, the communication paths 228 and 230, and so forth. FIG. 34B is a sectional view taken along the line C-C of FIG. 34A. FIG. 34C is a sectional view taken along the line D-D of FIG. 34A. FIG. 34D is a sectional view taken along the line E-E of FIG. 34A. FIG. 34E is a sectional view taken along the line F-F of FIG. 34A. FIG. 35 is a sectional view taken along the line A-A of FIG. 34A. FIG. 36 is a sectional view taken along the line B-B of FIG. 34A.

Next, the steps of making the inkjet recording head 32 structured as above will be described in detail with reference to FIGS. 37 through 39.

Description of the contents substantially identical to the first embodiment will be omitted, and illustrations will be given based on the B-B section of FIG. 34A.

First, as shown in FIG. 37A, grooves 232 which constitute the communication paths 228 are formed in the top surface (obverse) of a first supporting substrate 76 which is formed with plural through-holes 76A.

Then, as shown in FIG. 37B, an adhesive 78 is applied to the top surface of the first supporting substrate 76, and as shown in FIG. 37C, a vibrating plate 48 made of a metal (SUS or the like) is adhered to the top surface thereof. Here, the vibrating plate 48 is provided with through-holes 48A which are communicated with the communication paths 228.

Next, as shown in FIG. 37D, a lower electrode 72 which is layered on the top surface of the vibrating plate 48 is patterned. At this time, the lower electrode 52 is provided with through-holes 52A which are communicated with the through-holes 48A.

Then, as shown in FIG. 37E, a PZT film which is the material of the piezoelectric element 46 and an upper electrode 54 are layered in that order by sputtering onto the top surface of the lower electrode 52, and as shown in FIG. 37F, the piezoelectric element (PZT film) and the upper electrode 54 are patterned.

Thereafter, as shown in FIG. 37G, a low water permeability insulating film (an SiOx film) 80 is layered onto the exposed portions of the top surface of the lower electrode 52 and the top surface of the upper electrode 54, and further, a resin film 82 which is ink-resistant and flexible is layered and patterned on the top surface of the low water permeability insulating film 80. In this way, the communication paths 226 which are communicated with the isolation chambers 112 are completed. Further, at this time, openings 84 (see FIG. 9H) for connecting the piezoelectric elements 46 and the metal wires 86 are formed. The openings 84 are not shown since the illustrations are given based on the B-B section of FIG. 34A.

Subsequently, as shown in FIG. 37H, a metal film is layered onto those portions of the upper electrode 54 which are exposed at the openings 84 (see FIG. 9G) and the top surface of the resin film 82, and then patterned into the metal wires 86. The metal wires 86 (Al films) and the piezoelectric elements are joined together.

Further, as shown in FIG. 37I, a resin protective film 88 is layered and patterned on the top surfaces of the metal wires 86 and the resin film 82. Thereafter, as shown in FIG. 37J, a photosensitive dry film 96 is provided in a bridged manner on the top surfaces of the resin films 82, and then patterned by exposure and development. The photosensitive dry film 96 becomes air dampers 44 which mitigate pressure waves.

Thereafter, as shown in FIG. 37K, the driving ICs 60 are flip-chip assembled onto the metal wires 86 via the bumps 62, and thus the piezoelectric element substrate 70 is fabricated.

On the other hand, in the method of fabricating the top plate 40 made from glass, the fabricating steps are identical with those shown in FIGS. 10A through 10G, and therefore description thereof will be omitted.

Next, as shown in FIG. 38A, the top plate 40 is placed on the piezoelectric element substrate 70, and the two are united (joined) by thermal compression. More specifically, a photosensitive dry film 98 (partitioning wall 42) is joined to the photosensitive dry film 96, and the bumps 64 are joined to the metal wires 86.

After the portioning walls 42 and the bumps have been joined, as shown in FIG. 38B, the resin material 58 for sealing (e.g., an epoxy resin) is injected-in around the driving ICs 60. Then, as shown in FIG. 38C, by injecting-in an adhesive removal solution from the through-holes 76A of the first supporting substrate 76 and selectively dissolving the adhesive 78, the first supporting substrate 76 is removed from the piezoelectric element substrate 70. In this way, as shown in FIG. 38D, the piezoelectric element substrate 70, with which the top plate 40 is united (joined), is completed.

Next, as shown in FIG. 39A, the piezoelectric element substrate 70 and the flow path substrate 72 are united (joined) together by thermal compression. In this way, the communication paths 228 and 230 (see FIG. 18A) are formed. Then, as shown in FIG. 39B, by injecting-in an adhesive removal solution from the through-holes 100A of the second supporting substrate 100 which constitutes the flow path substrate 72 and selectively dissolving the adhesive 104, the second supporting substrate 100 is removed from the resin substrate 102.

Thereafter, as shown in FIG. 39C, nozzles 56 are opened in the surface from which the second supporting substrate 100 has been removed. Then, as shown in FIG. 39D, by applying a fluorine material 108, which serves as a water repellant, onto the bottom surface where the nozzles 56 are open, the inkjet recording head 32 is completed. As shown in FIG. 39E, the ink 110 can be filled into the ink pooling chamber 38 and the pressure chambers 50.

Although in the above embodiment, the communication paths 226 are formed in the bottom surfaces of the communication regions 224 so as to extend downward and then the communication paths 228 and 230 are provided which extend along the top surface of the resin substrate 102 in orthogonal directions (the row and column directions of the piezoelectric element substrate 70) so as to be communicated with the exterior and thus the isolation chambers 112 are communicated with the atmosphere, it is also possible that communication paths 234 which directly penetrate through the resin substrate 102 may be provided in the bottom surface of the communication region 224 located below the portioning wall 42, as shown in FIGS. 40-42 (the driving ICs 60 and bumps 64 are not shown in FIG. 40.

FIG. 40A is a plan view showing the isolation chambers 112, the resin protective films 88, the communication regions 224, and so forth. FIG. 40B is a sectional view taken along the line C-C of FIG. 40A. FIG. 40C is a sectional view taken along the line D-D of FIG. 40A. FIG. 40D is a sectional view taken along the line E-E of FIG. 40A. FIG. 40E is a sectional view taken along the line F-F of FIG. 40A. FIG. 41 is a sectional view taken along the line A-A of FIG. 40A. FIG. 42 is a sectional view taken along the line B-B of FIG. 40A.

As shown in FIGS. 43-45 (the driving ICs 60 and the bumps 64 are not shown in FIG. 43), communication paths 236 may be provided in the bottom surfaces of the communication regions 224 located below the partitioning walls 42 in such a manner as to penetrate through the resin substrate 102. Thereafter, communication paths 238 and 240 may be provided which permit the lower surface of the resin substrate 102 to be communicated with the exterior along orthogonal directions (in the row and column directions of the piezoelectric element substrate 70). Note that a nozzle plate 241 is adhered to the bottom surface of the resin substrate 241, instead of a fluorine material being applied thereto.

FIG. 43A is a plan view showing the isolation chambers 112, the resin protective films 88, the communication regions 224, the communication paths 238, and so forth. FIG. 43B is a sectional view taken along the line C-C of FIG. 43A. FIG. 43C is a sectional view taken along the line D-D of FIG. 43A. FIG. 43D is a sectional view taken along the line E-E of FIG. 43A. FIG. 43E is a sectional view taken along the line F-F of FIG. 43A. FIG. 44 is a sectional view taken along the line A-A of FIG. 43A. FIG. 44 is a sectional view taken along the line B-B of FIG. 43A.

Further, although in the second and third embodiments, plural ones of the piezoelectric elements that are adjacent to each other form one set and are surrounded by the approximately E-shaped resin protective film 88 and the communication regions 204 and 224 are provided which are partly communicated with one another in the plural isolation chambers 112, it goes without saying that the isolation chambers 112 may be made independent from the respective piezoelectric elements 46.

Further, as shown in FIGS. 46 and 47, in addition to the isolation chambers 112 being made independent from the respective piezoelectric elements 46, the communication paths 242 may be made to extend downward from the respective isolation chambers 112, and communication paths 224 and 246 through which the top surface of the resin substrate 102 is communicated with the exterior along the column direction of the piezoelectric element substrate 70. FIG. 46 is a plan view showing the isolation chambers 112, the communication paths 244 and 246 which will be described later, and so forth, and FIG. 47 is a sectional view taken along the line A-A of FIG. 46. In FIG. 46, the driving ICs 60 and the bumps 64 are not shown.

In this case, the isolation chambers 112 are configured in an approximate L-shape, and communication paths 242 are provided at the ends of the isolation chambers 112. It is also possible that the plural isolation chambers 112 may be divided into two groups in the column direction of the piezoelectric element substrate 70, and that in one group, the communication paths 242 may be communicated with the communication paths 244 while in the other group, the communication paths 242 may be communicated with the communication paths 246.

Further, as shown in FIGS. 48 and 49, it is possible that the communication paths 242 are made to extend downward from the respective isolation chambers 112 and that communication paths 248 or 250 may be formed which are communicated with the communication paths 242 and extend on the top surface of the resin substrate 102 along the column direction of the piezoelectric element substrate 70. In addition, it is also possible that communication paths 252 may be provided which extend downward at the opposite ends in the column direction of the piezoelectric element substrate 70 from the communication paths 248 or 250 toward the bottom surface of the resin substrate 102. FIG. 48 is a plan view showing the isolation chambers 112, the communication paths which will be described later, and so forth. FIG. 49 is a sectional view taken along the line A-A of FIG. 48. In FIG. 48, the driving ICs 60 and the bumps 64 are not shown.

Further, as shown in FIGS. 50 and 51, it is possible that communication paths 254 may be provided which extend downward from the bottom surfaces of the respective isolation chambers 112 directly toward the resin substrate 102. FIG. 50 is a plan view showing the isolation chambers 112, the communication paths 254 which will be described later, and so forth. FIG. 51 is a sectional view taken along the line A-A of FIG. 50. In FIG. 50, the driving ICs 60 and the bumps 64 are not shown.

This embodiment is given only by way of example, and it is needless to say that changes and modifications may be made as desired in view of ease of working, accuracy of working, and the like and without departing from the gist of the invention.

Further, in the inkjet recording apparatus 10 according to the above-described embodiments, it is designed such that ink droplets are selectively ejected from the inkjet recording heads 30 for the respective colors of black, yellow, magenta, and cyan based on image data, and thus a full-color image is recorded on the recording paper P. However, the inkjet recording in the present invention is by no means limited to recording of a character or an image onto the recording paper P.

That is, the recording medium is not limited to paper, and the liquid to be ejected is not limited to ink. For example, the inkjet recording head 32 according to the present invention can be applied to any liquid ejecting apparatus in general which is industrially used for such purposes as making a display color filter by ejecting ink onto a high molecular film or a glass body, forming bumps useful for mounting components by ejecting drops of welding solder onto a substrate, and so forth.

Although the inkjet recording apparatus 10 according to the above-described embodiments has been explained by way of example with respect to the partial width array (PWA) including the main scanning mechanism 16 and the sub scanning mechanism 18, the inkjet recording system according to the present invention is not limited thereto but is equally applicable to the so-called full width array which is paper width compliant. Because of being effective for achieving a high-density nozzle array, the present invention is rather suitable to the FWA which requires one-pass printing.

1. A liquid droplet ejecting head, comprising:
a nozzle that ejects a liquid droplet;
a pressure chamber that is communicated with the nozzle and in which a liquid is filled;
a vibrating plate that forms a portion of the pressure chamber;
an ink pooling chamber that pools a liquid which is supplied to the pressure chamber via a liquid flow path;
a piezoelectric element that displaces the vibrating plate; and
an isolation chamber that is provided in the liquid pooling chamber and isolates the piezoelectric element from the liquid;
wherein the liquid pooling chamber is provided at a side opposite to the pressure chamber, with the vibrating plate disposed between the liquid pooling chamber and the pressure chamber.

2. The liquid droplet ejecting head according to claim 1, further comprising a communication path that is communicated with the isolation chamber and makes a pressure within the pressure chamber substantially equal to an atmospheric pressure.

3. The liquid droplet ejecting head according to claim 2, wherein the communication path comprises a first communication path that is provided in a partition wall of the liquid pooling chamber and communicated with the isolation chamber, and a second communication path that is provided in a top plate of the liquid pooling chamber and communicated with the first communication path and an exterior.

4. The liquid droplet ejecting head according to claim 2, wherein the communication path comprises a third communication path that penetrates through the vibrating plate and the piezoelectric element and is communicated with the isolation chamber, and a fourth communication path that is provided on a flow path substrate by which the pressure chamber is formed and which is communicated with the third communication path and an exterior.

5. The liquid droplet ejecting head according to claim 1, wherein an air damper that mitigates pressure waves of the liquid pooled in the liquid pooling chamber is provided in the isolation chamber.

6. The liquid droplet ejecting head according to claim 2, wherein an air damper that mitigates pressure waves of the liquid pooled in the liquid pooling chamber is provided in the isolation chamber.

7. The liquid droplet ejecting head according to claim 3, wherein an air damper that mitigates pressure waves of the liquid pooled in the liquid pooling chamber is provided in the isolation chamber.

8. The liquid droplet ejecting head according to claim 4, wherein an air damper that mitigates pressure waves of the liquid pooled in the liquid pooling chamber is provided in the isolation chamber.

9. The liquid droplet ejecting head according to claim 1, wherein the piezoelectric element is disposed in a matrix form and isolated on a row unit basis in the isolation chamber.

10. The liquid droplet ejecting head according to claim 2, wherein the piezoelectric element is disposed in a matrix form and isolated on a row unit basis in the isolation chamber.

11. The liquid droplet ejecting head according to claim 3, wherein the piezoelectric element is disposed in a matrix form and isolated on a row unit basis in the isolation chamber.

12. The liquid droplet ejecting head according to claim 4, wherein the piezoelectric element is disposed in a matrix form and isolated on a row unit basis in the isolation chamber.

13. The liquid droplet ejecting head according to claim 5, wherein the piezoelectric element is disposed in a matrix form and isolated on a row unit basis in the isolation chamber.

14. The liquid droplet ejecting head according to claim 1, wherein the piezoelectric element is disposed in a matrix form and isolated on a one-element unit basis in the isolation chamber.

15. The liquid droplet ejecting head according to claim 2, wherein the piezoelectric element is disposed in a matrix form and isolated on a one-element unit basis in the isolation chamber.

16. The liquid droplet ejecting head according to claim 3, wherein the piezoelectric element is disposed in a matrix form and isolated on a one-element unit basis in the isolation chamber.

17. The liquid droplet ejecting head according to claim 4, wherein the piezoelectric element is disposed in a matrix form and isolated on a one-element unit basis in the isolation chamber.

18. The liquid droplet ejecting head according to claim 5, wherein the piezoelectric element is disposed in a matrix form and isolated on a one-element unit basis in the isolation chamber.

19. The liquid droplet ejecting head according to claim 1, wherein the piezoelectric element is disposed in a matrix form, and one or more arbitrary piezoelectric elements are isolated in the isolation chamber.

20. The liquid droplet ejecting head according to claim 2, wherein the piezoelectric element is disposed in a matrix form, and one or more arbitrary piezoelectric elements are isolated in the isolation chamber.

21. The liquid droplet ejecting head according to claim 3, wherein the piezoelectric element is disposed in a matrix form, and one or more arbitrary piezoelectric elements are isolated in the isolation chamber.

22. The liquid droplet ejecting head according to claim 4, wherein the piezoelectric element is disposed in a matrix form, and one or more arbitrary piezoelectric elements are isolated in the isolation chamber.

23. The liquid droplet ejecting head according to claim 5, wherein the piezoelectric element is disposed in a matrix form, and one or more arbitrary piezoelectric elements are isolated in the isolation chamber.

24. The liquid droplet ejecting head according to claim 2, wherein the isolation chamber is formed at a resin plate on which the liquid path is provided.

25. The liquid droplet ejecting head according to claim 1,.wherein a protective film that protects the piezoelectric element is a layer of a low water permeability film.

26. A liquid droplet ejecting head, comprising:
a nozzle that ejects a liquid droplet;
a pressure chamber that is communicated with the nozzle and in which a liquid is filled;
a vibrating plate that forms a portion of the pressure chamber;
an ink pooling chamber that pools a liquid which is supplied to the pressure chamber via a liquid flow path;
a piezoelectric element that displaces the vibrating plate;
an isolation chamber that is provided in the liquid pooling chamber and isolates the piezoelectric element from the liquid; and
a communication path that is communicated with the isolation chamber and makes a pressure within the pressure chamber substantially equal to an atmospheric pressure;
wherein the liquid pooling chamber is provided at a side opposite to the pressure chamber, with the vibrating plate disposed between the liquid pooling chamber and the pressure chamber; and
wherein the communication path comprises a first communication path that is provided in a partition wall of the liquid pooling chamber and communicated with the isolation chamber, and a second communication path that is provided in a top plate of the liquid pooling chamber and communicated with the first communication path and an exterior.

27. A liquid droplet ejecting head, comprising:
a nozzle that ejects a liquid droplet;
a pressure chamber that is communicated with the nozzle and in which a liquid is filled;
a vibrating plate that forms a portion of the pressure chamber;
an ink pooling chamber that pools a liquid which is supplied to the pressure chamber via a liquid flow path;
a piezoelectric element that displaces the vibrating plate;
an isolation chamber that is provided in the liquid pooling chamber and isolates the piezoelectric element from the liquid; and
a communication path that is communicated with the isolation chamber and makes a pressure within the pressure chamber substantially equal to an atmospheric pressure;
wherein the liquid pooling chamber is provided at a side opposite to the pressure chamber, with the vibrating plate disposed between the liquid pooling chamber and the pressure chamber; and
wherein the communication path comprises a third communication path that penetrates through the vibrating plate and the piezoelectric element and is communicated with the isolation chamber, and a fourth communication path that is provided on a flow path substrate by which the pressure chamber is formed and which is communicated with the third communication path and an exterior.

28. A liquid droplet ejecting apparatus comprising the liquid droplet ejecting head according to claim 1.

29. A liquid droplet ejecting apparatus comprising the liquid droplet ejecting head according to claim 26.

30. A liquid droplet ejecting apparatus comprising the liquid droplet ejecting head according to claim 27.
